(19) United States
(12) Patent Application Publication
(10) Pub. No.: US 2026/0359724 A1
(43) Pub. Date: Nov. 12, 2026

(54) SYSTEMS AND METHODS FOR GENERATING PERSONALIZED CONTENT

(71) Applicant: The PNC Financial Services Group, Inc., Pittsburgh, PA (US)

(72) Inventors: Robert J. Schukai, Marietta, GA (US); Deanna N. Gilbert, Arlington Heights, IL (US); Minette Vaccariello, Pittsburgh, PA (US); Brianna K. Hogan, Coraopolis, PA (US); Melissa Morello, Pittsburgh, PA (US); Touseef Habib, Secaucus, NJ (US)

(73) Assignee: The PNC Financial Services Group, Inc., Pittsburgh, PA (US)

(21) Appl. No.: 19/667,986

(22) Filed: May 5, 2026

Related U.S. Application Data
(60) Provisional application No. 63/802,078, filed on May 8, 2025.

(51) Int. Cl. G06N 20/00; G06F 18/2415

(52) U.S. Cl. CPC G06N 20/00; G06F 18/2415

(57) ABSTRACT

A system is disclosed for generating personalized content. The system may include at least one processor configured to execute the instructions to perform operations. The operations may include continuously monitoring user interaction with a platform hosted on a user device; storing user interaction data for a period of time in a database; parsing user interaction data according to predetermined parsing instructions to produce parsed user interaction data; identifying, by a machine learning model executed by the at least one processor, a pattern in the parsed user interaction data, the machine learning model trained to characterize the pattern as a positive pattern or a negative pattern; responsive to a characterization of the pattern as a positive pattern or a negative pattern, generating a customized message based on the characterization; and delivering the message to the user device.

### CROSS REFERENCE TO RELATED APPLICATIONS

This application claims priority from U.S. Provisional Application No. 63/802,078, filed on May 8, 2025, the entirety of which is incorporated by reference.

### BACKGROUND

There are a variety of marketing tools and strategies where merchants, businesses, and service providers aim to deliver content to users. Some of these tools use user and market data to target specific users. Marketing is vitally important to businesses because it informs people about a business’s products and services, attracts users, and generally increases sales or use of products and services.

Generally, businesses generate and utilize personalized content, such as personalized marketing content, for those businesses’ direct benefit. Users may benefit by learning about products and services they may be interested in, and the businesses may boost their profits and visibility. Users may see marketing and advertisements every day, including at the store, on their commute, or on a computing device, such as a laptop or mobile phone.

Likewise, users may receive personalized content on their computing devices. Personalizing content for every user is a challenge, and that challenge is growing with rapidly changing trends, varying user interests, and difficulty reaching all desired audiences. Currently, the personalized content is personalized for the masses, or a customer base as a whole, rather than individuals. As a result, users are presented with generic information that is good for everyone, but not good for any one person. There is a lack of true personalization from individual to individual. Often, the content is not the most relevant, useful, or of interest to users, and users are unable to modify the content they are receiving in a way that best suits them. Further, institutions have a network of businesses and service providers they partner with. Institutions do not currently have an effective way of providing their users with personalized content that is modifiable to fit users’ desired experience and connects users to goods and services including those provided by the institution’s network. What is needed is a system for improving a user’s experience by generating personalized content that takes into account user activity, habits, and preferences, and connects an institution’s users and partners.

### SUMMARY

In view of the foregoing, embodiments of the present disclosure provide novel computer-implemented systems and methods for generating personalized content.

Embodiments of the present disclosure provide a computer implemented system for providing users with personalized content. The personalized content system may include a memory storing a set of instructions. The personalized content system may include a database in electronic communication with a memory. The personalized content system may include a plurality of processors in electronic communication with the database. The database may be configured to store information that includes corporate partner information, user information, and account and activity information. The corporate partner information may be associated with a corporate account and user information may be associated with at least one user or account. The account and activity information may be associated with at least one account. The plurality of processors may be configured to execute a set of instructions. The set of instructions may include continuously monitoring user interaction with a platform hosted on a user device; storing user interaction data for a period of time in a database; parsing user interaction data according to predetermined parsing instructions to produce parsed user interaction data; identifying, by a machine learning model executed by the at least one processor, a pattern in the parsed user interaction data, the machine learning model trained to characterize the pattern as a positive pattern or a negative pattern; responsive to a characterization of the pattern as a positive pattern or a negative pattern, generating a customized message based on the characterization; and delivering the message to the user device. In some embodiments, the message may include dynamic content that a user may interact with to access external resources, such as external webpages, directions, and purchase options for goods and services. In yet another embodiment, the set of instructions may include detecting a user’s account has engaged a travel lock or some other hold, identifying the reason for the travel lock or hold, generating personalized content based on the reason for the travel lock or hold, and delivering the personalized content to a user’s computing device.

In other embodiments of the present disclosure, the set of instructions may include displaying on a user interface a personalization slider, receiving a user input to increase or decrease the personalization percentage of content, allowing the user to opt fully into receiving personalized content, fully out of receiving personalized content, or somewhere in the middle. In other embodiments of the present disclosure, the set of instructions may include outputting a visual change in the personalization slider marker position and personalization percentage to the user interface, and using an artificial intelligence model or machine learning model to generate a visual representation of content a user can expect to see for the selected personalization percentage. In some embodiments, a machine learning model may be trained to allow the visual representation to change fluidly and intelligently as a user changes the personalization slider marker position and personalization percentage. In other embodiments, the visual representation may change at specific, predefined percentage markers.

Another aspect of the present disclosure is directed to a system for determining an initial personalization level for personalized content delivered to a user. The system may include at least one processor; and at least one memory configured to execute the instructions to perform operations. The operations may include displaying on a user interface a personalization slider, monitoring an account of a user, receiving account data into a database where account data may include internal data and external data and internal data may include a user’s personal data, determining the user’s interests and associations, pushing notifications including personalized content to the user’s computing device, detecting and tracking a user’s interaction level with personalized content over time, detecting a user’s usage and redemption of the personalized content; using a machine learning model to assess the comfortability level of users having certain characteristics with a personalization level, and assigning users with certain characteristics an ideal default personalization level.

Another aspect of the present disclosure is directed to a method. The method may perform operations including monitoring a user account, receiving a user’s personal information into a database, receiving a user’s account data into the database, monitoring a user’s account for low or worsening performance, determining if a performance level has dropped below a predetermined threshold, generating need-based personalized content to address a user’s account’s declining performance, and delivering to a user’s computing device the personalized content to a user’s account. In another embodiment, the method may perform operations including monitoring a user account, receiving a user’s personal information including demographic information into a database, requesting access to a user’s location data, determining the location of a user, receiving a user’s location data into a database, predicting possible user needs based on the location data and personal information, generating need-based personalized content to address a user’s predicted needs, and delivering to a user’s computing device the personalized content. In yet another embodiment, the method may perform further operations including prompting the user to seek assistance from an institution employee.

Yet another aspect of the present disclosure is directed to a system for using location data and account data to provide personalized content. The system may include at least one processor; and at least one memory configured to execute the instructions to perform operations. The operations may include receiving user data into a database, monitoring an account, assessing user data for user interests and associations, identifying businesses the user may engage with most often, requesting access to a user’s location data, determining the location of a user, detecting the user is within a predefined distance from a business, and pushing a navigation recommendation to a user’s mobile device. In other embodiments, operations may include monitoring an account, receiving user data into a database, assessing user data for user interests and associations, requesting access to a user’s location data, determining the location of a user, receiving location data into a database, detecting patterns in the user’s activity at various establishments, generating personalized content including rewards and offers for an establishment, and delivering personalized content to the user’s account.

One aspect of the present disclosure is directed to a system for using location data and geofences to provide personalized content. The system may include at least one processor; and at least one memory configured to execute the instructions to perform operations. The operations may include receiving user data into a database, monitoring an account, requesting access to a user’s location data, determining the location of a user, generating a map of the locations user travels between during a period of time, identifying a perimeter around a portion of the map the user travels through most, extending the radius of the perimeter by a predetermined distance, setting a geofence with the same perimeter as the identified map perimeter, generating personalized content based on activity within the geofence, delivering the personalized content to a user account. In another embodiment, the operations may further include the step of identifying relevant news data within the geofence, receiving news data into a database, generating personalized content from the news data, and delivering the personalized content to a user account.

Yet another aspect of the present disclosure is directed to a system for determining a snapshot of a user’s network. The system may include at least one processor; and at least one memory configured to execute the instructions to perform operations. The operations may include monitoring an account, receiving user data into a database, assessing user data for user interests and associations, requesting access to a user’s location data, determining the location of a user, receiving location data into a database, identifying recurring activity of the user, grouping recurring activity into like-categories, packaging the categories of data and storing the categories of data in the database. In another embodiment, the system may identify businesses similar to the recurring activity, just outside of a user’s network, generate personalized content highlighting those businesses, and deliver the personalized content to a user’s account.

Yet another aspect of the present disclosure is directed to a system for providing in-network incentives. The system may include at least one processor; and at least one memory configured to execute the instructions to perform operations. The operations may include receiving user data into a database, monitoring an account, identifying businesses in an institution’s network of businesses within a predetermined radius of the user’s residence, generating a message highlighting incentives for engaging with businesses in the institution’s network, and delivering the message to a user’s computing device. In another embodiment, the operations may further include steps of tracking claimed incentive data, generating reports on the effectiveness of the incentives, and delivering the reports to businesses in the institution’s network. In yet another embodiment, the operations may further include the step of generating offers for the businesses in the institution’s network and delivering the offers to the institution’s employees and users.

Another aspect of the present disclosure is directed to a method. The method may perform operations including monitoring user accounts, receiving users’ data into a database, identifying within the user data users’ interests and associations, identifying similarities in interests and associations between users, generating a group based on the similarities; prompting users to join groups related to their interests. In another embodiment, the method may perform further operations including generating exclusive offers relevant to a group, delivering a message highlighting the offers to users’ accounts to incentivize users to join the group.

Aspects of the disclosed embodiments may include tangible computer readable media that store software instructions that, when executed by at least one processor, are configured for and capable of performing and executing one or more of the methods, operations, and the like consistent with the disclosed embodiments. Also, aspects of the disclosed embodiments may be performed by at least one processor that is configured as special-purpose processor(s) based on software instructions that are programmed with logic and instructions that perform, when executed, one or more operations consistent with the disclosed embodiments.

Throughout this disclosure the phrase “disclosed embodiments” refers to examples of ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic. It is to be understood that both the foregoing general description and the following detailed description are exemplary and explanatory only, and are not restrictive of the disclosed embodiments, as claimed.

### BRIEF DESCRIPTION OF THE DRAWINGS

Embodiments and various aspects of the present disclosure are illustrated in the following detailed description and the accompanying figures. Various features shown in the figures are not drawn to scale. Identical reference numerals generally represent identical components in the exemplary implementations of the present disclosure.

FIG. 1 depicts an exemplary illustration of a user using a computer to generate content for users.

FIG. 2 depicts an exemplary illustration of a user using a computing device to predict user needs and deliver personalized content, consistent with disclosed embodiments.

FIG. 3 depicts a block diagram showing an exemplary computing device, consistent with disclosed embodiments.

FIG. 4 depicts a flow diagram showing an exemplary process for providing personalized content, consistent with disclosed embodiments.

FIG. 5 depicts exemplary illustration of a user using a computing device to adjust a desired level of personalization of content, consistent with disclosed embodiments.

FIG. 6 depicts a flow diagram showing an exemplary process delivering personalized content, consistent with disclosed embodiments.

FIG. 7 depicts an exemplary illustration of a user using a computing device to engage with dynamic content within personalized content, consistent with disclosed embodiments.

FIG. 8 depicts a flow chart for a method of predicting user needs, consistent with disclosed embodiments.

FIG. 9 depicts a flow chart for a method of providing dynamic content, consistent with disclosed embodiments.

FIG. 10 depicts a flow chart for a method of redemption feedback monitoring, consistent with disclosed embodiments.

FIG. 11 depicts a flow chart for a method of providing location-based content, consistent with disclosed embodiments.

FIG. 12 depicts a flow chart for a method of providing predictive notifications, consistent with disclosed embodiments.

FIG. 13 depicts a flow chart for a method of providing personalized offers, consistent with disclosed embodiments.

FIG. 14 depicts a flow chart for a method of promoting a network, consistent with disclosed embodiments.

FIG. 15 depicts a flow chart for a method of user-selectable personalization, consistent with disclosed embodiments.

FIG. 16 depicts a flow chart for a method of mapping user data to personalization preferences, consistent with disclosed embodiments.

FIG. 17 depicts a flow chart for a method of setting an ideal personalization level, consistent with disclosed embodiments.

FIG. 18 depicts a flow chart for a method of generating user-selectable personalization graphics, consistent with disclosed embodiments.

FIG. 19 depicts a flow chart for another method of generating user-selectable personalization graphics, consistent with disclosed embodiments.

FIG. 20 depicts a flow chart for yet another method of generating user-selectable personalization graphics, consistent with disclosed embodiments.

FIG. 21 depicts a flow chart for a method of identifying a user network, consistent with disclosed embodiments.

FIG. 22 depicts a flow chart for a method of growing a user network, consistent with disclosed embodiments.

FIG. 23 depicts a flow chart for a method of promoting in-network businesses, consistent with disclosed embodiments.

FIG. 24 depicts a flow chart for a method of grouping like-users, consistent with disclosed embodiments.

FIG. 25 depicts a flow chart for a method of incentivizing group participation, consistent with disclosed embodiments.

FIG. 26 depicts a flow chart for a method of notifying an institution of user needs, consistent with disclosed embodiments.

FIG. 27 depicts a flow chart for a method of providing personalized card hold content, consistent with disclosed embodiments.

FIG. 28 depicts a flow chart for a method of providing in-network businesses’ offers, consistent with disclosed embodiments.

FIG. 29 depicts a flow chart for a method of redemption reporting, consistent with disclosed embodiments.

FIG. 30 depicts a flow chart for a method of making need-based assumptions, consistent with disclosed embodiments.

FIG. 31 depicts a flow chart for a method of recommending institution services, consistent with disclosed embodiments.

FIG. 32 depicts a flow chart for a method of feedback driven personalization reduction, consistent with disclosed embodiments.

FIG. 33 depicts a flow chart for a method of delivering timely content, consistent with disclosed embodiments.

FIG. 34 depicts a flow chart for a method of providing geofence-based content, consistent with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limiting.

Embodiments herein include computer-implemented methods, tangible non-transitory computer-readable media, and systems. The computer-implemented methods may be executed, for example, by at least one processor (e.g., a processing device) that receives instructions from a non-transitory computer-readable storage medium. Similarly, systems consistent with the present disclosure may include at least one processor (e.g., a processing device) and a memory, and the memory may include a non-transitory computer-readable storage medium. As used herein, a non-transitory computer-readable storage medium refers to any type of physical memory on which information or data readable by at least one processor may be stored. Examples include random access memory (RAM), read-only memory (ROM), volatile memory, non-volatile memory, hard drives, compact disc (CD) ROMs, digital optical discs (DVDs), flash drives, disks, and/or any other known physical storage medium. Singular terms, such as “memory” and “computer-readable storage medium,” may additionally refer to multiple structures, such as a plurality of memories and/or computer-readable storage mediums. As referred to herein, a “memory” may include any type of computer-readable storage medium unless otherwise specified. A computer-readable storage medium may store instructions for execution by at least one processor, including instructions for causing the processor to perform steps or stages consistent with an embodiment herein. Additionally, one or more computer readable storage mediums may be utilized in implementing a computer-implemented method. The term “computer-readable storage medium” should be understood to include tangible items and exclude carrier waves and transient signals.

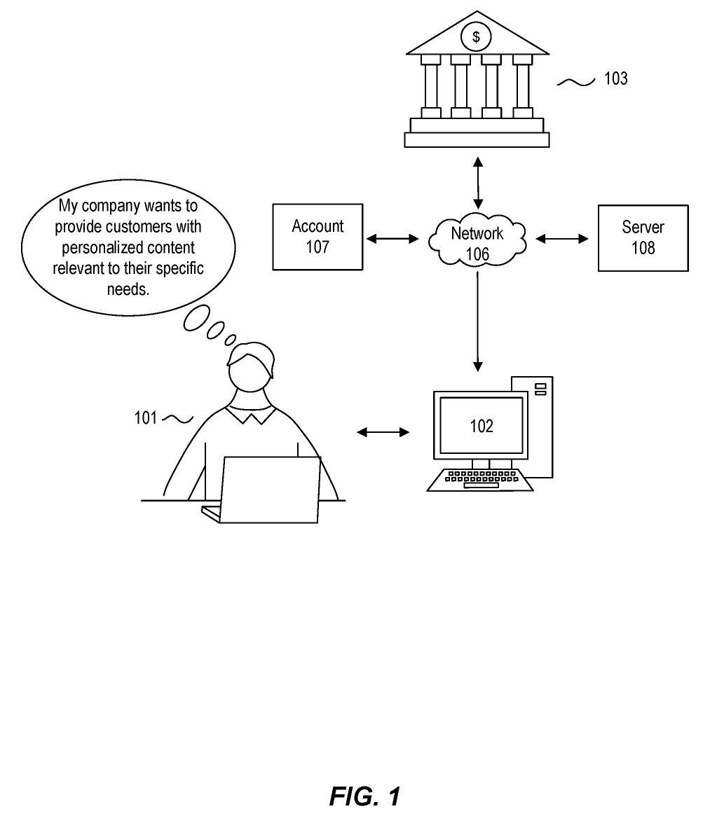

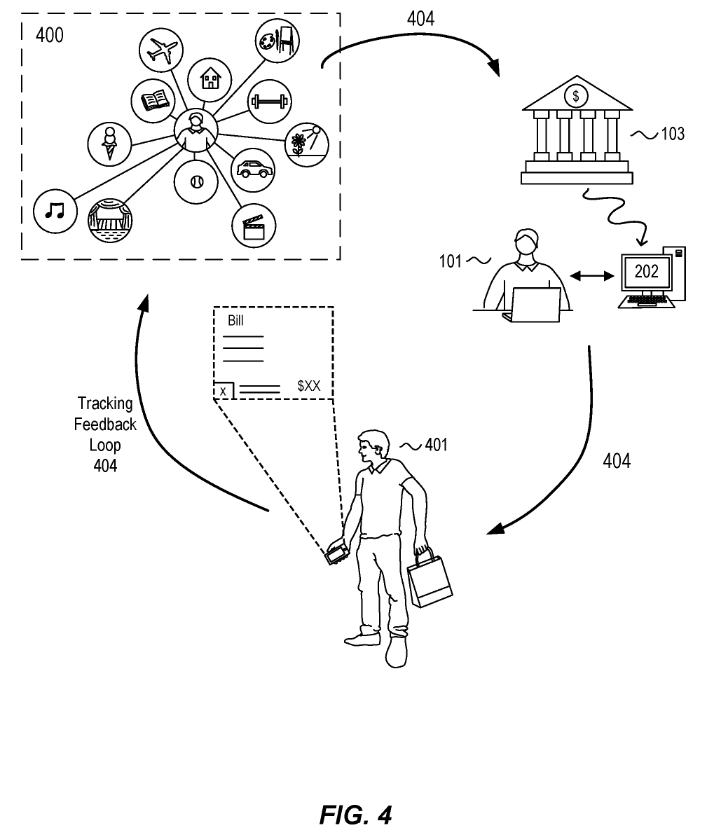

FIG. 1 depicts an exemplary illustration of user 101 using a computer 102 to generate content. User 101, as described herein, may be, for example, an individual, team of individuals, a customer, a financial institution, or an organization. Computer, as described herein, may refer to a device capable of connecting to the internet or executing instructions. User 101 may use an institution’s system to manually or automatically send generic content over network 106 to the institution’s customers which may be users 101. Network 106, as described herein, may refer to an environment in which activities of user 101 on computer 102 may be recorded, transmitted, or stored. Network 106 may also facilitate communication between institution 103, computer 102, account 107, and server, 108. User 101 or the institution’s system may collect contact information from account 107 and distribute generic, sponsored, or promoted content from institution 103 to user 101 at an interval. Institution 103, as described herein may be an entity, such as, for example, a business, organization, or financial institution. Institution 103 may securely send the information to user 101 digitally over network 106. User 101 may opt into or out of receiving such information, like emails and text messages, via account 107 or by communicating with institution 103. Account 107, as described herein, may refer to one or more records of information, such as financial information and transactions. Account 107 may also contain personal information about a user (such as customer 401, as further described in FIG. 4), such as, for example, name and birthday, or account information, such as, for example, holdings, balances, when account 107 was opened, withdrawals, deposits, regular and irregular account activity, debts, automatic transaction settings, loans, payment history, and interest earned. As illustrated in FIG. 1, user 101 considers: “My company wants to provide customers with personalized content relevant to their specific needs.”

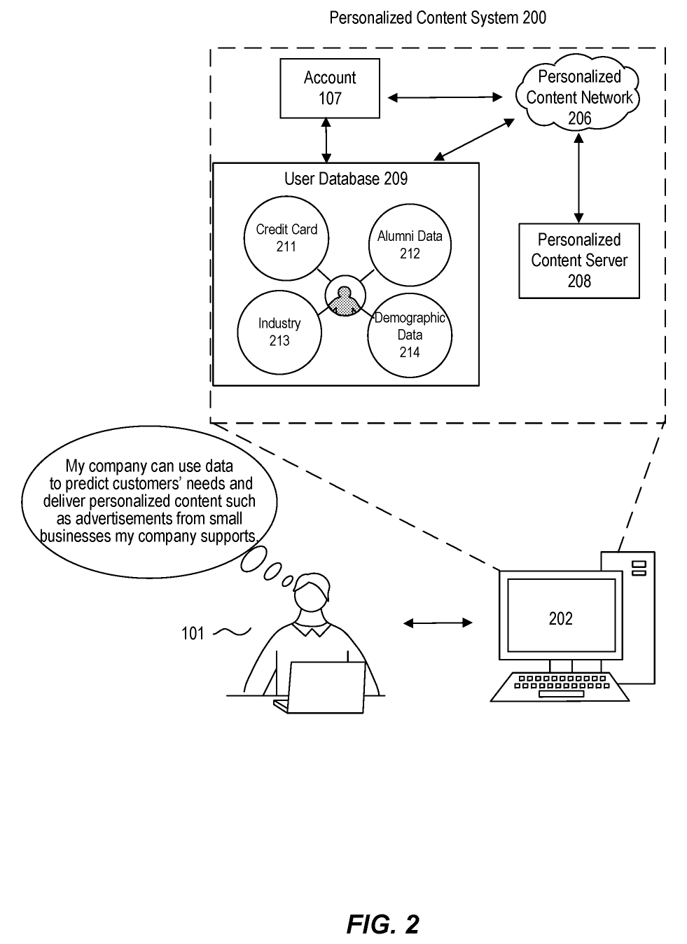

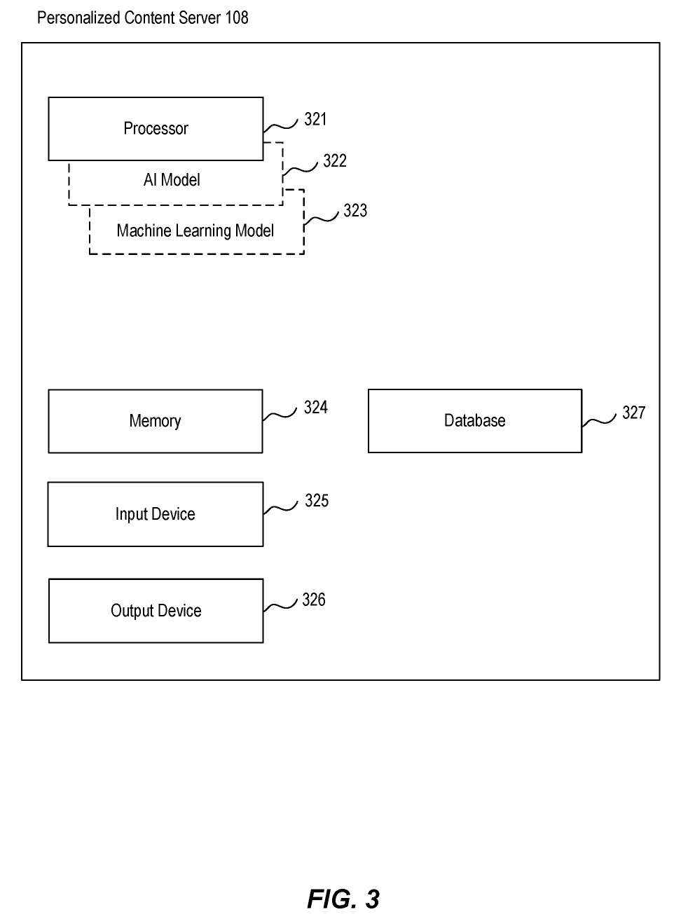

FIG. 2 depicts an exemplary illustration of user 101 using the computing device 202 to predict a user’s (such as customer 401’s, as further described in FIG. 4) needs and deliver personalized content. In some embodiments, the user may be a customer. Computing device 202, as described herein, may refer to a stationary or mobile device capable of connecting to the internet, including a laptop computer, desktop computer, mobile phone, tablet, smartwatch, or any other user device. User 101 considers: “My company can use data to predict customers’ needs and deliver personalized content such as advertisements from small businesses my company supports.” Personalized content system 200 may use computing device 202 to predict customer needs and interests from data in user database 209 and generate personalized content. Personalized content, such as personalized marketing content, as described herein, may refer to materials tailored to individual users or groups of users based on their unique data, preferences, and behaviors. Personalized content may be generated and delivered to customers on a periodic basis or may be generated and delivered to customers upon the happening of some trigger. A trigger, as described herein, may refer to an event occurring in account 107 that causes a specific response. Triggers may include, for example, an account balance falling below or rising above a predetermined threshold, account 107 receiving a large deposit, a customer making a withdrawal larger than a predetermined threshold, the customer placing their credit card on a travel hold, the customer purchasing flights or making hotel reservations, the customer changing the home address listed on account 107, or the customer applying for a mortgage loan. In some embodiments, the periodic basis may be hourly, daily, weekly, biweekly, monthly, or some other period. In other embodiments, personalized content may be generated and delivered if personalized content system 200 recognizes that the customer is traveling or moving residences. User database 209, as described herein, may refer to a database, further described in FIG. 3, storing data about the user including banking data.

Banking data may include, for example, credit card data 211, and external data, such as demographic data 214, industry data 213, and alumni data 212. Credit card data 211, as described herein, may refer to data related to the customer’s credit card history and usage, and may include transaction history, payment history, merchants frequently shopped at, and an average amount spent for different types of purchases. Demographic data 214, as described herein, may refer to data related to the customer’s identity and may include age, sex, race, ethnicity, education, and income. Industry data 213, as described herein, may refer to data related to the customer’s career, such as which industry the customer works in. Alumni data 212, as described herein, may refer to data related to where and when the customer went to school and what affiliations they may have. Together, credit card data 211, alumni data 212, industry data 213, and demographic data 214 may be received by personalized content system 200 and create a fuller picture of who the customer is and what their interests and needs may be.

Personalized content system 200 may include personalized content network 206, personalized content server 208, and account 107. Various components of personalized content system 200, including computing device 202, may communicate over personalized content network 206. Personalized content network 206, as described herein, may refer to one or more environments in which relevant activities of the customer on computing device 202 may be recorded and stored for future viewing. The recording, transmission, and storage of the recorded user activity may be performed in a secure manner, such that only the institution and the customer may have access to the recorded activity.

Such communications over personalized content network 206 may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, communications may take place across two or more of these forms of networks and protocols. In other embodiments, personalized content network 206 may also be a localized system, with one or more of the components communicating directly with each other.

Personalized content server 208, as described herein, as further described in FIG. 3, may refer to one or more digital and/or analog devices that allow communication with other machines and devices. The computing device, personalized content server 208, the institution, and account 107 may communicate with one another over personalized content network 206.

Account 107, as described herein, may refer to a record of information, such as financial information, and transactions. Account 107 may also include personal information about the customer, such as name and birthday, or account information, such as holdings, balances, when the account was opened, withdrawals, deposits, regular and irregular account activity, debts, automatic transaction settings, loans, payment history, and interest earned.

FIG. 3 depicts a block diagram showing an exemplary computational device, consistent with disclosed embodiments. Personalized content server 208 may include a dedicated processor and/or memory. For example, personalized content server 208 may include processor (or multiple processors) 321, and memory (or multiple memories) 324.

Processor 321 may take the form of, but is not limited to, a microprocessor, embedded processor, or the like, or may be integrated in a system on a chip (SoC). Furthermore, according to some embodiments, processor 321 may be from the family of processors manufactured by Intel®, AMD®, Qualcomm®, Apple®, NVIDIA®, or the like. Processor 321 may also be based on the ARM architecture, a mobile processor, or a graphics processing unit, etc. The disclosed embodiments are not limited to any one type of processor.

Processor 321 may include an artificial intelligence model 322 and/or a machine learning model 323. Artificial intelligence model 322, as described herein, may refer to a computer program trained on data to recognize patterns and make decisions with no or minimal human programming. Machine learning model 323, as described herein, may refer to a set of instructions that enable computing devices to learn from data, make predictions and improve their performance overtime with no or minimal human programming. Machine learning model 323 may refer to a model that can find patterns or make decisions from a dataset. Various machine learning models 323 may be implemented by analyzing user data and personalized content usage data to detect a user’s (such as customer 401’s, as further described in FIG. 4) interests and location, predict the user’s needs, and generate personalized content to meet those needs. User data, as described herein, may refer to information collected about a user as they interact with websites, applications, services, an institution, or other users. In some embodiments, user data may include contact information, login credentials, purchase history, payment history, user location, device location, internet browsing habits, or behavioral data. In some embodiments, machine learning model 323 may be used to generate a data analysis algorithm trained to predict relationships between local businesses and user needs, interests, and location. In other embodiments, machine learning model 323 may be used to generate a data analysis algorithm trained to predict relationships between a desired personalization level and content. Machine learning model 323 may utilize several steps for operation. Machine learning model 323 may use a query system to draw in and ingest new data and may use preprocessing and transformation steps to clean, normalize, and transform data before storing it. In some embodiments, data may be stored indefinitely while in other embodiments data be stored for a shorter period of time, such as for as long as the data is relevant. For example, customer data may be stored until a customer associated with the customer data ceases to be a customer. Machine learning model 323 may also use a monitoring operation to monitor data flow, detect anomalies, or ensure data optimization. In some embodiments, machine learning model 323 may have a trigger for retraining. In some embodiments, ingestion of new data may trigger retraining or fine tuning of machine learning model 323. In some embodiments, machine learning model 323 may retrain itself by use of back propagation to make predictions and compare them to actual outcomes. In some embodiments, machine learning model 323 may be trained using historical data and may continuously adjust internal parameters. In some embodiments, machine learning model 323 may be validated using separate datasets to assess accuracy, precision, recall, and other metrics. In other embodiments, machine learning model 323 may be evaluated through cross- validation or confusion matrices. Machine learning model 323 may be able to output a variety of data including scores, classifications, and recommendations. Machine learning model 323 may be configured to accept a variety of inputs, including text, image, audio, time series inputs, categorical inputs, numerical inputs. Machine learning model 323 may accept, for example, historical data, user data, merchant data, user interaction data, patterns or pattern data, user activity or user activity data, position data, location data, a set of rules, or a score, as inputs.

For example, in some embodiments, machine learning model 323 may be used to predict whether a user will interact with personalized content, such as advertisements, promotions, offers, coupons, discounts, or suggestions. Machine learning model 323 may be trained in a variety of ways. For example, machine learning model 323 may be trained on a series of messages containing personalized content delivered to a specific user and the response from that user. The messages may include messages delivered to a user during a period of time prior to training, such as one month or one year. The responses may include that the user deleted the message without opening it, opened the message and viewed the content, or opened the message and further interacted with the content, such as by clicking a link within the message.

In some embodiments, machine learning model 323 may be shown twelve messages the user received in January and told the user deleted each without opening them, shown several messages the user received in February and March with discounts to a clothing boutique the user shopped at before and told the user opened some of the messages to view to content but deleted others without opening, and shown a few messages the user received during the year containing coupons for a local pizza shop and told that the user opened each and clicked a link to the pizza shop’s website.

Machine learning model 323 may learn from the examples and may further be trained by being shown training messages and predicting the user response level. For each training message, machine learning model 323 may make a prediction, which may then be confirmed or corrected until machine learning model 323 is able to accurately predict the user response a threshold amount of the time. For example, machine leaning model 323 may be shown a message containing personalized content set to be sent in January and machine learning model 323 may predict that the user will open the message and further interact with it. Machine learning model 323 may be informed its prediction was incorrect and be informed that the correct prediction is that the user will delete the message without opening it. In another example, machine leaning model 323 may be shown a message containing a coupon for 40% off large two-topping pizzas good this week only and machine learning model 323 may predict that the user will open the message and further interact with it. Machine learning model 323 may be informed its prediction was correct and carry on to the next message for prediction.

During operation, machine learning model 323 may be configured to accept specific inputs. For example, an institution wishing to send users personalized content may generate personalized content of its own or receive promotions or other content from other organizations to distribute to users. The institution may wish to determine which content should be distributed to specific users based on their needs and interests. The generated personalized content from the institution and other organizations may be received as an input to machine learning model 323. Machine learning model 323 may receive the personalized content and predict how a particular user may respond to a message containing the personalized content. Machine learning model 323 may output the predicted response, which may be used by the personalized content system to determine what content should be sent to particular users so that personalized content is sent to users who will have the most positive responses.

While in the above example, machine learning model 323 may be trained from a user’s prior interactions with personalized content, in another embodiment, machine learning model 323 may be trained from a user’s prior activities to recognize habits, routines, interests, and preferences, before the personalized content is generated. Machine learning model 323 may use this training to determine which content to generate for the user.

For example, in some embodiments, machine learning model 323 may be trained from user activities. Machine learning model 323 may be provided the user’s activities, such as a user’s transactions and the location where the transactions were made for a period of time. Machine learning model 323 may be trained to recognize that repeat activity or location may indicate an interest, habit, preference, or routine. For example, machine learning model 323 may receive user activities and locations for training and see that the user receives a large deposit of Sum P every other Friday, goes to Grocery Store X every Saturday, shops at Grocery Store Y only on occasion, stops at Convenience Store C most weeks but not on a specific day, and travels one hour north to Town T on the first Thursday of every month.

During training, machine learning model 323 may be trained that routine deposits of a similar amount that exceed a certain threshold, such as Sum P, may indicate a user’s pay day and may play a role in the user’s routine. Further, machine learning model 323 may be trained that a user who engages in the same activity on the same day and location every week indicates a habit, routine, or interest of the user, and therefore the user may be interested in receiving personalized content relating to that activity. For example, when the user shops at Grocery Store X every Saturday, machine learning model 323 may be trained that a user shopping at an establishment every week is a routine and the user is likely interested in content related to their routine, such as personalized content the establishment, others like it, or the product or service sold by the establishment.

Machine learning model 323 may also be trained to recognize preferences and habits. Machine learning model 323 may be trained that since user shops at Grocery Store X every Saturday but only shops at Grocery Store Y on occasion, the user prefers Grocery Store X, though the user may be interested in both. Machine learning model 323 may also be trained to recognize that the user has a habit of spending more money at Grocery Store X on weeks that the user is paid Sum P.

Machine learning model 323 may be trained that a user who engages in an activity every week or most weeks but not on a specific day may be interested in personalized content relating to that occasional activity but they may not be as interested in the occasional content as they are in content relating to their routine. For example, from the above, the user has made shopping at Grocery Store X every Saturday part of their routine but sporadically shops at Convenience Store C. Machine learning model 323 may be trained to recognize that while the frequency of visits may be similar, shopping at Grocery Store X may be a routine but shopping at Convenience Store C may be an interest. Thus, machine learning model 323 may infer that the user may be less interested in personalized content relating to Convenience Store C than personalized content relating to Grocery Store X. This way, machine learning model 323 learns that a user engaging in an activity doesn’t necessarily mean the user wishes to receive personalized content related to that activity. Such a prediction may be reinforced or overridden by the user’s reaction to personalized content relating to their routine and/or their interest (such as shopping at Convenience Store C).

Machine learning model 323 may also be trained based on a user’s location. Machine learning model 323 may be trained that when a user visits a certain part of town or a neighboring town, such as Town T, at a specific interval, the user may have a routine and may be interested in personalized content relating to activities in that town that the user may engage in. For example, the user may have as a routine to visit Town T on the first Thursday of every month, buy lunch in Town T, and shop in town T. Machine learning model 323 may be trained to recognize this routine and that the user may be interested in personalized content relating to dining and shopping town T during the time leading up to the user’s visit.

Machine learning model 323 may learn from the examples and further train by receiving user activities for a period and determining the user’s interests, routines, habits, and preferences. For each set of user activities, machine learning model 323 may determine whether an activity indicates an interest, routine, habit, or preference, which may then be confirmed or corrected until machine learning model 323 is able to make accurate determinations a threshold amount of the time. For example, machine learning model 323 may receive user activity including that the user spends exactly Sum R on the second day of every month on rent for Apartment A, dines at Deli D every weekday during lunch hours, and visits Golf Course G every Sunday and a few other days each month. Machine learning model 323 may initially determine that the user is interested in apartments and has a habit of making a rent payment on the second day of each month. Machine learning model 323 may be informed its determination was partially correct and be informed that the correct determination is that the user has a habit of making a rent payment on the second day of each month but that the user is likely not interested in apartments.

In another example, machine leaning model 323 may determine that the user is interested in Deli D and has made going there for lunch a routine. Machine learning model 323 may be informed its determination was correct and continue assessing user activities. In another example, machine learning model 323 may determine that the user is interested in golf because the user engages in golf-related activities more than, for example, four times per month and that the user has a routine of golfing weekly. Machine learning model 323 may be informed its determination was correct and continue assessing user activities.

During operation, machine learning model 323 may be configured to accept specific inputs. For example, machine learning model 323 may receive user activity data from an institution wishing to generate personalized content. The institution may wish to determine which content should be distributed to specific users based on their needs and interests. Machine learning model 323 may receive the user activity data and determine which activities the user is interested in and prefers, and which activities are part of the user’s routine. Machine learning model 323 may output the determination which may be used by the personalized content system to generate personalized content for a particular user.

Memory 324 may include a storage device configured to store instructions used by processor 321 to perform functions related to the computing device. The disclosed embodiments are not limited to software programs or devices configured to perform dedicated tasks. For example, memory 324 may store a single program, such as a user level application, which performs the functions associated with the disclosed embodiments or may include multiple software programs. Additionally, processor 321 may, in some embodiments, execute a program (or portions thereof) remotely located from personalized content server 208. Furthermore, memory 324 may include a storage device configured to store data for use by the programs. Memory 324 may include, but is not limited to, a hard drive, a solid-state drive, a CD-ROM drive, a peripheral storage device (e.g., an external hard drive, a USB drive, etc.), a network drive, a cloud storage device, or any other storage device.

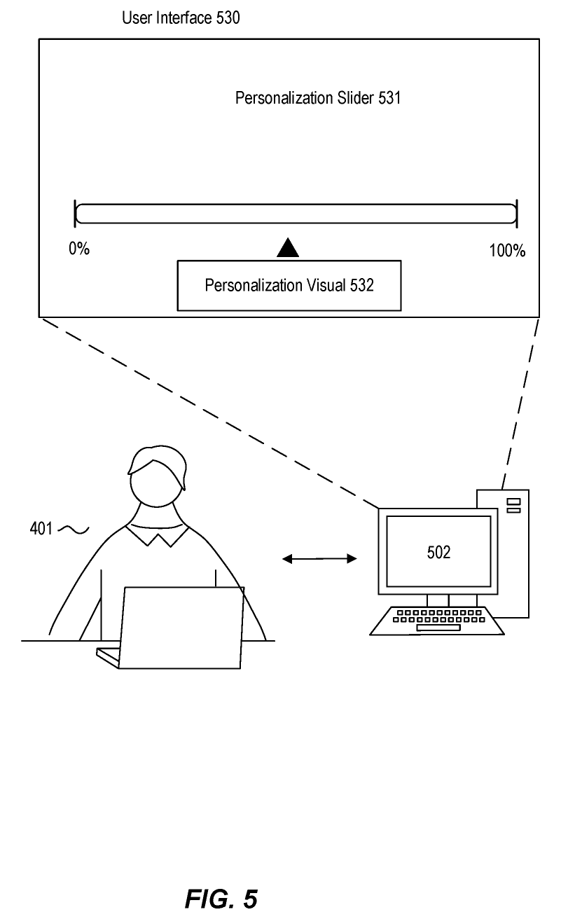

Personalized content server 208 may include a digital and/or analog device that allow communication with other machines and devices, such as other components of the personalized content system, as described with respect to FIG. 2. Personalized content server 208 may also include input device 325 and output device 326. Input device 325 may be configured to receive input from the user, and components of personalized content server 208 may perform a function in response to the input received. In some embodiments, input device 325 may include a user interface, as described, for example, with respect to FIG. 5, displayed on a touchscreen (e.g., output device 326). As such, input device 325 and output device 326 may be combined into an input/output device. Output device 326 may include a screen for displaying communications to the user. For example, output device 326 may include a display configured to display the information relating to the transaction. Personalized content server 208 may include other components known in the art for interacting with a user. Output device 326 may also include a digital and/or analog device that allows a user to interact with the personalized content system such as touch sensitive area, keyboard, buttons, or microphones.

In some embodiments, personalized content server 208 may include database 327. Database 327 may be included on a volatile or non-volatile, magnetic, semiconductor, tape, optical, removable, non-removable, or other type of storage device or tangible or non-transitory computer-readable medium. Database 327 may also be part of personalized content server 208 or separate from personalized content server 208. When database 327 is not part of personalized content server 208, personalized content server 208 may exchange data with database 327 via a communication link. Database 327 may include a memory device that stores data and instructions used to perform a feature of the disclosed embodiments. Database 327 may include any suitable databases, ranging from small databases hosted on a workstation to large databases distributed among data centers. Database 327 may also include any combination of databases controlled by memory controller devices (e.g., server(s)) or software. For example, database 327 may include document management systems, Microsoft SQL™ databases, SharePoint™ databases, Oracle™ databases, Sybase™ databases, other relational databases, or non-relational databases, such as mongo and others.

FIG. 4 depicts a flow diagram showing an exemplary process for providing personalized content. Personalized content, as described herein, may refer to advertisements, promotions, offers, coupons, discounts, or suggestions. User 101 may use a computing device 202, as described with respect to FIG. 2, to access an account, as described with respect to FIG. 2. Institution 103 may communicate with user 101 through the account. Communication may include notification of transactions, deposits, withdrawals, payment deadlines, or personalized content. Institution 103 may store a variety of information about customer 401, user activity (such as customer activity), and user interests (such as customer interests). The user interests may be minimal or expansive. The longer customer 401 utilizes an institution’s services, the more institution 103 may understand the user interests. Customer 401 may have a network of interests 400 involving their home, food, travel, or hobbies like painting exercise, gardening, automobiles, movies, performances, sports, or other hobbies and interests.

In some embodiments, institution 103 may facilitate open banking to further understand customer 401’s interests, needs, and financial situation. Open banking may involve securely linking the account to an external account. External account, as described herein, may be, for example, a bank account, an investment account, or a financial technology account. In some embodiments, the external account may be a retail account or an account associated with one of customer 401’s interests, hobbies, or subscriptions. Linking the account to the external account may allow institution 103 to track customer 401’s progress across each of customer 401’s accounts. Linking the account and the external account may allow institution 103 to collect user data (such as customer data) from a company that the external account is associated with. In some embodiments, institution 103 and the company may exchange the user data. In some embodiments, institution 103 and the company may review and accept each other’s terms of use and/or privacy policies to learn how institution 103 and the company may use, share, or sell the user data, which may include, for example, a transaction history, a spending history, a saving history, a user goal, a goal timeline, and a login history. Open banking may allow institution 103 and the personalized content system, as described with respect to FIG. 2, to consider customer 401’s activity across all of their accounts and/or platforms. From what institution 103 knows and learns about customer 401, institution 103 may generate and deliver, via the account, personalized content to customer 401. As institution 103 gains access to the external accounts, institution 103 and the personalized content system may provider smarter, more tailored content, such as, for example, messages, advertisements, recommendations, discounts, and coupons. In some embodiments, where user data is exchanged between the account and external account, the company that the external account is associated with may generate and deliver its own personalized content to customer 401 that may consider the user data shared from the account and/or another external account.

Institution 103 may then monitor the user activity and user interests and may determine if customer 401 utilized the personalized content. Institution 103 may utilize tracking feedback loop 404. Tracking feedback loop 404, as described herein, may refer to a feedback loop where institution 103 monitors the user activity to see which personalized content was utilized by customer 401 and which personalized content was not utilized by customer 401. In some embodiments, utilization by customer 401 may include whether customer 401 opened the personalized content, how long customer 401 spent looking at the personalized content, and whether customer 401 acted on the advice or offerings presented in the personalized content. In some embodiments, the personalized content may include a menu where customer 401 may flag the personalized content, save the personalized content, or share the personalized content. Flagging the personalized content may allow customer 401 to mark the personalized content that may not align with their personalization preferences, interests, or financial goals. Saving the personalized content may enable customer 401 to bookmark personalized content for later reading to support content tracking and repeat user engagement (such as customer engagement). Sharing personalized content may allow customer 401 to distribute personalized content to themselves or others, giving customer 401 control over their personalized content experience. The institution may then feed usage data or analytics from the utilization back into what it knows about customer 401, so it may better personalize future content.

FIG. 5 depicts an exemplary illustration of customer 401 using personal computing device 502 to adjust a desired level of personalization of content. Customer 401 may use personal computing device 502 to adjust personalization slider 531 via an input device, such as user interface 530. Personalization slider 531, as described herein, may be a setting associated with the account, as described with respect to FIG. 2, that may permit customer 401 to adjust the level of personalization used in the generation of personalized content. Personalization slider 531 may allow customer 401 to change their user experience by selecting how personalized they want the content they receive to be. In some embodiments, personalization slider 531 may range from no personalization to maximum personalization. In other embodiments, personalization slider 531 may have a minimum selectable personalization level that is higher than no personalization. Personalization slider 531 may also have a maximum selectable personalization level that is lower than full personalization. The maximum selectable personalization level may be based on a personalization possible for a given institution and may be limited to allow the institution to deliver certain types of content associated with the institution. For example, customer 401 may be prevented from excluding advertisements as part of their personalization option. Personalization slider 531 allows customer 401 to select a level of personalization with which they are comfortable. In some embodiments, personalization slider 531 may have a default position that may be set to the maximum personalization level. In other embodiments, personalization slider 531 may have a default position determined from a user’s data to be set at a level the system predicts is right for customer 401. In some embodiments, the desired level of personalization of content may be adjusted by use of, for example, a numerical entry; a digital personalization dial; selection of predefined personalization levels, such as in a drop down list or a menu; stepwise incremental and decremental controls; toggle switches to activate or deactivate personalization; a scroll wheel; swipe gestures; pinch and spread gestures; drag and drop interactions; or time- and pressure-sensitive input.

When customer 401 selects a personalization level on personalization slider 531, personalization visual 532 may change to provide customer 401 with an example of personalized content at the new selected personalization level. In some embodiments, personalization visual 532 may change fluidly such that minor changes in selected personalization level causes minor changes in personalization visual 532. In other embodiments, personalization visual 532 may change at intervals such that a selected personalization level may display the same personalization visual 532 as a personalization level plus or minus, for example, a five percent difference in personalization level.

In some embodiments, personalized content system 200, as described with respect to FIG. 2, may aggregate data across accounts, as described with respect to FIG. 2, and the machine learning model, as described with respect to FIG. 3, may be used to find patterns between user data and user comfortability with personalized content.

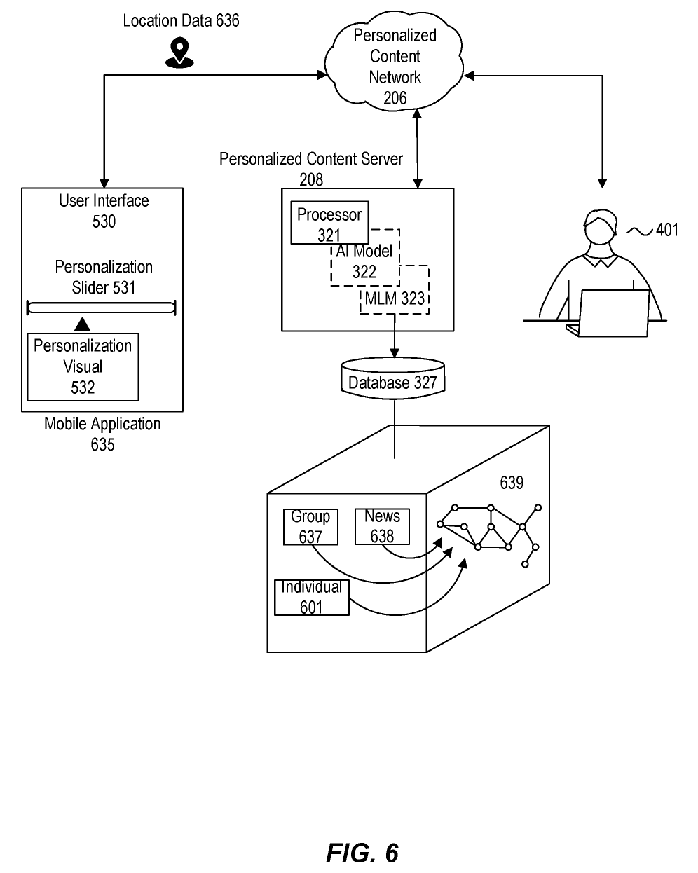

FIG. 6 depicts a flow diagram showing an exemplary process for delivering personalized content, such as personalized marketing content. The personalized content system, as described with respect to FIG. 2, may receive data into database 327, as described with respect to FIG. 3. The data may include user data relating to individual 601 and group 637. Group 637 may be identified when more than one individual 601, for example, is detected at an event, shares affiliations with organizations, shops at the same stores, or lives in the same city. Group 637 and group data help personalized content system 200 better understand communities. The personalized content system may invite individual 601 to join group 637 and may incentivize participation in group 637 by offering rewards or exclusive offers. The data may also include news 638 relevant to individual’s 601 location and the type of personalized content the institution wants to deliver.

Personalized content system, may also receive location data 636 into database 327. Mobile application 635 may ask customer 401’s permission to use and receive location data 636. Location data 636 may provide additional insights regarding customer activity, needs, and interests, allowing for delivery of more accurate personalized content. In some embodiments, personalized content system may use location data 636 to detect that customer 401 shops at Store A every Friday but never uses Store A’s credit card and subsequently deliver to customer 401 an offer or discount on Store A products or Store A’s credit card. In another embodiment, personalized content system 200 may use location data 636 to detect customer 401 traveling to City B. From the customer 401’s data, personalized content system 200 may predict where customer 401 likes to eat and shop. In some embodiments, personalized content system may push notifications to customer 401’s mobile device (which may correspond to personal computing device 502) and mobile application 635, suggesting businesses and restaurants to visit and creating suggested destinations in customer 401’s mobile device’s navigation application. Customer 401’s mobile device may transmit data, including location data 636, to a server, as described with respect to FIG. 3, over a network, as described with respect to FIG. 3, where it may be received into database 327.

Customer 401 may change their selected personalization level at any time with personalization slider 531 via user interface 530 on a computing device. Customer 401 may see how personalization visual 532 changes as customer 401 selects different personalization levels. Customer 401 may access personalization slider 531 by logging into their account after accessing the account website or opening mobile application 635. Mobile application 635 may provide customer 401 access to their account on a mobile device.

Before or after data is received into a database, it may be processed by a processor, as described with respect to FIG. 3. A processor, such as processor 321 may utilize artificial intelligence model 322 or machine learning model 323, both as described with respect to FIG. 3. The artificial intelligence model 322 or machine learning model 323 may identify patterns in data, such as location data 636 or personalization data, to assist with generating better, more relevant, personalized content. In some embodiments, machine learning model 323 may be trained to recognize such patterns. For example, in some embodiments, machine learning model 323 may be trained from user activity. Machine learning model 323 may be provided the user activity, such as customer 401’s transactions and a location where the transactions were made for a period of time. Machine learning model 323 may be trained to recognize that frequent activity at a location may indicate an interest or routine, either of which may indicate that customer 401 is interested in personalized content related to the location. Machine learning model 323 may be taught from exemplary user activity and locations and whether a pattern exists. Such exemplary user activity, locations, and pattern determination may include that a majority of user activity occurs in Town A, where customer 401 resides, customer 401 dines at restaurants in City C for lunch every weekday, and customer 401 pays a shoe rental fee at a cycling studio in Town B on most Sunday mornings. Machine learning model 323 may be told that activities occurring sporadically in Town A do not indicate a pattern, customer 401 dining in City C on weekdays indicates a pattern that customer 401 commutes to City C during the week, and customer 401 paying a shoe rental fee indicates a pattern of customer 401 being in Town B on Sundays.

Machine learning model 323 may learn from the examples and may further be trained by receiving user activity and locations and determining if a location pattern exists. For each set of user activities, machine learning model 323 may determine whether user activity indicates a location pattern, the pattern being confirmed or corrected until machine learning model 323 is able to make accurate determinations a threshold amount of the time.

In another embodiment, machine learning model 323 may be trained from user interaction data, such as how or if customer 401 interacted with personalized content, and personalization data, such as customer 401’s personalization level set by customer 401’s personalization slider. Machine learning model 323 may be provided customer 401’s personalization data and interaction data for a period of time and trained to recognize an effect of the personalization data on the interaction data. Such an effect may include that customer 401 did or did not interact with personalized content when their personalization level was a specific level and they were delivered personalized content that was personalized to that level.

Machine learning model 323 may be taught from exemplary personalization and interaction data whether a pattern exists. Such examples may involve a personalization slider with personalization levels ranging from zero to one hundred, where a personalization level of zero may result in a minimum amount of personalization for the application and a personalization level of one hundred may result in a maximum amount of personalization for the application. Such examples may include that when customer 401 has a personalization level set to lower than fifty-five, customer 401 did not interact with personalized content they were delivered; when customer 401 has a personalization level set between fifty-five and sixty-five, they interacted with the personalized content they were delivered most of the time; when customer 401 has a personalization level set between sixty-five and seventy, customer 401 always interacted with the personalized content they were delivered; and when customer 401 has a personalization level set above seventy, customer 401 seldom interacted with personalized content they were delivered. In this example, machine learning model 323 may learn that increasing a personalization level beyond a given point may lead users, such as customer 401, to engage less with personalized content, instead of more. Based on this given point, machine learning model 323 may learn that there is an optimum amount of personalization, which may differ based on user characteristics (such as customer characteristics), and that exceeding this optimum amount of personalization may lead to customer 401 engaging less with personalized content. For example, customer 401 may desire a degree of personalized advertising, such as advertising associated with golf equipment when customer 401 has repeatedly shown an interest in golf and purchasing golf equipment. Customer 401, however, may not desire targeted advertising associated with single internet searches or sporadic indications of interest. Customer 401 may find such targeted advertisements too invasive and may therefore limit their interaction with the personalized content. Machine learning model 323 may use these trends to limit the personalization level available to customer 401 or may use these trends to recommend an optimum amount of personalization.

Machine learning model 323 may learn from the examples and may further be trained by receiving personalization data and determining a likelihood of user interaction. In some embodiments the likelihood of user interaction may be a percent chance of customer 401 interacting and in other embodiments the likelihood of user interaction (such as customer interaction) may be that yes, customer 401 will interact or no, customer 401 will not interact. For each personalization level received, machine learning model 323 may determine whether customer 401 is likely to respond to personalized content based on the personalization data, the determination being confirmed or corrected until machine learning model 323 is able to make accurate determinations a threshold amount of the time.

In some embodiments, a database may be a graph database 639. Graph database 639, as described herein, may refer to a database including nodes for storing data and edges representing relationships between data in the respective nodes. Nodes in graph database 639 may refer to entities or groups associated with graph database 639, and edges in graph database 639 may refer to relationships between those groups.

In some embodiments, the personalized content system may communicate with a computing device at the institution’s branch location to prompt an employee to ask customer 401 questions or deliver personalized suggestions in person. For example, besides the personalized content system identifying patterns in data, personalized content system may determine whether the implications of a pattern are good or bad (i.e., relating to actions that the institution understands customer 401 should practice or avoid), such as by characterizing a pattern as a good pattern or a bad pattern. The personalized content system may then use the characterization to tailor advice to the employee or customer 401. In some embodiments, the personalized content system may track a variety of data and compare it against historical data, including how often customer 401 interacts with their account and a user’s savings rate, and timeliness of payments.

The personalized content system, by comparing historical datasets and current datasets, may identify a pattern of decline in the user’s interaction with their account. The personalized content system may recognize that customer 401’s interaction with their account has decreased each month for the last six months, and customer 401 did not interact with their account at all last month. The personalized content system may also identify a pattern of later payments by customer 401. The personalized content system may recognize that customer 401 usually pays their credit card bill quite early but has paid their credit card bill on dates closer to the deadline for each of the past six months and was late on their payment last month. The personalized content system may also identify a pattern of increased savings by customer 401 each month. The personalized content system may recognize that customer 401 has increased their monthly savings by three percent each month for the last six months making them more likely to meet their savings goal for the year.

The personalized content system may be configured to characterize patterns based on impacts to customer 401 or account health. Patterns that may harm account health may be characterized as negative patterns while patterns that may boost account health may be characterized as positive patterns. Here, the personalized content system may characterize increases in savings as a positive pattern since additional savings is a positive indicator for financial health and indicates account requirements, such as minimum balance, will not be an issue. However, the personalized content system may characterize decreases in account interaction and late payments as negative patterns since they may indicate a drop in user engagement, may indicate a decline in financial health, or may indicate some other issue. An outputted suggestion or advice to an employee or customer 401 may be tailored based on the characterization of the pattern as a positive pattern or a negative pattern. From the above example, the employee may be advised by the personalized content system, based on the negative pattern of declining account interaction, that customer 401 is unable to access their account or does not know how to best utilize their account features, and the employee may be provided with resources on account features and troubleshooting, which the employee can then present to customer 401 to improve the user’s financial health. In another embodiment, the employee may be advised by the personalized content system, based on the positive pattern of increased savings, that customer 401 is likely to reach their savings goal earlier than expected and may want to consider utilizing a specific financial instrument.

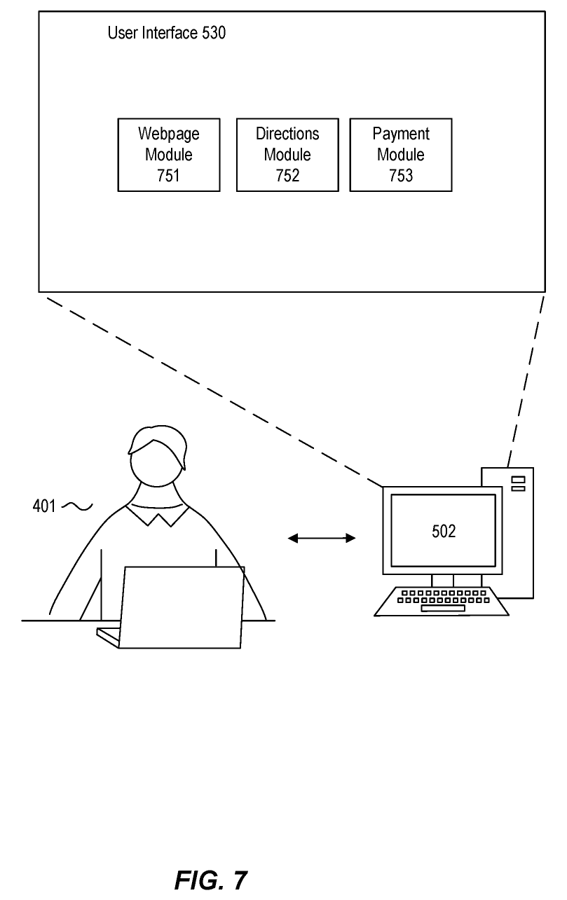

FIG. 7 depicts an exemplary illustration of customer 401 using personal computing device 502 to engage with dynamic content within personalized content, such as personalized marketing content. Customer 401 then uses personal computing device 502 to further explore information about the personalized content the user received. Once personalized content is delivered to an account, as described with respect to FIG. 2, or a user interface 530, as described with respect to FIG. 5, customer 401 may engage with dynamic content within the personalized content. In some embodiments, dynamic content may include webpage module 751, directions module 752, and payment module 753. Webpage module 751, as described herein, may refer to an embedded link to take customer 401 to an external webpage with additional information. Directions module 752, as described herein, may refer to an interactive map displaying a location of the subject of the personalized content. In some embodiments, customer 401 may click and drag the map, zoom in or out, access navigation on an external application or website, and access and print step by step text directions. Payment module 753, as described herein, may refer to an embedded link customer 401 may click on to be taken directly to the subject of the personalized content’s webpage to engage with the website and purchase goods or services.

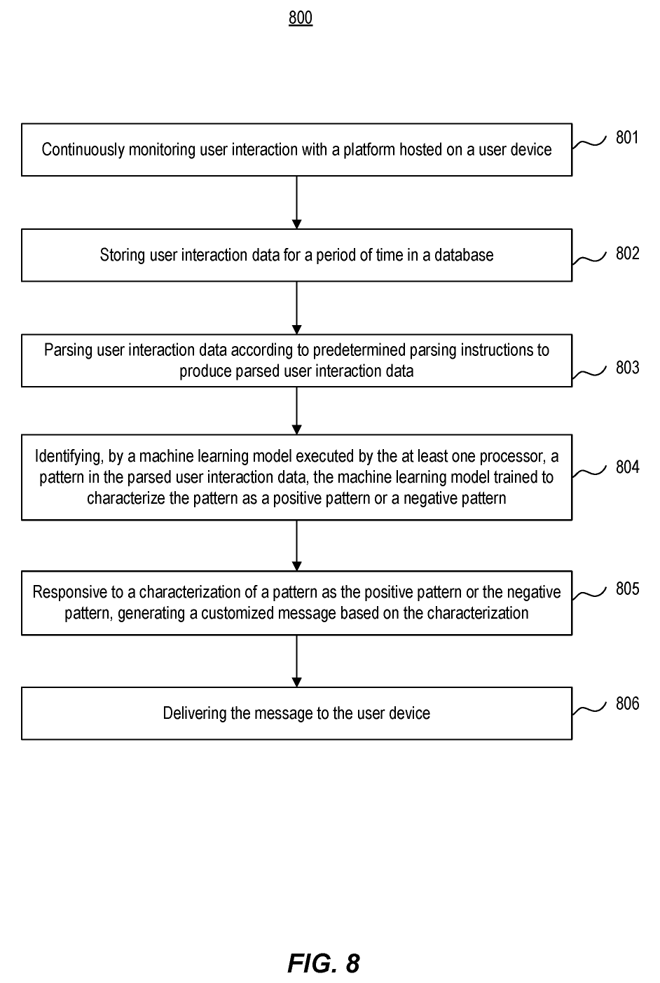

FIG. 8 depicts a flow chart for a method of predicting user needs. Some embodiments pertain to predicting users’ needs by monitoring users’ data, such as personal and banking data, to provide timely, personalized, relevant content, such as marketing content. Such embodiments may involve a computer system, for example, at a bank or institution, that monitors customer activity to provide timely, personalized, relevant content, such as marketing content. Method 800 may include a step 801 of continuously monitoring user interaction with a platform hosted on a user device. Platform, as described herein, may refer to a set of technologies or integrated services that support or develop other products, applications, or services. In some embodiments, the platform may be focused on personal banking or commercial banking. Personal banking may relate to an individual’s financials and commercial banking may relate to a business’s financials. In other embodiments, the platform may be a digital marketplace. Digital marketplace, as described herein, may refer to a platform where a seller, business, or service provider may offer its goods and services to users. In some embodiments, the platform may be part of a mobile application. User interaction, as described herein, may refer to an input entered by a user such as through an input device. User interaction may include actions or requests, such as, for example, logging in, withdrawing funds, depositing funds, making a payment such as paying a bill, scheduling a payment, reviewing account balances, scheduling an appointment, setting up direct deposit, requesting more information, or engaging with content. In some embodiments, the user device, as described herein, may be a computing device.

Method 800 may include a step 802 of storing user interaction data for a period of time in a database. User interaction data, as described herein, may refer to information related to a frequency at which the user interacts with content, how much time the user spends interacting with the content, and the method by which the user interacts with the content. In some embodiments, user interaction data may include a time and a frequency at which the system monitoring the user interaction detects the user accessing the platform to gauge a receptivity of a user to receiving the customized message and a best destination for delivering the customized message. Each time the user accesses the platform, the date and time may be recorded in a log. For example, the user data may include that the user accesses the platform on average three times per week. Date and time data in the log may indicate the user’s receptivity to receiving customized messages at a customization level. For example, there may be a correlation between the frequency at which the user accesses an account and the user’s engagement level with customized messages related to the account. Further, the date and time data in the log may assist in determining the best destination for delivering the message. For example, if the user only accesses the account once per month, then delivering the customized messages to the account may not be the best way to contact the user.

In another embodiment, the user data may include the time and frequency at which the user interacts with personalized content. For example, user interaction data may include information that the user interacted with personalized content four times during a week, the user spent an average of four minutes interacting with the personalized content per interaction, and the user interacted with the personalized content via user device. In some embodiments, the user interaction data may include paying a bill, and, from a plurality of user interactions, a machine learning model identifying a pattern of paying bills before the bills are due. In some embodiments, the user interaction data may include setting up direct deposit, and, from the plurality of user interactions, the machine learning model identifying the pattern of utilizing account features.

Method 800 may include a step 803 of parsing user interaction data according to predetermined parsing instructions to produce parsed user interaction data. Parsing, as described herein, may refer to the process of analyzing a string of data and structuring the strings of data into a more readable and usable format such as by transforming the data into a different form. Parsing may involve breaking down raw data, identifying relationships within the data, and restructuring the data for easier data analysis, improved efficiency, increased data quality, or increased productivity. Predetermined parsing instructions, as described herein, may refer to rules governing how data should be separated, extracted, converted, or formatted during parsing. In some embodiments, the predetermined parsing instructions may include instructions to extract names.

Method 800 may include a step 804 of identifying, by a machine learning model executed by the at least one processor, a pattern in the parsed user interaction data. The machine learning model may be trained to characterize the pattern as a positive pattern or a negative pattern. Pattern, as described herein, may refer to recurring features or elements in data, such as, for example, matching sequences of characters, similar formatting, matching file types, matching file data types, or matching values. Patterns may also refer to recurring like-actions taken or not taken by a user, such as, for example, making timely payments, making late payments, interacting with an account, a length of time between a user purchasing a service, or the time of day or day of the week the user usually shops for a good. Positive pattern, as described herein, may refer to a pattern indicative of choices that demonstrate good financial health, such as paying bills on time, regularly interacting with an account, or meeting a savings goal, and negative pattern, as described herein, may refer to patterns indicative of poor choices or declining financial health, such as making late payments, neglecting an account, or failing to contribute to a savings goal. In some embodiments, the machine learning model may be configured to forecast an outcome of one of either the positive pattern or the negative pattern.

In some embodiments, the machine learning model may be trained from historical user activity or interaction data to characterize the pattern as a positive pattern or a negative pattern. The machine learning model may be trained that a couple instances of an event or an action is not a pattern but that a threshold number of occurrences of an event or an action within a period of time is a pattern. The machine learning model may also be trained that patterns involving events or actions impacting account health or financial health may be characterized as positive or negative. More specifically, the machine learning model may be trained that a pattern of taking actions of a certain type may be a positive pattern, such as a user logging into and interacting with their account, but a pattern of failing to take such actions may be a negative pattern. The machine learning model may also be trained that a pattern of taking actions at a certain time may be a positive pattern, such as the user paying a bill on time, but a pattern of failing to take such actions at a certain time, such as paying a bill after it is due, may be a negative pattern.

The machine learning model may be shown exemplary user activity or user interaction data and whether a pattern exists. For example, such examples may include that the user has paid their credit card between one to four days after the due date for each of the last six months, except for one of the months where the user paid the bill one week before the due date. The machine learning model may be trained that, despite the single early payment, the data indicates a pattern of late payments, and since the pattern involves actions harmful to the user’s financial health, it is a negative pattern. Another example may include that the user logs into and interacts with their account three times per month: once one week before the user’s credit card bill is due and once the day after each of the user’s pay days. The machine learning model may be trained that there is a pattern of the user frequently interacting with their account and finances, and that because the pattern involves an action beneficial to the user’s financial health, it is a positive pattern.

The machine learning model may learn from the examples and may further be trained by receiving user activity and interaction data and determining whether a pattern exists and characterizing the pattern as a positive pattern or a negative pattern. For each set of data, the machine learning model may determine whether a pattern exists and how it should be characterized, which may then be confirmed or corrected until the machine learning model is able to make accurate determinations a threshold amount of the time. For example, the machine learning model may receive user activity data including that the user receives their monthly credit card statement on the tenth day of every month and makes the full payment on the statement on the eleventh day of every month. The machine learning model may identify a pattern of timely payments by the user and may categorize the pattern as a positive pattern. The machine learning model may be informed its determination was correct and continue assessing user activities.

During operation, the machine learning model may be configured to accept specific inputs. For example, the machine learning model may receive user activity data from an institution wishing to generate personalized content to send to the user. The institution may wish to provide the user with a warning, kudos, resources, or a suggestion based on the pattern and characterization. The machine learning model may output the identified pattern and characterization, which may be used by the personalized content system to generate personalized content for a particular user.

Method 800 may include a step 805 of responsive to a characterization of a pattern as the positive pattern or the negative pattern, generating a message based on the characterization. Messages, as described herein, may refer to an exchange of information, digitally or not digitally, between devices, users, or entities. Messages may include text, files, or images, may be dynamic or static, and may be interactive. In some embodiments, a message may be a positive message or may be a negative message. The positive message, as described herein, may, for example, be congratulatory or a kudos, may include a discount or coupon, may be encouraging or thankful, or may be otherwise positive in nature. The negative message, as described herein, may, for example, include a flag or warning, may include a penalty, may include recommendations or advice for improvement, or may be otherwise negative in nature. In some embodiments, the message may include an advertisement. In some embodiments, the pattern being characterized as the positive pattern prompts generation of a positive message. In other embodiments, the pattern being characterized as the negative pattern prompts generation of a negative message.

Method 800 may include a step 806 of delivering the message to the user device. Delivery, as described herein, may be, for example, automatic or manual, executed digitally, not digitally, via mobile device, via laptop or desktop computer, via text message or direct messaging, via email, via phone call, or via a notification such as a push notification.

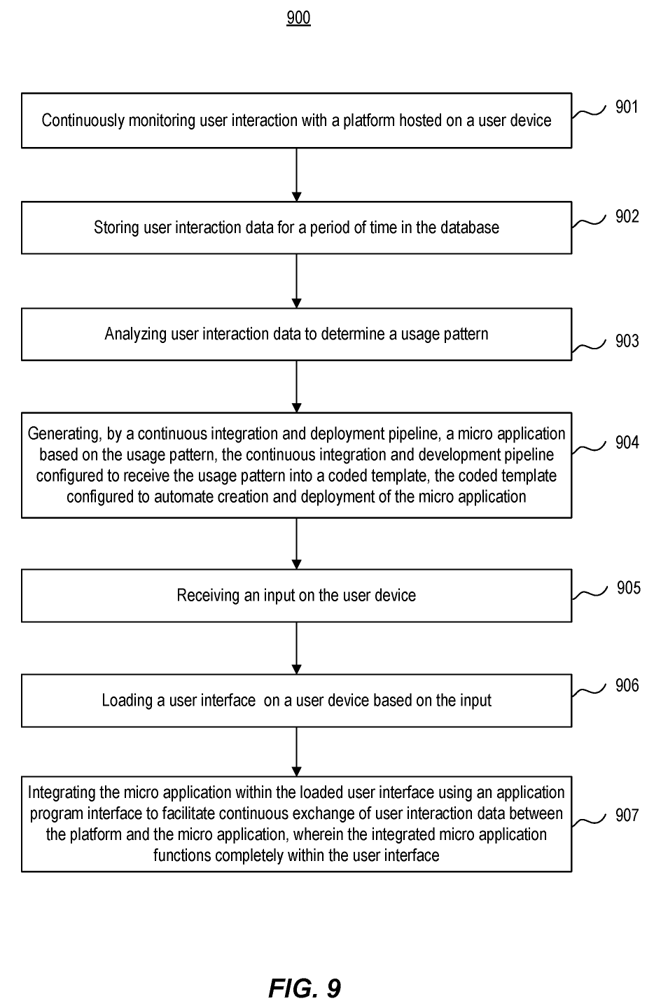

FIG. 9 depicts a flow chart for a method of providing dynamic content. Some embodiments pertain to providing personalized dynamic content within personalized content, such as marketing content, on a user interface. Such embodiments may involve a computer system, for example, at a bank or institution, that builds personalized dynamic content into personalized content. Method 900 may include a step 901 of continuously monitoring user interaction with a platform hosted on a user device. In some embodiments, the platform may be part of a mobile application.

Method 900 may include a step 902 of storing user interaction data for a period of time in a database. Method 900 may include a step 903 of analyzing user interaction data to determine a usage pattern. Usage patterns, as described herein, may refer to a pattern within the user interaction data. In some embodiments, usage patterns may be a spending pattern, a travel pattern, or a browsing pattern. In some embodiments, the usage pattern may be a spending pattern, highlighting a transaction preference of the user. In some embodiments, the usage pattern may be a travel pattern, the travel pattern highlighting a movement preference of the user. And in some embodiments, the usage pattern may be a browsing pattern, the browsing pattern highlighting an information consumption preference of the user. Usage patterns may include, for example, making timely payments, making late payments, regularly interacting with an account, a distance traveled for a good or service, patterns in a search history, a length of time between a user purchasing a service, or the time of day or day of the week the user usually shops for a good. In some embodiments, analysis of the user interaction data may occur by comparing user interaction data, including account information, transaction history, location history, search history, data related to how and when the user access their account, and account balance, over multiple periods of time, such as, for example, weeks, months, or years. For analysis, the user interaction data may be gathered in a uniform format and examined for consistency or change over time. For example, in some embodiments, the usage pattern related to the user’s transaction history may be determined by comparing the user’s monthly credit card statements for the last several years. Such a comparison may determine a usage pattern that the user lives in City A but travels to City B every three months and makes a purchase for a haircut. While in City B, the user also purchases lunch. In another example, the comparison may determine a usage pattern that the user makes a payment to a utility company on the third day of every month.

Method 900 may include a step 904 of generating, by a continuous integration and deployment pipeline, a micro application based on the usage pattern, the continuous integration and development pipeline configured to receive the usage pattern into a coded template, the coded template configured to automate creation and deployment of the micro application. Micro applications, as described herein, may refer to specialized software applications that perform a single, well-defined task and may be contained within a larger application. In some embodiments, the coded template may be predefined, reusable code snippets, or file structures used to accelerate development and ensure consistency. The coded template may involve creation of a template file including static markup, such as HyperText Markup Language, and special markers; such as brackets, braces, or parenthesis; that may act as placeholders for dynamic data to be inserted during rendering. The dynamic data, such as the usage pattern, may then replace the placeholder and the micro application may be generated and deployed. In some embodiments, the micro applications may relate to, for example, connecting to the internet, providing directions, or making a payment. In some embodiments, the micro application may be a payment module, a directions module, or a webpage module.

In some embodiments, the payment module may be configured to, for example, remind a user about an upcoming payment; forecast a payment, upcoming payment, or recurring payment based on the user’s previous spending; forecast an account balance based on predicted upcoming payments; or process a payment. In some embodiments, the continuous integration and deployment pipeline may be configured to modify the micro application to provide a visual aid or list of upcoming recurring payments based on the transaction preference. In other embodiments, the continuous integration and deployment pipeline may use historic spending patterns to modify the payment module. For example, the user may live in an apartment where they pay $2000 per month and may have automatic rent payments set up to pay the rent on the second day of each month. The user may also have an investment account where the user set up to automatic investments, such as to automatically invest $100 every Wednesday into a mutual fund. In one example, the first day of the month may be a Monday. On Sunday, the user may receive a notification that they may view a summary of the week ahead. The payment module may display that $2000 is scheduled to be withdrawn from the user’s account or be charged to the user’s credit card on Tuesday to fulfill the automatic rent payment. The payment module may also display that $100 is scheduled to be withdrawn from the user’s account on Wednesday to fulfill the automatic investment.

In some embodiments, the payment module may display a spending suggestion on the user device to make a payment based on a spending pattern. In embodiments where the usage pattern may be a spending pattern, the continuous integration and deployment pipeline may be configured to modify the micro application to provide a spending suggestion based on the transaction preference. In some embodiments, the continuous integration and deployment pipeline may compare the transaction preference against a database of transaction preferences associated with certain spending behaviors, such as, for example, a user’s interest in spending on user experiences (i.e., buying concert tickets), a user’s interest in music, a user’s interest in sports, a user’s interest in clothing, or a user’s interest in childcare accessories. In embodiments where the transaction preference is compared against a database of transaction preferences associated with user experiences, the continuous integration and deployment pipeline may be configured to determine that the user desires to spend money on certain user experiences and may perform further analysis to determine what those user experiences are. For example, a user may repeatedly spend money on symphony concert tickets, but not on sports tickets. The continuous integration and deployment pipeline may compare this spending pattern to other users’ spending patterns to determine, for example, that the user may likely be interested in early-offer tickets for a visiting big-band jazz show, but may not be likely to be interested in exclusive, backstage-access tickets to Pop Artist P’s upcoming concert. So, the continuous integration and deployment pipeline may configure the micro application to display the early-offer tickets. The continuous integration and deployment pipeline may use machine learning to make these determinations by training a machine learning algorithm to compare historic spending patterns for users to the users’ likelihood of accepting a given purchase offer.

In some embodiments, the directions module may be configured to provide location and route suggestions to a suggested merchant based on a travel pattern. For example, the directions module may display a map or directions to a suggested merchant based on the usage pattern. In some embodiments, the directions module may display an interactive map of a relevant location based on the travel pattern. In some embodiments, the travel pattern, as described herein, may refer to a predicted location or route to take to reach the predicted location based on a user’s location data. For example, the travel pattern may include that the user travels from work to home at 5:30 PM on weekdays. In some embodiments, the webpage module may be configured to display a linked thumbnail on the user device based on a browsing pattern.

A continuous integration and deployment pipeline, as described herein, may automate software delivery by integrating code changes frequently and automatically building, testing, and preparing the code changes for release. Use of a continuous integration and deployment pipeline may help to ensure speed and reliability. The continuous integration and deployment pipeline may follow build, test, and deploy steps, where a software program, such as the micro application, is rapidly built, tested, and deployed. The continuous integration and deployment pipeline may merge code changes into a central repository, and each merge may trigger an automated build and test process. The build and test processes may be configured to catch integration issues with the micro applications. The continuous integration and deployment pipeline may automatically prepare code for release to production after passing tests and may be configured to ensure the code for the micro applications is always in a deployable state. The continuous integration and deployment pipeline may then automatically deploy validated changes micro applications to production. The continuous integration and deployment pipeline may maintain a repository of previous micro applications and may be configured to modify, test, and deploy micro applications.

Method 900 may include a step 905 of receiving an input on the user device. Input, as described herein, may refer to data or content that a user provides to a system to guide its actions or provide necessary information. Input may involve an entry, such as the entry of text, numbers, audio, or commands, and may involve an interaction with a physical device, such as a keyboard, mouse, touchscreen, or stylus. In some embodiments, the input may be, for example, the user logging in to the platform, the user turning on the user device, or the user navigating to a new menu or a particular menu of the platform.

Method 900 may include a step 906 of loading a user interface based on the input. In some embodiments, the user interface may be loaded using an event-driven loop. In the event driven loop, the system may detect an input which may trigger code to be deployed. The code may process the input and display the user interface and may refresh the user interface to display any changes to the user interface. In some embodiments, loading may involve detecting the input, for instance, as described in step 905; determining if the input caused a state change, such as from being logged out to being logged in or from being navigated to Menu A to being navigated to Menu B; and re-rendering the user interface based on the state change. Re-rendering may involve comparing a previous state to a new state and updating the user interface according to the new state. In some embodiments, the user interface may be completely updated, and in other embodiments, only some aspects of the user interface may be updated. For example, in some embodiments, re-rendering may update text displayed on the user interface or the style or color of the user interface. In other embodiments, the permissions of the user may change. In some embodiments, an element may be added to or removed from the user interface. In some embodiments, each element of the user interface may depend on a state such that the element changes or is applied when the state it depends on is changed or applied. In some embodiments, the element depending on a state may enable the user interface to transition between states without requiring reloading or refreshing.

Method 900 may include a step 907 of integrating the micro application within the loaded user interface using an application program interface to facilitate continuous exchange of user interaction data between the platform and the micro application, wherein the integrated micro application functions completely within the user interface. Integrating, as described herein, may be a process of placing one type of data, object, or piece of code within a separate system or container so that it becomes part of the whole. In some embodiments, integration may involve the system generating a link or script for the micro application and placing it in the user interface’s code.

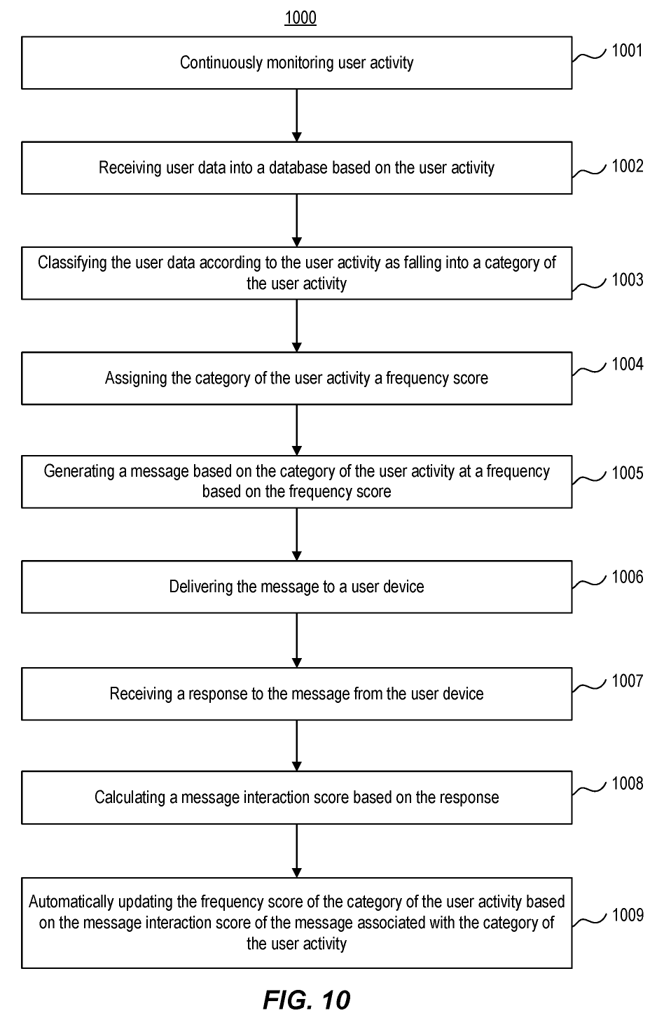

FIG. 10 depicts a flow chart for a method of redemption feedback monitoring. Some embodiments pertain to monitoring which offers, if any, users redeem and using redemption data as feedback to improve future offers. Such embodiments may involve a computer system, for example, at a bank or institution, that monitors which offers, if any, customers redeem and uses redemption data as feedback to improve future offers. Method 1000 may include a step 1001 of continuously monitoring user activity. User activity, as herein described, may refer to any actions or interactions a user takes or decisions a user makes. In some embodiments, user activity may include a user location based on a location of a user device. In some embodiments, user activity may include, for example, making a payment, making a withdrawal, making a deposit, logging into an account, paying a bill, setting up auto pay or other recurring payments, traveling to a new location, interacting with messages sent by an institution, making an appointment with the institution, canceling a credit card, locking a credit card, or any other action taken by a user, including financial-related actions. Method 1000 may include a step 1002 of receiving user data into a database based on the user activity.

Method 1000 may include a step 1003 of classifying the user data according to the user activity as falling into a category of the user activity. Category of user activity, as described herein, may refer to types of user activity, such as, for example, spending categories like food, restaurants, entertainment, groceries, retail, or travel. In some embodiments, classification of the user data may involve, for example, using merchant category codes. Merchant category codes, as described herein, may refer to codes assigned to a business based on the types of goods or services the business provides. The business’s merchant category code may fall into a range of merchant category codes, where the range of merchant category codes spans all businesses providing goods and services that fall into a category of goods and services.

Category, as described herein, may be a label that describes goods or services that share a characteristic. Category may, for example, include contracted services, utility services, transportation, groceries, restaurants, fuel, public transit, rideshare services, retail, dining, shopping and leisure, vehicle maintenance, entertainment, and lodging. In some embodiments, the category may be a sub-category of goods and services such that a range of merchant category codes may correspond to a sub-category, and several ranges of merchant category codes may fall into a single category.

For example, one range of merchant category codes may be exemplary merchant category codes 4001–4005, where each business assigned one of 4001–4005 may sell fuel. Gas Company A may be assigned 4001, Gas Company B may be assigned 4002, Gas Company C may be assigned 4003, Gas Company D may be assigned 4004, and Gas Company E may be assigned 4005. Thus, merchant category codes 4001–4005 may fall into the category of fuel.

In another example, merchant category codes 4001–4005 may correspond to the sub-category of fuel, merchant category codes 4041–4055 may correspond to the sub-category of vehicle maintenance, merchant category codes 4056–4065 may correspond to the sub-category of rideshare services, and merchant category codes 4081–4090 may correspond to the sub-category of public transit. Together, the sub-categories of fuel (4001–4005), vehicle maintenance (4041–4055), rideshare services (4056–4065), and public transit (4081–4090) may fall into the category of transportation. A purchase made by the user at Gas Company A’s gas station may be recognized as having merchant category code 4001, which is in the range of merchant category codes corresponding to the sub-category of fuel, which falls into the category of transportation. Thus, the user data corresponding to the user’s purchase at Gas Company A’s gas station may be classified as fuel or transportation.

In some embodiments, the codes, including merchant category codes, may include letters. In some embodiments, user activity and user data not involving purchased, such as account actions like withdrawals and deposits of varying amounts, may also be assigned codes. For example, deposits of $0–$100 may be assigned exemplary code D100, deposits of $101–$1000 may be assigned exemplary code D1000, and deposits of greater than $1001 may be assigned exemplary code D1001. Similarly, withdrawals of $0–$100 may be assigned exemplary code W100, withdrawals of $101–$1000 may be assigned exemplary code W1000, and withdrawals of greater than $1001 may be assigned exemplary code W1001. If the user makes a withdrawal of $150, the user data surrounding the user’s withdrawal may be classified as a withdrawal.

Method 1000 may include a step 1004 of assigning the category of the user activity a frequency score. Frequency score, as described herein, may refer to a value or assessment of how often a user takes certain actions, makes certain decisions, or interacts with messages that fall into a category. In some embodiments, when a user frequently makes certain decisions or takes certain actions or interacts with content that falls into a certain category, the frequency score may be high. In some embodiments, when a user infrequently makes certain decisions, infrequently takes certain actions, or interacts with content that falls into a certain category only sparingly, the frequency score may be low. In some embodiments, the frequency score may be an integer ranging from zero to one hundred, where a frequency score greater than or equal to fifty is considered high and a frequency score of less than fifty is considered low. In some embodiments, the category of user activity may be assigned an arbitrary initial frequency score, such as, for example, one hundred.

Method 1000 may include a step 1005 of generating a message based on the category of the user activity at a frequency based on the frequency score. In some embodiments, messages may include a coupon, a discount code, or an advertisement. In some embodiments, the message may be related to one category of user activity. In some embodiments, the message may be related to two or more categories of user activity. In some embodiments, messages related to a category of user activity having a high frequency score will be generated more often than messages related to a category of user activity having a low frequency score. Method 1000 may include a step 1006 of delivering the message to a user device.

Method 1000 may include a step 1007 of receiving a response to the message from the user device. In some embodiments, response may refer to a user engagement with the message by, for example, clicking on, tapping on, or swiping the message. In some embodiments, the response may include a length of response or a frequency of response, where a length of response may refer to how long a user engaged with a message and a frequency of response may refer to how many times the user engaged with the message. The response with the message may be received, for example, by use of tracking pixels. In some embodiments, the message may be an email. Tracking pixels may be embedded in an email. An institution may insert a pixel image tag into the hypertext markup language (HTML) code of the email. Pixel image tag, as described herein, may be a 1x1 pixel, transparent graphic embedded in the email or website to track user interaction. The user may open the email, which may cause the email client to fetch the image from a server. The server hosting the image may log the request and record the time, internet protocol (IP) address, and device information. The server may also document how long the email was opened for, how many times the email was reopened, and whether any links within the email were clicked by the user. The institution may then access and record the documented data. In other embodiments, other receiving methods may be used to receive the response to the message.

Method 1000 may include a step 1008 of calculating a message interaction score based on the user interaction. Message interaction score, as described herein, may refer to a value or assessment of how much a user interacts with a message. In some embodiments, the message interaction score may be an integer ranging from zero to one hundred, where a message interaction score greater than or equal to fifty is considered high and a message interaction score of less than fifty is considered low. In some embodiments, the user interaction score may be associated with the category of user activity. In some embodiments, the message may include a coupon. In some embodiments, message interaction score may be based on whether the user opened the coupon, a time between receiving and opening the coupon, and whether the user redeemed the coupon. In some embodiments, there may be several message interaction scores, and the message interaction score may be associated with the category of user activity. The message interaction score for each category of user activity may be calculated based on a percentage of messages related to the category of user activity the user interacts with. For example, if the user received ten messages related to a category of user activity of retail and the user interacted with seven of the messages, the user interaction score may be calculated to be seventy. While in some embodiments, the message interaction score may be calculated for a category of user activity based on user interaction with several messages, in other embodiments, the message interaction score may be calculated for individual messages.

Method 1000 may include a step 1009 of automatically updating the frequency score of the category of the user activity based on the message interaction score of the message associated with the category of the user activity. In some embodiments, the frequency score may be automatically updated periodically, such as once per month. In some embodiments, the frequency score may increase upon determining the message interaction score exceeds a first score threshold. In some embodiments, the frequency score may decrease upon determining the message interaction score does not exceed a second score threshold. The first score threshold and the second score threshold, as described herein, may refer to predetermined scores, which, when reached or not reached, trigger a change in the frequency score.

In some embodiments, the first score threshold and second score threshold may be set above and below an expected message interaction score, respectively, wherein the expected message interaction score may be determined from historical interaction data. For example, for messages related to contract services, historical interaction data may indicate that, on average, users interact with four out of every ten messages related to utility services. Thus, the expected message interaction score may be forty, the first threshold score may be set to fifty, and second threshold score may be set to thirty.

In some embodiments, upon determining that the frequency score for the category of user activity decreased below a minimum frequency score, messages based on the category of user activity may cease to be generated.

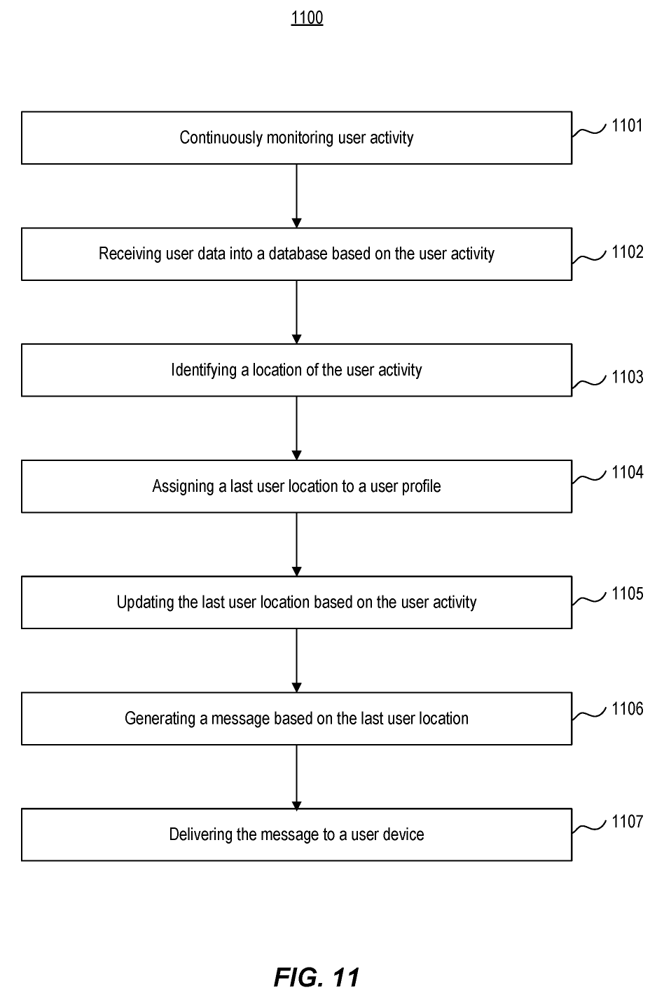

FIG. 11 depicts a flow chart for a method of providing location-based content. Some embodiments pertain to using location data, such as data related to user travel, residence, or current location, to personalize offers. Such embodiments may involve a computer system, for example, at a bank or institution, that uses location data, such as data related to user travel, residence, or current location, to personalize offers.

Method 1100 may include a step 1101 of continuously monitoring user activity. In some embodiments, user activity may include a user location, a profile update, an appointment at an institution, a withdrawal, or a purchase. In some embodiments, the purchase may be classified as a recurring purchase or a one-time purchase. Method 1100 may include a step 1102 of receiving user data into a database based on the user activity.

Method 1100 may include a step 1103 of identifying a location of the user activity. The location of user activity, as described herein, may refer to the location of the user at the time of the user activity, as indicated by the location of the user’s mobile device, or the location of a subject of the user activity at the time of the user activity. For example, a user may book a hotel for a future trip. In some embodiments, the location of the user activity may be the location of the user at the time the user booked the hotel, and in other embodiments the location of the user activity may be the location of the hotel. In some embodiments the location of the user activity may be determined from transaction data. Transaction data, as described herein, may include time- and location-stamped records of funds moving into or out of a user account. In some embodiments, the transaction data may include deposits and withdrawals by the user, and in some embodiments, the transaction data may include expenses, such as on a credit card statement. The transaction data may include an identification number, timestamp, amount, and status, such as successful or failed. The transaction data may also include contextual information including merchant name, merchant type, or location.

Method 1100 may include a step 1104 of assigning a last user location to a user profile. Last user location, as described herein, may refer to a last recorded location of a user indicated by the user’s activity. Method 1100 may include a step 1105 of updating the last user location based on the user activity. Method 1100 may include a step 1106 of generating a message based on the last user location. In some embodiments, the message may include an advertisement, coupon, or promotion. In some embodiments, the message may be unique to the user. In some embodiments, the message may be informational. For example, in some embodiments, the system may generate a message that includes a reminder to withdraw money today based on the user’s activity pattern of withdrawing money from an automatic teller machine (ATM) near the last user location on Fridays.

Method 1100 may include a step 1107 of delivering the message to a user device. In some embodiments, the message may be delivered via text message, email, or push notification. In some embodiments, the message may be delivered via email when the message exceeds a predetermined length. In some embodiments, the predetermined length may be a word count or be based on the presence of images or graphics in the message. In other embodiments, the predetermined length may be based on an amount of text that may be seen on a screen of a mobile device without scrolling. In some embodiments, the message type may be dictated by a selected or indicated user preference. For example, a user who routinely reads and responds to emails may be sent an email message, while a user who routinely ignores emails may not be sent an email message. In some embodiments, the institution may collect user data associated with a user’s messaging preferences, which may be used to personalize message delivery, such as message delivery at step 1107.

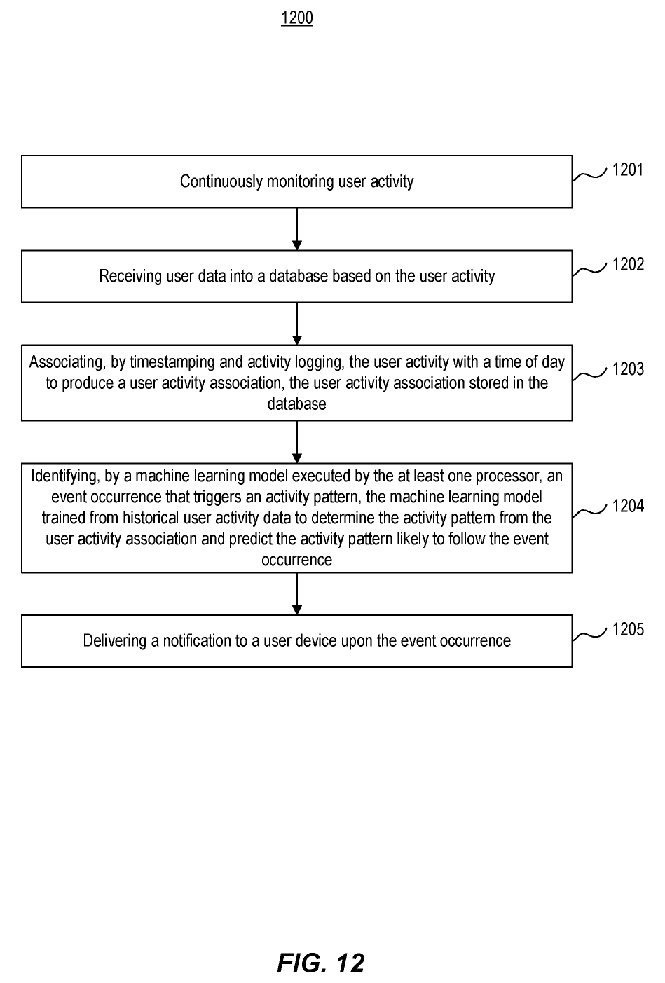

FIG. 12 depicts a flow chart for a method of providing predictive notifications. Some embodiments pertain to using location data, such as data related to user travel, residence, or current location, to push navigation suggestions to users’ mobile devices. Such embodiments may involve a computer system, for example, at a bank or institution, that uses location data, such as data related to user travel, residence, or current location, to push navigation suggestions to users’ mobile devices. Method 1200 may include a step 1201 of continuously monitoring user activity. In some embodiments, the user activity may include a location of the user device resulting from an event occurrence. Method 1200 may include a step 1202 of receiving user data into a database based on the user activity.

Method 1200 may include a step 1203 of associating, by timestamping and activity logging, the user activity with a time of day to produce a user activity association, the user activity association stored in the database. Associating, as described herein, may refer to correlating the user activity with a time or a place. User activity association, as described herein, may be the user activity, the time the user activity occurred, and where the user was when they engaged in the user activity. Activity logging, as described herein, may refer to creating a record of user activity such that a log of historical user activity data may be maintained. User activity, as described herein, may refer to actions or interactions a user takes or decisions a user makes. User activity may include, for example, making a payment, making a withdrawal, making a deposit, logging into an account, paying a bill, setting up auto pay or other recurring payments, traveling to a new location, interacting with messages sent by an institution, making an appointment with the institution, canceling a credit card, locking a credit card, or any other action taken by a user, including financial-related actions. In some embodiments, each entry in the log of user activity may be time-stamped. In other embodiments, each entry in the log of user activity may be location-stamped.

Method 1200 may include a step 1204 of identifying, by a machine learning model executed by the at least one processor, an event occurrence that triggers an activity pattern. The machine learning model may be trained from historical user activity data to determine the activity pattern from the user activity association and predict the activity pattern likely to follow the event occurrence. Event occurrence, as described herein, may refer to an event taking place. In some embodiments, an event occurrence may be, for example, a first time of day or a second time of day. In such embodiments, the occurrence of the first time of day or the second time of day may trigger user engagement in user activity at the first time of day or the second time of day. In some embodiments, the event occurrence may be, for example, a day of the week or a day of the month. In such embodiments, the occurrence of the day of the week or the day of the month may trigger user engagement in user activity during the day of the week or the day of the month. In some embodiments, the event occurrence may be, for example, the user activity happening at a specific location. In such embodiments, the occurrence of the user activity happening at a specific location may trigger subsequent user activity at a second location. In some embodiments, the event occurrence may be, for example, the user arriving at a specific location, reaching a savings goal, a withdrawal exceeding a threshold amount, a deposit exceeding a threshold amount, an amount of time passing since a transaction. In some embodiments, the event occurrence may be, for example, a pay day. In such embodiments, the occurrence of the pay day may trigger the user engaging in user activity related to an increase in spending.

Activity patterns, as described herein, may refer to a pattern within user activity. In some embodiments, the activity pattern may include, for example, purchasing a good or service at a time of day, on a day of the week, or in a location; a length of time between a first purchase of a good or service and a second purchase of the same good or service; paying a bill at a certain time each month; making a deposit or withdrawal exceeding a threshold amount; or interacting with an account at an interval of time. In some embodiments, the activity pattern may include a location of the user device resulting from the event occurrence. In some embodiments, the activity pattern and the event occurrence may have an if-then relationship where if the event occurrence has occurred, then the activity pattern may exist. One example may be, if the user arrives in City C before 10:00 AM, then the user may go to Restaurant R for lunch.

In some embodiments, the machine learning model may be used to predict the activity pattern likely to follow the event occurrence. The machine learning model may be trained in a variety of ways. For example, the machine learning model may be trained from a series of user activity associations from the historical user activity data. In some embodiments, the machine learning model may be shown that the user travels from City A, where the user resides, to City B on the first Saturday of every month, and the user always buys lunch at Restaurant R while in City B. The machine learning model may be trained that the first Saturday of the month is the event that triggers the activity pattern of traveling to City B and buying lunch at Restaurant R. The machine learning model may also be shown that, sometimes, the user buys gas in City C on the way back from City B, and every time the user stops for gas in City C they purchase ice cream from Ice Cream Shop S, which is also in City C. The machine learning model may be trained that purchasing gas in City C is the event that triggers purchasing ice cream from Ice Cream Shop S.

In another example, the machine learning model may also be shown that the user is paid on the fifteenth day of every month and on the last day of every month, and the user transfers $300 to their investment account on the first and sixteenth day of every month. The machine learning model may be trained that the user receiving a large deposit into their account, such as on pay day, is the event that triggers the user making a transfer of funds to their investment account.

The machine learning model may learn from the examples and may further be trained by being shown event occurrences and predicting the activity pattern likely to follow the event occurrence. For each event, the machine learning model may make a prediction, which may then be confirmed or corrected until the machine learning model is able to accurately predict the activity pattern likely to follow the event occurrence a threshold amount of the time. For example, the machine leaning model may be shown the event occurrence of the user purchasing gas in City A on the first Saturday of the month, and the machine learning model may predict that the user will travel to City B, buy lunch at Restaurant R, and buy ice cream at Ice Cream Shop S. The machine learning model may be informed that its prediction was only partially correct and be informed that the correct prediction is that the user will travel to City B and buy lunch at Restaurant R, but the user will not buy ice cream at Ice Cream Shop S because the user did not buy gas in City C.

Method 1200 may include a step 1205 of delivering a notification to a user device upon the event occurrence. Notification, as described herein, may refer to a type of message that may be an automated message that alerts a user, such as alerting the user to an event, update, or reminder. In some embodiments, the notification may be a push notification, lock screen notification, in-application notification, banner notification, icon notification, text message, email, phone call, or some other message service notification. In some embodiments, the notification may anticipate the activity pattern based on the event occurrence.

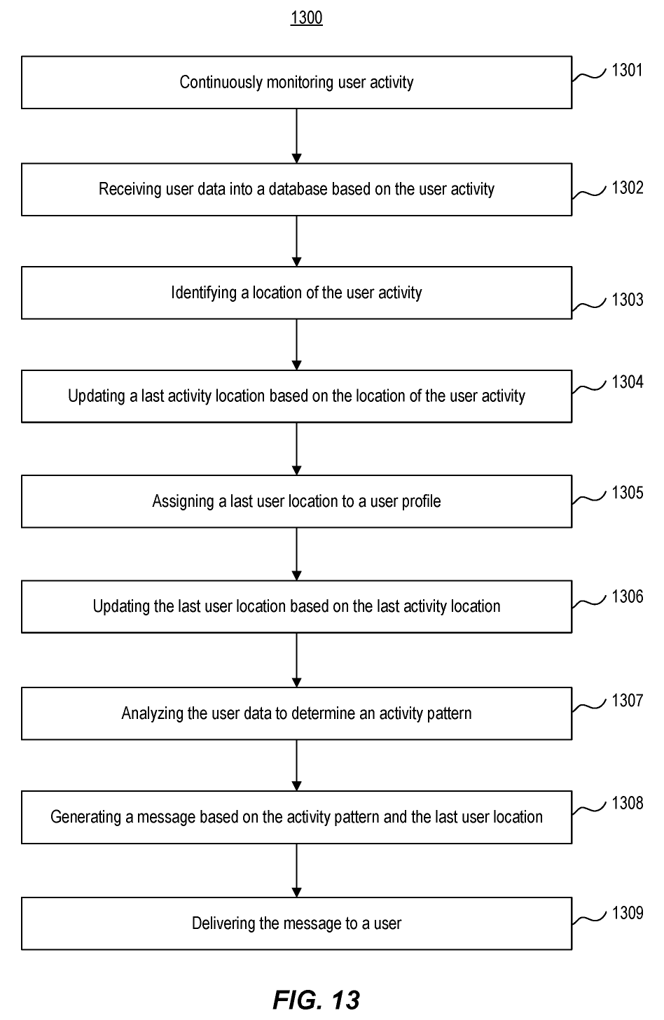

FIG. 13 depicts a flow chart for a method of providing personalized offers. Some embodiments pertain to using location data and user activity to personalize offers and/or discounts. Such embodiments may involve a computer system, for example, at a bank or institution, that uses location data and user activity to personalize offers and/or discounts. Method 1300 may include a step 1301 of continuously monitoring user activity. In some embodiments, the user activity may include a user location. Method 1300 may include a step 1302 of receiving user data into a database based on the user activity.

Method 1300 may include a step 1303 of identifying a location of the user activity. The location of the user activity, as described herein, may refer to the location of the user at the time of the user activity, as indicated by the location of the user’s mobile device, or the location of a subject of the user activity at the time of the user activity. For example, a user may book a hotel for a future trip. In some embodiments, the location of the user activity may be the location of the user at the time the user booked the hotel, and in other embodiments the location of the user activity may be the location of the hotel. In some embodiments the location of the user activity may be determined from transaction data. Transaction data, as described herein, may include time- and location-stamped records of funds moving into or out of a user account. In some embodiments, the transaction data may include deposits and withdrawals by the user, and in some embodiments, the transaction data may include expenses, such as on a credit card statement. The transaction data may include an identification number, timestamp, amount, and status, such as successful or failed. The transaction data may also include contextual information including merchant name, merchant type, or location.

Method 1300 may include a step 1304 of updating a last activity location based on the location of the user activity. Last activity location, as described herein, may refer to a last recorded location where user activity is detected. Method 1300 may include a step 1305 of assigning a last user location to a user profile. Last user location, as described herein, may refer to a last recorded location of a user indicated by the user’s activity or user data. Method 1300 may include a step 1306 of updating the last user location based on the last activity location.

Method 1300 may include a step 1307 of analyzing the user data to determine an activity pattern. In some embodiments, the activity pattern may include, for example, making timely payments; making late payments; interacting with an account; purchasing a good or service at a time of day, on a day of the week, or in a location; a length of time between a first purchase of a good or service and a second purchase of the same good or service; checking an account balance; or making a withdrawal. In some embodiments, time series analysis may be used to analyze the user data to determine the activity pattern.

Time series analysis, as described herein, may involve evaluating data points collected at consistent, sequential time intervals to identify a trend, cycle, or seasonal pattern. Trend, as described herein, may refer to a direction of data upwards or downwards. Cycle, as described herein, may refer to an unpredictable, long-term fluctuation in the data. Seasonal pattern, as described herein, may refer to a predictable, repeating pattern over a specific interval, such as weekly, monthly, or annually. Time series analysis may allow for forecasting values based on historical data. Forecasting, as described herein, may refer to using historical activity patterns to predict a future activity pattern.

In some embodiments, the time series analysis may evaluate various types of user data against time. In some embodiments, the time series analysis may evaluate an account balance against time. In another embodiment, the time series analysis may evaluate a total number of transactions against time. In another embodiment, the time series analysis may evaluate a number of transactions falling into a category of user activity against time. Category of user activity, as described herein, may refer to types of user activity, such as, for example, spending categories like food, restaurants, entertainment, groceries, retail, or travel.

In one example, the user’s account balance may be analyzed with respect to time to determine an activity pattern. In analyzing the user’s account balance over time, it may be determined that the account balance is trending upwards, has a seasonal pattern of two large deposits each month on the days the user is paid by their employer, and cycles between the large deposits. The analysis may reveal activity patterns, such as the user’s deposit schedule, the user’s monthly recurring payments, or other patterns of spending or saving.

Method 1300 may include a step 1308 of generating a message based on the activity pattern and the last user location. In some embodiments, the message may include an advertisement, coupon, or promotion. In some embodiments, the message may be unique to the user. In some embodiments, the message may be informational. For example, in some embodiments, the system may generate a message that includes a reminder to withdraw money today based on the user’s activity pattern of withdrawing money from an ATM near the last user location on Fridays. Method 1300 may include a step 1309 of delivering the message to a user. In some embodiments, the message may be delivered via text message, email, or push notification.

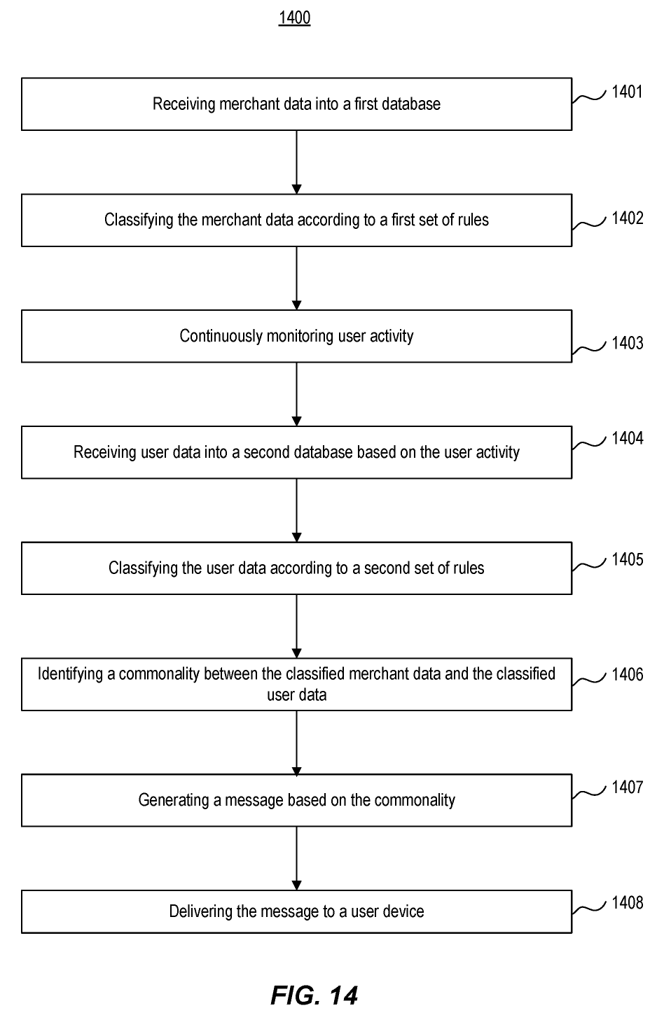

FIG. 14 depicts a flow chart for a method of promoting a network. Some embodiments pertain to promoting and offering discounts on, or recommendations for, in-network businesses. An in-network business may be one that is associated with a certain organization or entity or that has certain characteristics that pertain to it being within a certain network. Such embodiments that pertain to promoting and offering discounts may involve a computer system, for example, at a bank or institution, that promotes and offers discounts on, or recommendations for, in-network businesses. Method 1400 may include a step 1401 of receiving merchant data into a first database. Merchant data may include name, address, operations, list of products for sale, list of services offered, or date of sales. Method 1400 may include a step 1402 of classifying the merchant data according to a first set of rules. A set of rules, as described herein, may refer to standards that govern a process. In some embodiments, the first set of rules may be based on, for example, the list of products, the list of services, a sale, or a price range of products.

Method 1400 may include a step 1403 of continuously monitoring user activity. In some embodiments, the user activity may include a user location. Method 1400 may include a step 1404 of receiving user data into a second database based on the user activity.

Method 1400 may include a step 1405 of classifying the user data according to a second set of rules. In some embodiments, the second set of rules may be based on, for example, a purchase history, an account balance, a savings goal, a proximity to a pay day, a budget, or a card lock. In some embodiments, the second set of rules may be the same as the first set of rules.

Method 1400 may include a step 1406 of identifying a commonality between the classified merchant data and the classified user data. In some embodiments, the commonality may be identified based on matching a merchant classification of the merchant data to a user classification of the user data. For example, in some embodiments, the classified merchant data may include information about the merchant’s products listed for less than $50, and the classified user data may include information that the user deposited $550 into an account this week, the user has a savings goal of $500 per week, the user has made purchases from the merchant in the past, and it is the last day of the week. There, a commonality may exist, since the user has a budget of $50, has a history of making purchases from the merchant, and the merchant has products for sale for less that the user’s budget. In some embodiments, the commonality may be updated continuously based on the user data and merchant data.

Method 1400 may include a step 1407 of generating a message based on the commonality. In some embodiments, the message may include an advertisement, coupon, or promotion. In some embodiments, the message may be unique to the user. In some embodiments, the message may be informational. In some embodiments, the message may include information about the user’s proximity to a merchant, a user’s purchase history with the merchant, a status of the user’s savings goal, a featured product sold by the merchant, and a coupon valid for the day the message is sent to the user device. Method 1400 may include a step 1408 of delivering the message to a user device. In some embodiments, the message may be delivered via text message, email, or push notification.

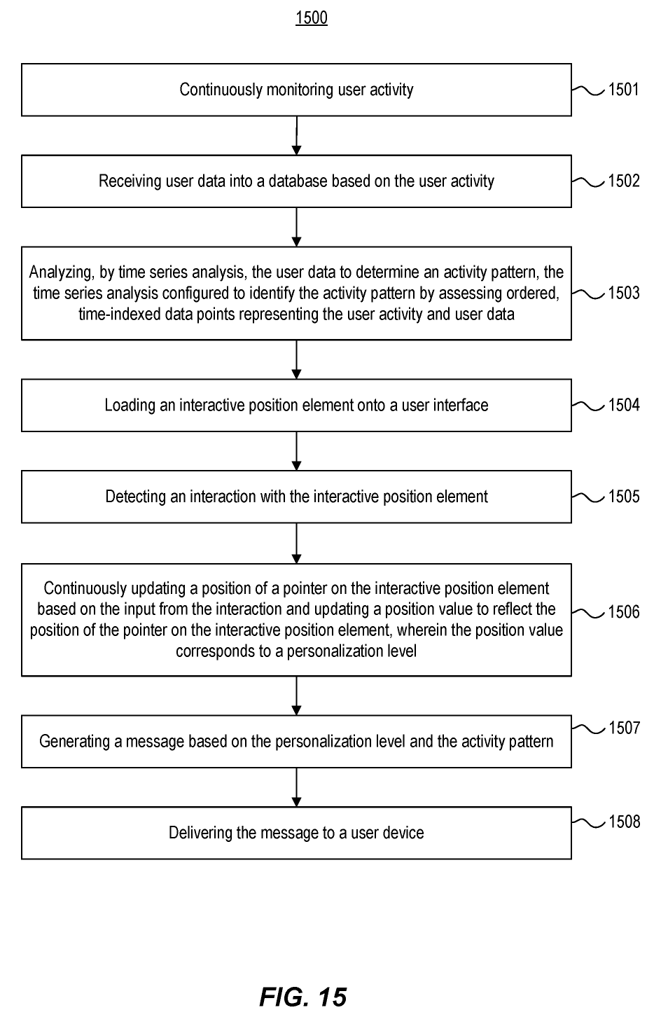

FIG. 15 depicts a flow chart for a method of user-selectable personalization. Some embodiments pertain to an adjustable personalization slider to allow users to opt fully into receiving personalized content, fully opt out of receiving personalized content, or somewhere in the middle, where a user may choose to receive some personalized content and opt out of other content. Such embodiments may involve a computer system, for example, at a bank or institution, having an adjustable personalization slider to allow users to opt fully into receiving personalized content, fully opt out of receiving personalized content, or somewhere in the middle, where a user may choose to receive some personalized content and opt out of other content. Method 1500 may include a step 1501 of continuously monitoring user activity. In some embodiments, the user activity may include a user location. Method 1500 may include a step 1502 of receiving user data into a database based on the user activity.

Method 1500 may include a step 1503 of analyzing, by time series analysis, the user data to determine an activity pattern, the time series analysis configured to identify the activity pattern by assessing ordered, time-indexed data points representing the user activity and user data. Time series analysis, as described herein, may involve evaluating data points collected at consistent, sequential time intervals to identify a trend, cycle, or seasonal pattern. Trend, as described herein, may refer to a direction of data upwards or downwards. Cycle, as described herein, may refer to an unpredictable, long-term fluctuation in the data. Seasonal pattern, as described herein, may refer to a predictable, repeating pattern over a specific interval, such as weekly, monthly, or annually. Time series analysis may allow for forecasting values based on historical data. Forecasting, as described herein, may refer to using historical activity patterns to predict a future activity pattern. In some embodiments, the activity pattern may be a location pattern. The location pattern may highlight a movement preference of a user and may involve a log of previous locations for a period of time.

In some embodiments, the time series analysis may evaluate various types of user data against time. In some embodiments, the time series analysis may evaluate an account balance against time. In another embodiment, the time series analysis may evaluate a total number of transactions against time. In another embodiment, the time series analysis may evaluate a number of transactions falling into a category of user activity against time. Category of user activity may include, for example, spending categories like food, restaurants, entertainment, groceries, retail, or travel.

In one example, the user’s account balance may be analyzed with respect to time to determine an activity pattern. In analyzing the user’s account balance over time, it may be determined that the account balance is trending upwards, has a seasonal pattern of two large deposits each month on the days the user is paid by their employer, and cycles between the large deposits. The analysis may reveal activity patterns, such as the user’s deposit schedule, the user’s monthly recurring payments, or other patterns of spending or saving.

Method 1500 may include a step 1504 of loading an interactive position element onto a user interface. In some embodiments, the interactive position element may be loaded onto a user interface using active or passive loading. In some embodiments, passive loading may be used to load content upfront, when an application or the user interface first starts, so the content is ready for immediate access. In other embodiments, active loading may be used to load content, such as the interactive position element, on demand upon the user requesting the content. In some embodiments, content, such as the interactive position element, may be loaded through a fetch process. In some embodiments, the fetch process may involve the user interface receiving a request for content from the user, the user interface sending a request to a server and asking for the files containing the requested content, the server sending the requested files in a data packet back to the user interface, the user interface parsing the files, the user interface building a structure of the requested content and using rendering tools to display the requested content, and the system executing code to modify the requested content or add functionality, making the requested content interactive.

Interactive position element, as described herein, may refer to an interactive portion of a display of a user interface where a user may be able to, for example, change a setting. In some embodiments, the user may be able to interact with the interactive position element. In some embodiments, the interaction may occur by the user providing an input, such as by clicking and dragging along a slide bar, tapping, or speaking, or by numerical entry. In some embodiments, the user may enter an input by, for example, using swipe gestures, pinch and spread gestures, or drag and drop interactions. In some embodiments, the user interface may consider time and pressure of a user’s tap or press when processing the input. In some embodiments, the interactive position element may be a personalization slider. In some embodiments, the interactive position element may be a personalization dial or a personalization scroll wheel. In some embodiments, the interactive position element may involve a drop down list, a stepwise incremental and decremental control, or a toggle switch. Personalization slider, as described herein, may refer to a tool that may allow a user to adjust a personalization level of future content such as messages.

Method 1500 may include a step 1505 of detecting an interaction with the interactive position element. In some embodiments, the interaction may be detected upon receiving the input by the user. Method 1500 may include a step 1506 of continuously updating a position of a pointer on the interactive position element based on the input from the interaction and updating a position value to reflect the position of the pointer on the interactive position element, wherein the position value corresponds to a personalization level. The pointer, as described herein, may refer to an indicator along the interactive position element. The pointer may be any number of shapes or sizes, and the pointer may be bound by an edge of the interactive position element.

Position value, as described herein, may refer to a value or assessment of a location of the pointer on or within the interactive position element. In some embodiments, the position value may range from zero to one hundred, where a position value of zero may result in the least personalization and a position value of one hundred may result in the most personalization. Specific to personalized content, the personalized content system may generate personalized content that is the least personalized, or most generic, when the position value is zero and may generate personalized content that is the most personalized when the position value is one hundred.

Method 1500 may include a step 1507 of generating a message based on the position value and the activity pattern. In some embodiments, a personalization level of the message may be high when the position value is high. In some embodiments, the position value may be considered to be high when, for example, the position value ranges from zero to one hundred and the position value is greater than or equal to fifty. In some embodiments, a personalization level of the message may be low when the position value is low. In some embodiments, the position value may be considered to be low when, for example, the position value ranges from zero to one hundred and the position value is less than fifty. For example, the personalized content system may detect an interaction with the interactive position element such that the position value is zero. The personalized content system may then generate a message that is generic, non-targeted, industry-wide content. In another example, the personalized content system may detect an interaction with the interactive position element such that the position value is ten. The personalized content system may then generate a message that is more personalized than the message generated for a position value of zero, but still not overly personalized. The message generated for a position value of ten may, for example, include the user recipient’s name rather than “valued customer.”

As a further example, the personalized content system may detect an interaction with the interactive position element such that the position value is fifty. The personalized content system may then generate a message that is much more personalized than the message generated for a position value of ten, focusing on specific user activities but not overly intrusive. The message generated for a position value of fifty may, for example, include the user recipient’s name and include information about a product the user may be interested in based on the user having made a transaction in the same product category.

In another example, the personalized content system may detect an interaction with the interactive position element such that the position value is eighty. The personalized content system may then generate a message that is more personalized than the message generated for a position value of fifty, focusing on specific user activities, locations, interaction history, or transaction history. The message generated for a position value of eighty may, for example, include the user recipient’s name, may recommend a specific product the user previously looked at, and may include information that the product is in stock at a location in a city the user frequently visits.

Method 1500 may include a step 1508 of delivering the message to a user device. In some embodiments, the message may be delivered, for example, via push notification or email. In some embodiments, the message may be delivered via email when the message exceeds a predetermined length. In some embodiments, the predetermined length may be a word count or be based on the presence of images or graphics in the message. In other embodiments, the predetermined length may be based on an amount of text that may be seen on a screen of a mobile device without scrolling. In other embodiments, the message may be delivered via push notification when the message includes time-sensitive content. In some embodiments, time-sensitive content may include limited-time offers, warnings, or recommendations for a current location or time of day. In some embodiments, the message type may be dictated by a selected or indicated user preference. For example, a user who routinely reads and responds to emails may be sent an email message, while a user who routinely ignores emails may not be sent an email message. In some embodiments, the institution may collect user data associated with a user’s messaging preferences, which may be used to personalize message delivery, such as message delivery at step 1508.

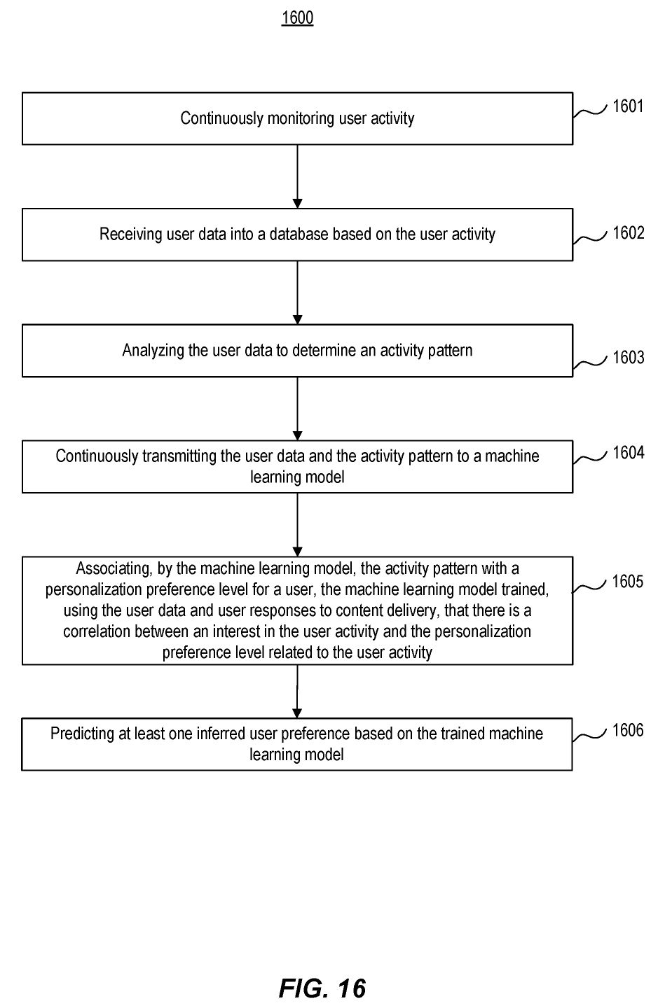

FIG. 16 depicts a flow chart for a method of mapping user data to personalization preferences. Some embodiments pertain to a machine learning model that maps user data to user personalization preferences. Such embodiments may involve a computer system, for example, at a bank or institution, that uses a machine learning model to map user data to user personalization preferences.

Method 1600 may include a step 1601 of continuously monitoring user activity. In some embodiments, the user activity may include a user location based on a location of a user device. Method 1600 may include a step 1602 of receiving user data into a database based on the user activity. Method 1600 may include a step 1603 of analyzing the user data to determine an activity pattern. Activity pattern, as described herein, may refer to a trend in the user data appearing over time, such as recurring transactions; transactions falling into a category, such as dining, clothing, recreation, or travel, or falling a subcategory of the category; transactions occurring at a specific day or time in a time period, such as the beginning of a month, end of the month, the third day of the month, a morning, an evening, or a Saturday; transactions occurring in a location; regular user interaction with an account; user interaction with a message containing content related to a category; or consistency or consistent change in account balance. In some embodiments, analysis of the user data may occur by comparing user data, including account information, transaction history, location history, search history, interaction data, and account balance, over multiple periods of time, such as, for example, weeks, months, or years. For analysis, the user data may be gathered in a uniform format and examined for consistency or change over time. For example, in some embodiments, the activity pattern relating to account balance may be determined by comparing the user’s account balance, for example, month-over-month to identify patterns in savings. Such a comparison may determine an activity pattern that the user’s account grows, on average, 5% each month. In some embodiments, the activity pattern may be a location pattern. The location pattern may highlight a movement preference of a user and may involve a log of previous locations for a period of time. In another embodiment, the activity pattern may be a spending pattern, the spending pattern highlighting a transaction preference of the user and may include a log of attempted payments.

Method 1600 may include a step 1604 of continuously transmitting the user data and the activity pattern to a machine learning model. In some embodiments, the user data and the activity pattern may be continuously transmitted through an application programming interface that may link the machine learning model to an institutions servers storing the user data and the activity pattern. Through the application programming interface, the machine learning model may be able to communicate and share data with the server, allowing continuous access to the user data and the activity pattern. In some embodiments, the database may track the quantity of user data transmitted to the machine learning model.

Method 1600 may include a step 1605 of associating, by the machine learning model, the activity pattern with a personalization preference level for a user. The machine learning model may be trained using the user data and user responses to content delivery, that there is a correlation between an interest in user activity and personalization preference level related to the user activity. In some embodiments, the personalization preference level may be one of low, medium, or high. In some embodiments, the personalization preference level may be a positive integer ranging from zero to one hundred. In some embodiments, a first personalization preference level associated with a first activity pattern may differ from a second personalization preference level associated with a second activity pattern. In some embodiments, the machine learning model may be trained from historical user data and interaction data to associate the user activity pattern with the personalization preference level of the user. The machine learning model may be trained that there is a direct correlation between the user’s interest in something and the user’s interaction with content related to that thing. And in some embodiments, the machine learning model may learn that user’s with similar interest levels in something may have similar preferences for personalization regarding that thing. In some embodiment, the machine learning model may be retrained when the quantity of user data transmitted exceeds a threshold quantity. In some embodiments, the tracked quantity of user data transmitted reverts to zero after the machine learning model is retrained.

The machine learning model may be shown exemplary user data or interaction data and corresponding personalization preference levels. Such examples may include that the user has an activity pattern of purchasing tickets to baseball games, and the user opens and interacts with highly personalized content related to baseball. More specifically, in some embodiments, the machine learning model may learn that every year during the baseball season, the user purchases a pair of tickets to at least three home games per month. The user may, based on this pattern, receive personalized content related to baseball. The personalized content may be personalized to the user’s identity, the user’s location, and/or the user’s ticket purchase history. For example, some personalized content the user receives may greet the user by name, promote the user’s local team and list the upcoming games, and it may include a count of how many games the user has attended so far this season. The user may open and interact with all personalized content they receive related to Baseball Team T’s tickets. The machine learning model may learn that users who purchase several tickets to a type of event every year may have a personalization preference level that includes receiving personalized content that includes their name, details on upcoming events, and a record of how many events the user has attended.

The machine learning model may learn from the examples and may further be trained by receiving user data and interaction data and determining a corresponding personalization preference level. For each set of data, the machine learning model may determine a corresponding personalization preference level, which may then be confirmed or corrected until the machine learning model is able to make accurate determinations a threshold amount of the time. For example, the machine learning model may receive user data including that the user purchases a pair of ticket to one symphony event per year. The machine learning model may associate the activity pattern of attending the symphony once per year with a personalization preference level that involves sending personalized content after the attended event that includes the users name, the name of the symphony event the user attended in the current and previous year, a listing of symphony events scheduled for the next week, and a questionnaire about the attended event. The machine learning model may be corrected that the appropriate personalization preference level may involve personalized content sent at the start of the year with the user’s name and a link to the symphony’s calendar of events or personalized content sent after the attended event including a message of gratitude for supporting the symphony and expressing hope that the user enjoyed the specific event. During operation, the machine learning model may be configured to accept specific inputs.

Method 1600 may include step 1606 of predicting at least one inferred user preference based on the trained machine learning model. For example, for the user in the above example that likes baseball, the machine learning model may learn that other users, such as User U, who have a similar interest in baseball have a Personalization Preference Level L and also interact with personalized content related to merchandise sold by their local baseball team. Thus, it may be predicted that the user here may have an inferred user preference of receiving personalized content at Personalization Preference Level L and of receiving personalized content related to their teams merchandise.

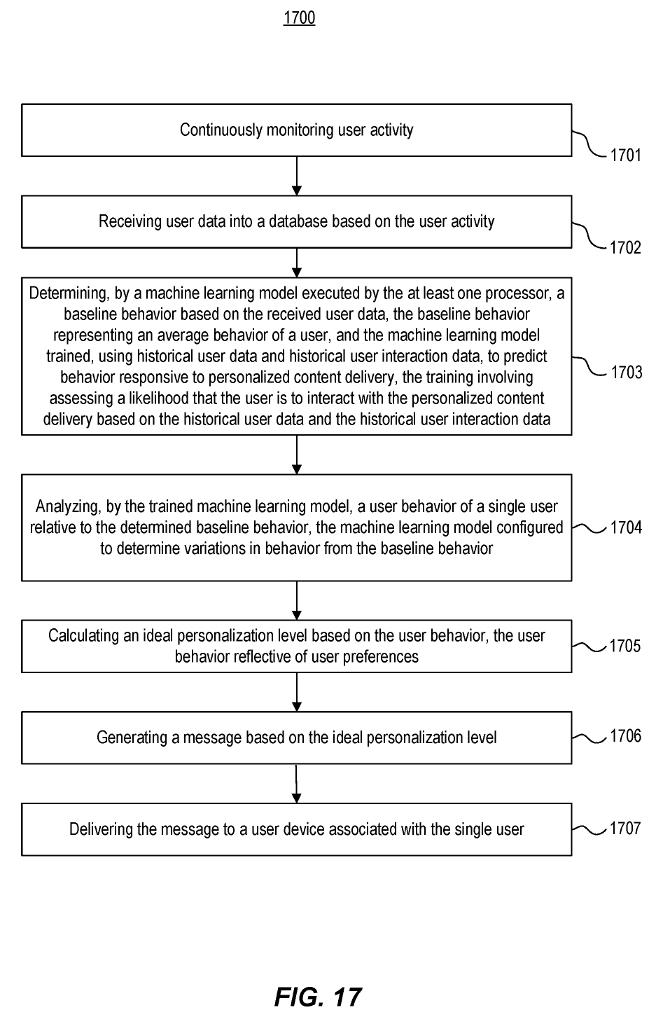

FIG. 17 depicts a flow chart for a method of setting an ideal personalization level. Some embodiments pertain to a machine learning model that determines a user’s ideal initial personalization level and delivers content at that personalization level. The machine learning model may determine an initial personalization level of a user that may be less than the maximum personalization level but may be more suitable to the user’s preferences. Such embodiments may involve a computer system, for example, at a bank or institution, that uses a machine learning model to determine a user’s ideal initial personalization level and deliver content at that personalization level. Method 1700 may include a step 1701 of continuously monitoring user activity. Method 1700 may include a step 1702 of receiving user data into a database based on the user activity. In some embodiments, the user activity may include a user location based on a location of a user device.

Method 1700 may include a step 1703 of determining, using a machine learning model executed by the at least one processor, a baseline behavior based on the received user data, the baseline behavior representing an average behavior of a user. The machine learning model may be trained, using historical user data and historical user interaction data, to predict behavior responsive to personalized content delivery. The training may involve assessing a likelihood that the user is to interact with the personalized content delivery based on the historical user data and the historical user interaction data. In some embodiments, the user may be a plurality of users. In some embodiments, the baseline behavior may be a representation of how most users behave in response to receiving personalized content. In some embodiments, the behavior may be a response or an interaction. In some embodiments, the personalized content may be a message, such as a text message, email, or push notification.

In some embodiments, the machine learning model may be trained from historical user data or historical interaction data of several users to determine baseline behavior, where the baseline behavior may be an average behavior of users in response to being delivered personalized content. The machine learning model may be trained that receiving a piece of personalized content is likely to elicit a behavior from the average user. The machine learning model may thus be trained to predict the baseline behavior of the average user in response to receiving the personalized content. In some embodiments, the machine learning model may be trained to predict the baseline behavior of the average user of a certain demographic in response to receiving the personalized content.

The machine learning model may be shown exemplary personalized content and what the average user’s behavior is. One example may include that the average user is likely to open and interact with personalized content related to maintaining or improving their financial health. Another example may include that the average user does is likely to open but unlikely to further interact with personalized content relating to a product, where the personalized content is delivered within one week of searching for the product on the internet. Another example may include that the average user is likely to open and further interact with personalized content related to a destination, where the average user purchased a flight to the destination and the personalized content is delivered before the flight.

The machine learning model may learn from the examples and may further be trained by receiving historical user activity and interaction data and determining a baseline behavior based for various personalized content. For each set of data, the machine learning model may determine the baseline behavior based on the personalized content, and the determination may then be confirmed or corrected until the machine learning model is able to make accurate determinations a threshold amount of the time. For example, the machine learning model may be shown personalized content related to strategies for maximizing savings each month. The machine learning model may predict that the baseline behavior will be to open and further interact with the message since the message related to maintaining and improving financial health. The machine learning model may be informed its determination was correct and continue training. In another example, the machine learning model may be shown personalized content related to a product the user has never purchased but searched the internet for on the previous day. The machine learning model may predict that the baseline behavior will be to open but not further interact with the message. The machine learning model may be informed its determination was correct and continue training. In another example, the machine learning model may be shown personalized content related to the destination the user purchased flights to. The machine learning model may predict that the baseline behavior will be to open but not further interact with the message. The machine learning model may be informed its determination was incorrect and that the correct baseline behavior is to open and further interact with the personalized content.

During operation, the machine learning model may be configured to accept specific inputs. For example, an institution wishing to send users personalized content may generate personalized content of its own or receive promotions or other content from other organizations to distribute to users. The institution may wish to determine which content should be distributed to users based on their needs and interests. The personalized content from the institution and other organizations may be received as an input to machine learning model. The machine learning model may receive the personalized content and predict the baseline behavior of users receiving the content. The machine learning model may output the predicted baseline behavior which may be used by the personalized content system to better understand user preferences and generate content that is more likely to elicit a positive response.

Method 1700 may include a step 1704 of analyzing, by the trained machine learning model, a user behavior of a single user relative to the determined baseline behavior, the machine learning model configured to determine variations in behavior from the baseline behavior.

While the machine learning model may be trained to determine a baseline behavior, since the baseline behavior may be how the average user will behave or how most users will behave, the machine learning model may also already be trained to predict the user behavior, which may be the behavior of the single user. In some embodiments, the user behavior may be a timing of a purchase. In another embodiment, the user behavior may include interaction data for a period of time. In another embodiment, the user behavior may include redemption data for a period of time.

For example, while the machine learning model may have been trained that the average user may be likely to open and further interact with personalized content related to maintaining or improving financial health, but that the single user is unlikely to open or interact with personalized content related to maintaining or improving financial health. Similarly, while the machine learning model may have been trained that the average user may open but is unlikely to further interact with personalized content related to the product they’ve never purchased but recently searched for on the internet, and that the single user is also likely to open but unlikely to further interact with personalized content related to the product they’ve never purchased but recently searched for on the internet.

With this training, the machine learning model may be configured to determine variations in variations in behavior from the baseline behavior. In some embodiments, the determination may be binary in that it may merely determine if the user behavior is different than the baseline behavior. In other embodiments, the determination may be more involved, such as by indicating that a difference exists and whether the baseline behavior or the user behavior has a more positive response to personalized content.

Method 1700 may include a step 1705 of calculating an ideal personalization level based on the user behavior, the user behavior reflective of user preferences. In some embodiments, the user may adjust how personalized the personalized content they receive is. Personalization level, as described herein, may refer to how personalized the personalized content is. Ideal personalization level, as described herein, may refer to the personalization level most suited for a user based on the user’s comfort and preferences. In some embodiments, the personalization level may be a numerical level ranging from zero to one hundred, where a personalization level of zero may mean the personalized content is not personalized or only slightly personalized, and a personalization level of one hundred may mean the personalized content is personalized to the fullest extent. In some embodiments, the ideal personalization level may start at or be a factor of a baseline personalization level, where the baseline personalization level may be determined based on the baseline behavior.

Method 1700 may include a step 1706 of generating a message based on the ideal personalization level. Method 1700 may include a step 1707 of delivering the message to a user device associated with the single user. In some embodiments, the message may be delivered via a push notification. In some embodiments, the message may include a statistic on the ideal personalization level. For example, the message may include a notification of whether the ideal personalization level of the user is greater than a personalization level calculated from the baseline behavior.

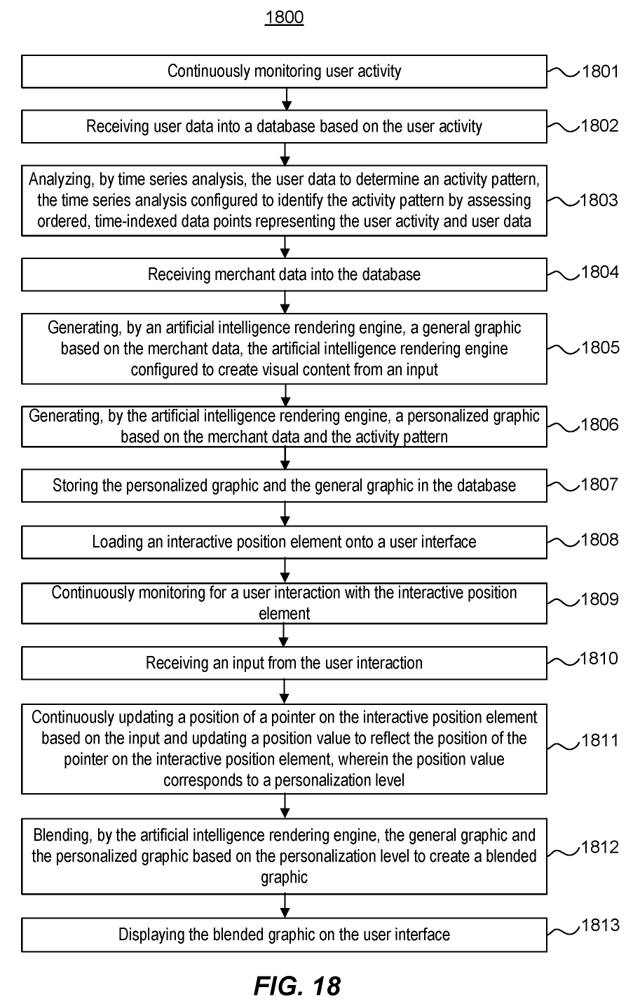

FIG. 18 depicts a flow chart for a method of generating user-selectable personalization graphics. Some embodiments pertain to tying back-end data analysis to a front-end visual to display a personalization visual, such as a marketing visual, to a user that is representative of the user’s selections. Such embodiments may involve a computer system, for example, at a bank or institution, that ties back-end data analysis to a front-end visual to display a personalization visual to a user that is representative of the user’s selections. Method 1800 may include a step 1801 of continuously monitoring user activity. Method 1800 may include a step 1802 of receiving user data into a database based on the user activity.

Method 1800 may include a step 1803 of analyzing, by time series analysis, the user data to determine an activity pattern, the time series analysis configured to identify the activity pattern by assessing ordered, time-indexed data points representing the user activity and user data. Activity pattern, as described herein, may refer to a trend in the user data appearing over time, such as recurring transactions; transactions falling into a category, such as dining, clothing, recreation, or travel, or falling a subcategory of the category; transactions occurring at a specific day or time in a time period, such as the beginning of a month, end of the month, the third day of the month, a morning, an evening, or a Saturday; transactions occurring in a location; regular user interaction with an account; user interaction with a message containing content related to a category; or consistency or consistent change in account balance. In some embodiments, the activity pattern may be a location pattern. The location pattern may highlight a movement preference of a user and may involve a log of previous locations for a period of time.

In some embodiments, the time series analysis may evaluate various types of user data against time. In some embodiments, the time series analysis may evaluate an account balance against time. In another embodiment, the time series analysis may evaluate a total number of transactions against time. In another embodiment, the time series analysis may evaluate a number of transactions falling into a category of user activity against time. Category of user activity, as described herein, may refer to types of user activity, such as, for example, spending categories like food, restaurants, entertainment, groceries, retail, or travel.

In one example, the user’s account balance may be analyzed with respect to time to determine an activity pattern. In analyzing the user’s account balance over time, it may be determined that the account balance is trending upwards, has a two large deposits each month and two large expenses each month. The analysis may reveal activity patterns, such as the user’s deposit schedule, the user’s monthly recurring payments, or other patterns of spending or saving. In another example, the number of transactions falling into a category of user activity may be analyzed with respect to time to determine an activity pattern. In analyzing the number of transactions falling into a category over time, it may be determined that the user grocery shops very consistently, once per week, but the user goes out to eat at restaurants a lot during the first week of each month but not at all during the rest of the month. The analysis may reveal activity patterns, such as the user’s spending or savings patterns. In another example, the user’s search history for a product may be analyzed with respect to time to determine an activity pattern. In analyzing the number of times the user searched for a product over time, it may be determined that the user searched for the product once during the first week of the month, the number of searches increased over the course of the month, and the user searched for the product twelve times during the last week of the month. The analysis may reveal activity patterns, such as the user’s search history of the product, and the user’s change in interest in the product over time.

Method 1800 may include a step 1804 of receiving merchant data into the database. Method 1800 may include a step 1805 of generating, by an artificial intelligence rendering engine, a general graphic based on the merchant data, the artificial intelligence rendering engine configured to create visual content from an input. Artificial intelligence rendering engine, as described herein, may refer to a software component that translates or converts data or code into a visual representation. Here, the artificial intelligence rendering engine may convert merchant data, such as available products, into a visual representation such as, for example, a picture, advertisement, coupon, or promotion. General graphics, as described herein, may refer to visual content designed for broad, undifferentiated audience rather than being tailored to a user’s data.

In some embodiments, the artificial intelligence rendering engine may use an artificial intelligence model. For example, the artificial intelligence model may be trained from a large dataset of images, where each image may be paired with descriptive text or metadata. In one example, one of the images in the dataset may be an image of a tennis ball, and the artificial intelligence model may be trained to recognize the image as a tennis ball and learn what a tennis ball is to be able to generate an image of a tennis ball from the text “tennis ball.”

For example, the artificial intelligence model may be shown exemplary images of tennis balls in various settings and told the image contains a tennis ball. From the images, the artificial intelligence model may be trained that a tennis ball is circular, yellow, and fuzzy, with a white stripe that wraps around the ball and sometimes with text or images on the ball.

The artificial intelligence model may learn from the exemplary images and may further be trained by receiving an image and determining if the image contains a tennis ball. For each image, the artificial intelligence model may determine whether the image contains a tennis ball. The determination may then be confirmed or corrected until the artificial intelligence model is able to make accurate determinations a threshold amount of the time. In other embodiments, the artificial intelligence model may may further be trained by receiving descriptive text and generating an image that accurately represents the descriptive text. For each set of data, which may include descriptive text, the artificial intelligence model may generate an image based on the descriptive text. The accuracy of the generated image may then be confirmed or corrected until the artificial intelligence model is able to make accurate determinations a threshold amount of the time.

For example, the artificial intelligence model may receive an image of a baseball and may recognize that the image does not contain a tennis ball. The artificial intelligence model may be informed its determination was correct and continue training. In another example, the artificial intelligence model may receive data, including descriptive text that reads “tennis ball,” and may generate an image of a lemon. The artificial intelligence model may be informed its determination was incorrect and may be shown a correct image of a tennis ball.

During operation, the artificial intelligence model may be configured to accept specific inputs, such as images and data, including descriptive text. The artificial intelligence model may recognize the contents of an image and output descriptive text or may receive descriptive text from data, such as the merchant data, and may generate and output an image that accurately represents a piece of data. Here, where the general graphic is based purely on the merchant data, the artificial intelligence rendering engine may generate an image related to, for example, product or service offerings, an upcoming sale, a promotion, a coupon, or an advertisement.

Method 1800 may include a step 1806 of generating, by the artificial intelligence rendering engine, a personalized graphic based on the merchant data and the activity pattern. Personalized graphics, as described herein, may refer to visual content designed for a specific user or group of users and tailored to a user or group of users’ data or interests. Here, the artificial intelligence rendering engine may convert merchant data and the activity pattern, into a visual representation, such as, for example, a picture, advertisement, coupon, or promotion. Here, where the personalized graphic is based on the merchant data and the activity pattern, the artificial intelligence rendering engine may generate an image related to, for example, product or service offerings, an upcoming sale, a promotion, a coupon, or an advertisement that also include elements of the user’s activity, interests, location, or identity. For example, whereas the general graphic may be an image promoting a sale, including the dates and types of products on sale, the personalized graphic may be an image promoting a sale, including the dates, that the location near the user is offering an additional 5% off purchases of $50 or more, that the blouse the user has been searching the internet for is back in stock and part of the sale, and that the blouse is currently available in the user’s size and favorite color. In another example, the general graphic may be an image of a regular can of tennis balls, but the personalized graphic may be an image of a twelve pack of limited-addition, pink ribbon, breast cancer awareness tennis balls since the user normally purchases tennis balls in bulk and the user makes monthly donations to a foundation that supports breast cancer research.

Method 1800 may include a step 1807 of storing the personalized graphic and the general graphic in the database. Method 1800 may include a step 1808 of loading an interactive position element onto a user interface. In some embodiments, the interactive position element may be loaded onto a user interface using active or passive loading. In some embodiments, passive loading may be used to load content upfront, when an application or the user interface first starts, so the content is ready for immediate access. In other embodiments, active loading may be used to load content, such as the interactive position element, on demand upon the user requesting the content. In some embodiments, content, such as the interactive position element, may be loaded through a fetch process. In some embodiments, the fetch process may involve the user interface receiving a request for content from the user, the user interface sending a request to a server and asking for the files containing the requested content, the server sending the requested files in a data packet back to the user interface, the user interface parsing the files, the user interface building a structure of the requested content and using rendering tools to display the requested content, and the system executing code to modify the requested content or add functionality, making the requested content interactive.

In some embodiments, the interaction may occur by the user providing an input, such as by clicking and dragging along a slide bar, tapping, or speaking, or by numerical entry. In other embodiments, the interactive position element may be a personalization slider. Personalization slider, as described herein, may refer to a tool that may allow a user to adjust a personalization level of future content such as messages.

Method 1800 may include a step 1809 of continuously monitoring for a user interaction with the interactive position element. Method 1800 may include a step 1810 of receiving an input from the user interaction. Method 1800 may include a step 1811 of continuously updating a position of a pointer on the interactive position element based on the input and updating a position value to reflect the position of the pointer on the interactive position element, wherein the position value corresponds to a personalization level. The pointer, as described herein, may refer to an indicator along the interactive position element. The pointer may be any number of shapes or sizes, and the pointer may be bound by edges of the interactive position element. Position value, as described herein, may refer to a value or assessment of a location of the pointer on or within the interactive position element. In some embodiments, the position value may range from zero to one hundred, where a position value of zero may result in the least personalization and a position value of one hundred may result in the most personalization. Specific to personalized content, the personalized content system may generate personalized content that is the least personalized, or most generic, when the position value is zero and may generate personalized content that is the most personalized when the position value is one hundred. In some embodiments, the position value may be considered high then the position value is greater than fifty and the position value may be considered low when the position value is less than fifty.

Method 1800 may include a step 1812 of blending, by the artificial intelligence rendering engine, the general graphic and the personalized graphic based on the personalization level to create a blended graphic. Blended graphic, as described herein, may refer to a combination of elements of the general graphics and the personalized graphics to reflect a personalization level. In some embodiments, the personalization level of the blended graphic may be considered high when the position value is high. In other embodiments, the personalization level of the blended graphic may be considered low when the position value is low. In some embodiments, the position value being high may trigger a greater influence of the personalized graphic compared to the general graphic in the blended graphic. In some embodiments, the position value being low may trigger a greater influence of the general graphic compared to the personalized graphic in the blended graphic.

In some embodiments, the general graphic and the personalized graphic may be different versions of the same image. In some embodiments, the artificial intelligence rendering engine may blend the general graphic and the personalized graphic through compositing. Compositing, as described herein, may refer to a process of image blending where pixel data is manipulated to combine multiple image element into a single image. In some embodiments, images may be resized to be the same size. In some embodiments, images may be layered on top of one another and the compositing may alter how pixels on a top layer interact with pixels on a bottom layer. The transparency, color, and opacity of various elements of each image being combined may be modified to achieve the blended graphic.

In some embodiments, the general graphic and the personalization graphic may each be assigned a weight based on the personalization level. The weights may affect how the images are blended. For example, if the pointer of the interactive position element is interacted with such that the position value is sixty, the resulting personalization level may lean slightly more personalized than generic. In such a case, the general image may be assigned a weight of 40% and the personalized graphic may be assigned a weight of 60%. Thus, when the general graphic and the personalized graphic are blended to create the blended graphic, the blended graphic may include 40% of the characteristics of the general graphic and 60% of the characteristics of the personalized graphic. Method 1800 may include a step 1813 of displaying the blended graphic on the user interface.

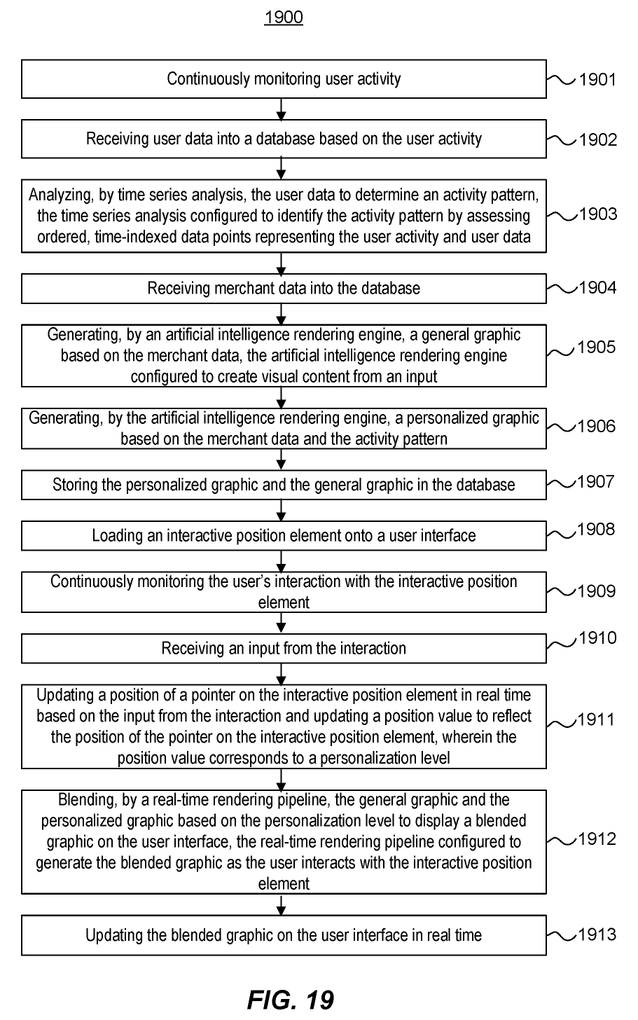

FIG. 19 depicts a flow chart for another method of generating user-selectable personalization graphics. Some embodiments pertain to a machine learning model that allows a personalization visual to change fluidly as the user changes their personalization selection. In some cases, the visual may change intelligently, by for example, using artificial intelligence. Such embodiments may involve a computer system, for example, at a bank or institution, that uses a machine learning model to change a personalization visual fluidly and intelligently as the user changes their personalization selection. Method 1900 may include a step 1901 of continuously monitoring user activity. Method 1900 may include a step 1902 of receiving user data into a database based on the user activity. In some embodiments, the activity pattern may be a location pattern.

Method 1900 may include a step 1903 of analyzing, by time series analysis, the user data to determine an activity pattern, the time series analysis configured to identify the activity pattern by assessing ordered, time-indexed data points representing the user activity and user data. In some embodiments, the time series analysis may evaluate various types of user data against time. In some embodiments, the time series analysis may evaluate an account balance against time. In another embodiment, the time series analysis may evaluate a total number of transactions against time. In another embodiment, the time series analysis may evaluate a number of transactions falling into a category of user activity against time.

In one example, the user’s account balance may be analyzed with respect to time to determine an activity pattern. In analyzing the user’s account balance over time, it may be determined that the account balance is trending upwards, has a two large deposits each month and two large expenses each month. The analysis may reveal activity patterns, such as the user’s deposit schedule, the user’s monthly recurring payments, or other patterns of spending or saving. In another example, the number of transactions falling into a category of user activity may be analyzed with respect to time to determine an activity pattern. In analyzing the number of transactions falling into a category over time, it may be determined that the user grocery shops very consistently, once per week, but the user goes out to eat at restaurants frequently during the first week of each month but not at all during the rest of the month. The analysis may reveal activity patterns, such as the user’s spending or savings patterns.

In another example, the user’s search history for a product may be analyzed with respect to time to determine an activity pattern. In analyzing the number of times the user searched for a product over time, it may be determined that the user searched for the product once during the first week of the month, the number of searches increased over the course of the month, and the user searched for the product twelve times during the last week of the month. The analysis may reveal activity patterns, such as the user’s search history of the product and the user’s change in interest in the product over time.

Method 1900 may include a step 1904 of receiving merchant data into the database. Merchant data, as described herein, may refer to information related to a merchant, such as name, address, operations, list of products for sale, list of services offered, or date of sales. Method 1900 may include a step 1905 of generating, by an artificial intelligence rendering engine, a general graphic based on the merchant data, the artificial intelligence rendering engine configured to create visual content from an input. Here, the artificial intelligence rendering engine may convert merchant data, such as available products, into a visual representation, such as, for example, a picture, advertisement, coupon, or promotion. General graphics, as described herein, may refer to visual content designed for broad, undifferentiated audience rather than being tailored to a user’s data.

In some embodiments, where the general graphic is based purely on the merchant data, the artificial intelligence rendering engine may generate an image related to, for example, product or service offerings, an upcoming sale, a promotion, a coupon, or an advertisement.

Method 1900 may include a step 1906 of generating, by the artificial intelligence rendering engine, a personalized graphic based on the merchant data and the activity pattern. Here, the artificial intelligence rendering engine may convert merchant data and the activity pattern, into a visual representation, such as, for example, a picture, advertisement, coupon, or promotion. In some embodiments, where the personalized graphic is based on the merchant data and the activity pattern, the artificial intelligence rendering engine may generate an image related to, for example, product or service offerings, an upcoming sale, a promotion, a coupon, or an advertisement that also include elements of the user’s activity, interests, location, or identity. For example, whereas the general graphic may be an image promoting a sale, including the dates and types of products on sale, the personalized graphic may be an image promoting a sale, including the dates, that the location near the user is offering an additional 5% off purchases of $50 or more, that the blouse the user has been searching the internet for is back in stock and part of the sale, and that the blouse is currently available in the user’s size and favorite color. In another example, the general graphic may be an image of a regular can of tennis balls, but the personalized graphic may be an image of a twelve pack of limited-addition, pink ribbon, breast cancer awareness tennis balls since the user normally purchases tennis balls in bulk and the user makes monthly donations to a foundation that supports breast cancer research.

Method 1900 may include a step 1907 of storing the personalized graphic and the general graphic in the database. Method 1900 may include a step 1908 of loading an interactive position element onto a user interface. In some embodiments, the interactive position element may be loaded onto a user interface using active or passive loading. In some embodiments, passive loading may be used to load content upfront, when an application or the user interface first starts, so the content is ready for immediate access. In other embodiments, active loading may be used to load content, such as the interactive position element, on demand upon the user requesting the content. In some embodiments, content, such as the interactive position element, may be loaded through a fetch process. In some embodiments, the fetch process may involve the user interface receiving a request for content from the user, the user interface sending a request to a server and asking for the files containing the requested content, the server sending the requested files in a data packet back to the user interface, the user interface parsing the files, the user interface building a structure of the requested content and using rendering tools to display the requested content, and the system executing code to modify the requested content or add functionality, making the requested content interactive.

Method 1900 may include a step 1909 of continuously monitoring the user’s interaction with the interactive position element. Method 1900 may include a step 1910 of receiving an input from the interaction. Method 1900 may include a step 1911 of updating a position of a pointer on the interactive position element in real time based on the input from the interaction and updating a position value to reflect the position of the pointer on the interactive position element, wherein the position value corresponds to a personalization level. The pointer may be any number of shapes or sizes, and the pointer may be bound by edges of the interactive position element. In some embodiments, the position value may range from zero to one hundred, where a position value of zero may result in the least personalization and a position value of one hundred may result in the most personalization. Specific to personalized content, the personalized content system may generate personalized content that is the least personalized, or most generic, when the position value is zero and may generate personalized content that is the most personalized when the position value is one hundred. In some embodiments, the position value may be considered high then the position value is greater than fifty and the position value may be considered low when the position value is less than fifty.

Method 1900 may include a step 1912 of blending, by a real-time rendering pipeline, the general graphic and the personalized graphic based on the personalization level to display a blended graphic on the user interface, the real-time rendering pipeline configured to generate the blended graphic as the user interacts with the interactive position element.

Method 1900 may include a step 1913 of updating the blended graphic on the user interface in real time. In some embodiments, the user’s interaction with the interactive position element may be monitored and processed as it is received. In some embodiments, the user’s interaction with the interactive position element may be processed during each user interaction. For example, the user may interact with the personalization slider by clicking and dragging the pointer. One interaction with the personalization slider may involve clicking on the pointer, dragging the pointer to a new location along the personalization slider, and releasing the click. While in some embodiments the user’s interaction may be detected and processed upon the click being released, in other embodiments, the user’s interaction may be detected when the user clicks on the pointer, and the processing may last from the clicking of the pointer until the click is released. This way, the blended graphic may change as the user drags the pointer instead of waiting until after.

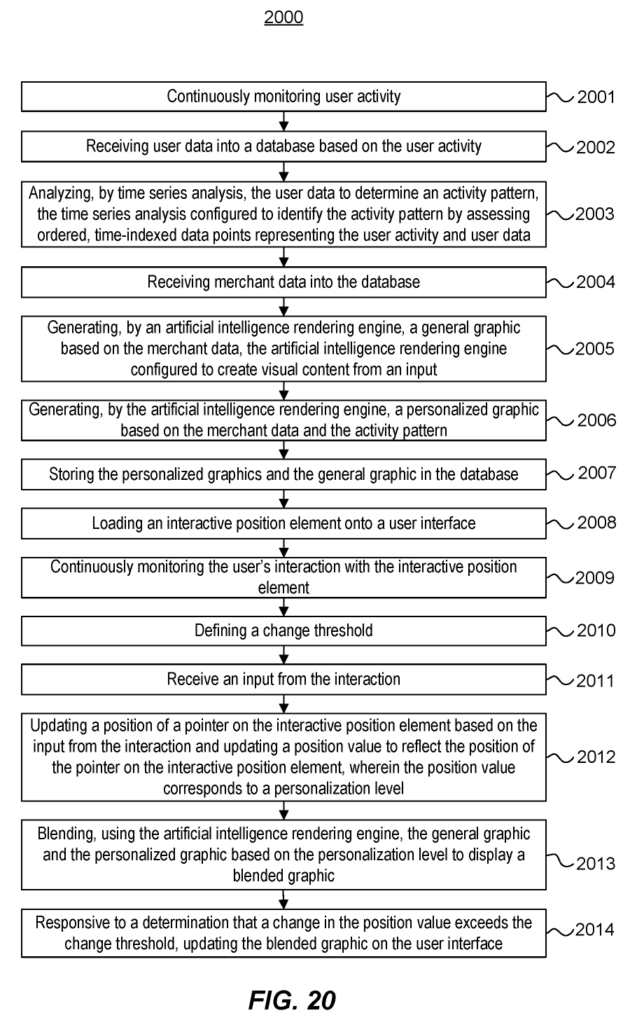

FIG. 20 depicts a flow chart for yet another method of generating user-selectable personalization graphics. Some embodiments pertain to updating a personalization visual at specific intervals or according to a user’s personalization selection. Such embodiments may involve a computer system, for example, at a bank or institution, that updates a personalization visual at specific intervals or according to a user’s personalization selection. Method 2000 may include a step 2001 of continuously monitoring user activity. Method 2000 may include a step 2002 of receiving user data into a database based on the user activity. In some embodiments, the activity pattern may be a location pattern.

Method 2000 may include a step 2003 of analyzing, by time series analysis, the user data to determine an activity pattern, the time series analysis configured to identify the activity pattern by assessing ordered, time-indexed data points representing the user activity and user data.

In some embodiments, the time series analysis may evaluate various types of user data against time. In some embodiments, the time series analysis may evaluate an account balance against time. In another embodiment, the time series analysis may evaluate a total number of transactions against time. In another embodiment, the time series analysis may evaluate a number of transactions falling into a category of user activity against time.

In one example, the user’s account balance may be analyzed with respect to time to determine an activity pattern. In analyzing the user’s account balance over time, it may be determined that the account balance is trending upwards, has a two large deposits each month and two large expenses each month. The analysis may reveal activity patterns, such as the user’s deposit schedule, the user’s monthly recurring payments, or other patterns of spending or saving. In another example, the number of transactions falling into a category of user activity may be analyzed with respect to time to determine an activity pattern. In analyzing the number of transactions falling into a category over time, it may be determined that the user grocery shops very consistently, once per week, but the user goes out to eat at restaurants a lot during the first week of each month but not at all during the rest of the month. The analysis may reveal activity patterns, such as the user’s spending or savings patterns.

In another example, the user’s search history for a product may be analyzed with respect to time to determine an activity pattern. In analyzing the number of times the user searched for a product over time, it may be determined that the user searched for the product once during the first week of the month, the number of searches increased over the course of the month, and the user searched for the product twelve times during the last week of the month. The analysis may reveal activity patterns, such as the user’s search history of the product and the user’s change in interest in the product over time.

Method 2000 may include a step 2004 of receiving merchant data into the database. Method 2000 may include a step 2005 of generating, by an artificial intelligence rendering engine, a general graphic based on the merchant data, the artificial intelligence rendering engine configured to create visual content from an input. The artificial intelligence model may recognize the contents of an image and output descriptive text or may receive descriptive text from a data, such as the merchant data, and may generate and output an image that accurately represents a piece of data. In some embodiments, where the general graphic is based purely on the merchant data, the artificial intelligence rendering engine may generate an image related to, for example, product or service offerings, an upcoming sale, a promotion, a coupon, or an advertisement.

Method 2000 may include a step 2006 of generating, by the artificial intelligence rendering engine, a personalized graphic based on the merchant data and the activity pattern. In some embodiments, the artificial intelligence engine rendering engine may convert merchant data and the activity pattern, into a visual representation, such as, for example, a picture, advertisement, coupon, or promotion. In some embodiments, where the personalized graphic is based on the merchant data and the activity pattern, the artificial intelligence rendering engine may generate an image related to, for example, product or service offerings, an upcoming sale, a promotion, a coupon, or an advertisement that also include elements of the user’s activity, interests, location, or identity, as described herein.

Method 2000 may include a step 2007 of storing the personalized graphics and the general graphic in the database. Method 2000 may include a step 2008 of loading an interactive position element onto a user interface. In some embodiments, the interactive position element may be loaded onto a user interface using active or passive loading. In some embodiments, passive loading may be used to load content upfront, when an application or the user interface first starts, so the content is ready for immediate access. In other embodiments, active loading may be used to load content, such as the interactive position element, on demand upon the user requesting the content. In some embodiments, content, such as the interactive position element, may be loaded through a fetch process. In some embodiments, the fetch process may involve the user interface receiving a request for content from the user, the user interface sending a request to a server and asking for the files containing the requested content, the server sending the requested files in a data packet back to the user interface, the user interface parsing the files, the user interface building a structure of the requested content and using rendering tools to display the requested content, and the system executing code to modify the requested content or add functionality, making the requested content interactive.

Method 2000 may include a step 2009 of continuously monitoring the user’s interaction with the interactive position element. Method 2000 may include a step 2010 of defining a change threshold. A change threshold, as described herein, may refer to a magnitude of change required to trigger a reaction. In some embodiments, the change threshold may be predetermined. In some embodiments, the change threshold may be an arbitrary value such as ten. In some embodiments, the change threshold may be a magnitude of change based on where the pointer was last determined to be. In other embodiments, the change threshold may be preset intervals on the interactive position element.

Method 2000 may include a step 2011 of receiving an input from the interaction. Method 2000 may include a step 2012 of updating a position of a pointer on the interactive position element based on the input from the interaction and updating a position value to reflect the position of the pointer on the interactive position element, wherein the position value corresponds to a personalization level, as described herein.

Method 2000 may include a step 2013 of blending, using the artificial intelligence rendering engine, the general graphic and the personalized graphic based on the personalization level to display a blended graphic, as disclosed herein.

Method 2000 may include a step 2014 of, responsive to a determination that a change in the position value exceeds the change threshold, updating the blended graphic on the user interface. For example, the user may interact with the personalization slider by clicking and dragging the pointer. One interaction with the personalization slider may involve clicking on the pointer, dragging the pointer to a new location along the personalization slider, and releasing the click. While in some embodiments the user’s interaction may be detected and processed upon the click being released, in other embodiments, the user’s interaction may be detected when the user clicks on the pointer, and the processing may last from the clicking of the pointer until the click is released. When the pointer is detected as being dragged such that the position value changes by more than a change threshold, the blended graphic may change.

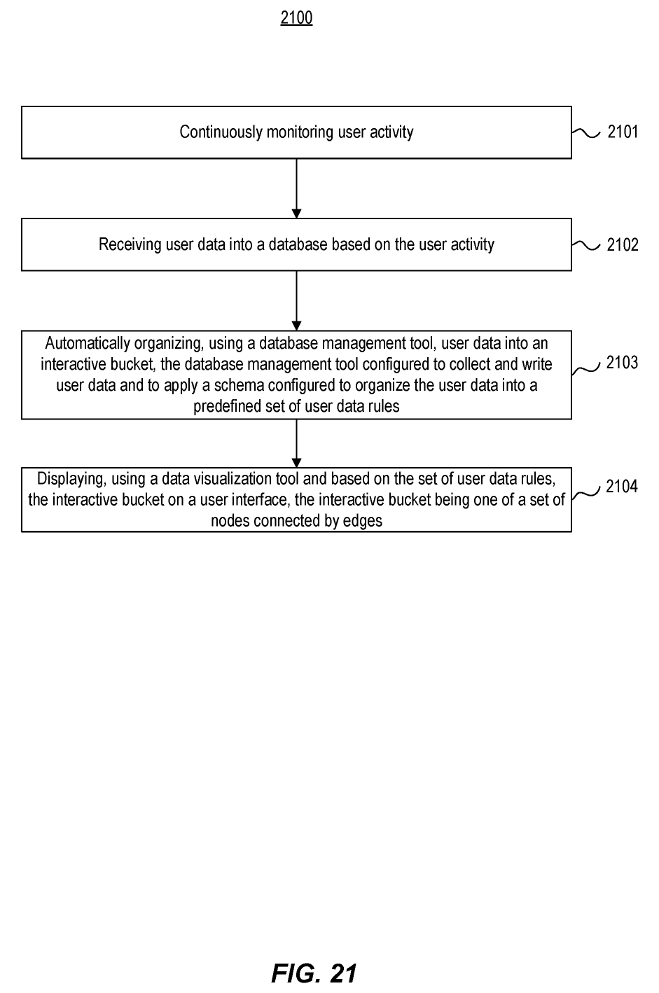

FIG. 21 depicts a flow chart for a method of identifying a user network. Some embodiments pertain to determining a snapshot of a user’s network. Such embodiments may involve a computer system, for example, at a bank or financial institution, that determines a snapshot of a user’s network. Method 2100 may include a step 2101 of continuously monitoring user activity. In some embodiments, the user activity may include a user location based on a location of a user device. In some embodiments, the user location is an indicator of a distance the user will travel to make a transaction. In another embodiment, the user activity may include account activity. Method 2100 may include a step 2102 of receiving user data into a database based on the user activity.

Method 2100 may include a step 2103 of automatically organizing, using a database management tool, user data into an interactive bucket, the database management tool configured to collect and write user data and to apply a schema configured to organize the user data into a predefined set of user data rules. Interactive bucket, as described herein, may refer to a storage system within the database used to further arrange the user data into a category of user data. In some embodiments, the data visualization tool may be configured to enable interacting with an interactive bucket to view the user data associated with the interactive bucket. The interactive bucket may be interactive with by the user through a user interface where the user may expand the interactive bucket to see the user data it contains. In some embodiments, the interactive bucket may correspond to a spending category. In some embodiments, the spending category may include purchasing goods at a grocery store. In such embodiments, user activity related to purchasing goods at the grocery store may be organized into the interactive bucket. In some embodiments, the spending category may include purchasing food at a restaurant. In such embodiments, user activity related to purchasing food at a restaurant may be organized into the interactive bucket. The database management tool may process user data stored in the database to better organize it for further analysis and display. In some embodiments, the database management tool may use schema-on-write to collect and write data and to apply a schema.

The database management tool may use schema-on-write to organize data by defining and enforcing the schema, or structure, for the data before the data is stored. In some embodiments, defining the schema may include specifying tables, columns, data types, constraints, and relationships between tables. In some embodiments, the user data may include transaction data. Transaction data, as described herein, may include time- and location-stamped records of funds moving into or out of a user account. In some embodiments, the transaction data may include deposits and withdrawals by the user, and in some embodiments, the transaction data may include expenses, such as on a credit card statement. The transaction data may include an identification number, timestamp, amount, and status, such as successful or failed. The transaction data may also include contextual information including merchant name, merchant type, or location. In some embodiments, the schema may be defined based on the date the database will receive. In one example, the database may receive transaction data. In such an example, defining the schema may involve specifying that types of transactions, such as products, services, withdrawals, or deposits, may each be a separate table. In other embodiments, the tables may be specified for various categories of expenses, such as travel, leisure, entertainment, dining, or life expenses. In other embodiments, the tables may be specified for merchants or for locations. The schema may also be defined by specifying columns for the tables, such as date, time, location, merchant name, and product involved in a transaction.

Once the schema is defined, incoming user data may be processed and transformed to fit the predefined schema, and data not conforming to the schema may be rejected, modified, or stored elsewhere. When the data is written, the database management system may validate the data against the schema to ensure data stored is consistent and relevant. The data may then be stored in the specified tables. In some embodiments, the specified tables may make up the interactive buckets.

Method 2100 may include a step 2104 of displaying, using a data visualization tool and based on the set of user data rules, the interactive bucket on a user interface, the interactive bucket being one of a set of nodes connected by edges. A data visualization tool, as described herein, may refer to a tool that provides a visual representation of connected ideas. The nodes and the edges may enable the interactive nodes to be interconnected based on their relationships or common features. Nodes, as described herein, may be entities in a connected network, and edges, as described herein, may represent how the nodes, are connected or related. In some embodiments, the data visualization tool may display the interactive bucket in a table or on a graph,

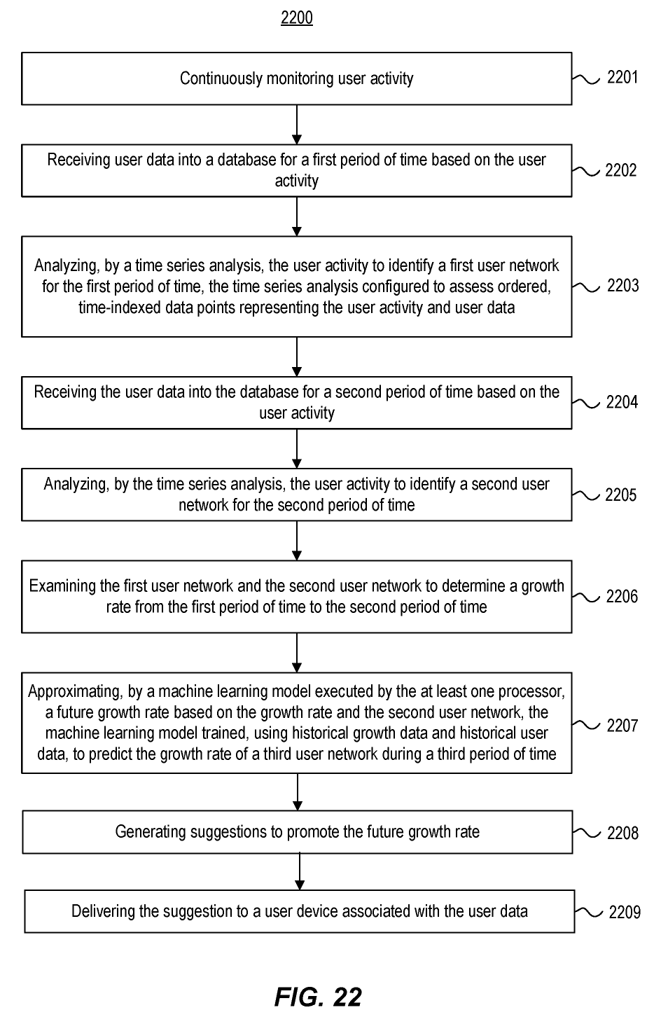

FIG. 22 depicts a flow chart for a method of growing a user network. Some embodiments pertain to growing a user’s network by sending suggestions that push the user to try new things, not just what they are already interested in. Such embodiments may involve a computer system, for example, at a bank or institution, that grows a user’s network by sending suggestions that push the user to try new things, not just what the user is already interested in. Method 2200 may include a step 2201 of continuously monitoring user activity. In some embodiments, the user activity may include a user location based on a location of a user device. In some embodiments, the user location may include a first user location and a second user location, where the first user location may include a first distance a user may travel for a first user activity during a first period of time, and the second user location may include a second distance the user may travel for a second user activity during a second period of time. In another embodiment, the user activity may include account activity. Method 2200 may include a step 2202 of receiving user data into a database for a first period of time based on the user activity.

Method 2200 may include a step 2203 of analyzing, by a time series analysis, the user activity to identify a first user network for the first period of time, the time series analysis configured to assess ordered, time-indexed data points representing the user activity and user data.

In one example, the user’s transactions in a location, such as a city where the user resides and/or a neighboring city, may be analyzed with respect to time to determine a user network, such as the first user network. In some embodiments, the neighboring city may be a city adjacent to the city where the user resides. In analyzing the number of transactions the user made in the city over time, the first user network may be determined. First user network, as described herein, may be a collection of merchants that that the user shops at during the first period of time. Network, as described herein, may be an interconnected community of merchants, businesses, or other organizations that the user interacts with. In some embodiments, the time series analysis may be executed for several cities, such as cities where the majority of the user’s transactions occur. In some embodiments, the time series analysis may be executed for several neighboring cities, such as cities the user visits less frequently. The results may then be examined as a whole to get a broader picture of the first user network. The broad picture may provide insight into the user’s interests, routine, favorite merchants, or a distance the user may be willing to travel for various goods during the first period of time.

Method 2200 may include a step 2204 of receiving the user data into the database for a second period of time based on the user activity. Method 2200 may include a step 2205 of analyzing, by the time series analysis, the user activity to identify a second user network for the second period of time.

In one example, the user’s transactions in a location, such as a neighboring city, may be analyzed with respect to time to determine a user network, such as the second user network. Second user network, as described herein, may be a collection of merchants that that the user shops at during the second period of time. In some embodiments, the neighboring city may be a city adjacent to the city where the user resides. In analyzing the number of transactions the user made in the neighboring city over time, it may be determined that the user made 3% more transactions in the neighboring city in a current three month period than the user made in a previous three month period. In some embodiments, the time series analysis may be executed for several neighboring cities, such as cities the user visits less frequently. The results may then be examined as a whole to view a broader picture of the second user network. The broad picture may provide insight into the user’s interests, routine, favorite merchants, or a distance the user may be willing to travel for various goods during the first period of time. The time series analysis may reveal a trend, cycle, or seasonal pattern in the second user network, such as the user’s network growing or shrinking over time. For example, the time series analysis may reveal that the second user network is larger than the first user network, which may indicate that the user shopped at more merchants or traveled further distances during the second period of time than the first period of time.

Method 2200 may include a step 2206 of examining the first user network and the second user network to determine a growth rate from the first period of time to the second period of time. In some embodiments, the growth rate may reflect a change from the first user network to the second user network. In some embodiments, the growth rate may be based on the number of different merchants the user made transactions at. In other embodiments, the growth rate may be distance-based. In some embodiments, the growth rate may be one of either a positive or a negative percentage, where a positive percentage may indicate growth from the first user network to the second user network, and a negative percentage may indicate shrinkage from the first user network to the second user network.

For example, in examining the first user network and the second user network, it may be determined that the user shaped at 5% more merchants during the second time period than during the first time period. In another example, in examining the first user network and the second user network, it may be determined that the user covered more ground during the second period of time than during the first period of time. It may be determined that the merchant that the user made a transaction at that was furthest from the user’s home address during the second period of time was 12% further away than the merchant that was furthest away during the first period of time.

Method 2200 may include a step 2207 of approximating, by a machine learning model executed by the at least one processor, a future growth rate based on the growth rate and the second user network. The machine learning model may be trained, using historical growth data and historical user data, to predict the growth rate of a third user network during a third period of time. The machine learning model may be shown an exemplary second user network, the growth rate for the second user network, and an approximation of the future growth rate for a third month. One example may include that, in a first month, the user made transactions at one hundred different merchants, the furthest of which was forty miles from their home address. In a second month, the user made transactions at one hundred and five different merchants, the furthest of which was fifty miles from their home address, so there was a 5% increase in the number of different merchants from the previous month and a 25% increase in the furthest distance the user traveled to make a transaction. The machine learning model may be trained that an appropriate approximation for the future growth rate, which may be a growth rate of the third user network during a third period of time, may be an 8% increase in terms of the number of different merchants and a 10% increase in terms of distance to the furthest merchant.

In another example, the machine learning model may be trained to predict that the growth rate of the third user network during a third period of time will be the same as the growth rate of the second user network during a second period of time. In another example, the machine learning model may be trained to predict that the growth rate of the third user network during a third period of time will be less than the growth rate of the second user network during a second period of time. In yet another example, the machine learning model may be trained to predict that the growth rate of the third user network during a third period of time will be less than the growth rate of the second user network during a second period of time such that the increase in the number of different merchant and the distance to the furthest merchant is the same from the second period of time to the third period of time as it was from the first period of time to the second period of time. In another example, the machine learning model may be trained to predict that the growth rate of the third user network during a third period of time will be 0% or negative.

The machine learning model may learn from the examples and may further be trained by receiving data related to a first user network and second user network and the corresponding growth rates and predicting the growth rate of the third user network during a third period of time. For each set of data, the machine learning model may approximate the growth rate of the third user network in terms or the number of different merchants or in terms of the distance to the furthest merchant, which may then be confirmed or corrected until the machine learning model is able to make accurate determinations a threshold amount of the time. For example, the machine learning model may data indicating that, in a first month, the user made transactions at eighty different merchants, the furthest of which was twenty miles from their home address, and in a second month, the user made transactions at eighty-eight different merchants, the furthest of which was twenty-five miles from their home address, so there was a 10% increase in the number of different merchants from the previous month and a 25% increase in the furthest distance the user traveled to make a transaction. The machine learning model may predict the growth rate of the third user network during a third period of time and thus approximate that the future growth rate will decrease to 9% in terms of different merchants visited and 20% in terms of distance to the furthest merchant. This way the approximate increase in the number of different merchant and the distance to the furthest merchant is the same from the second period of time to the third period of time as it was from the first period of time to the second period of time. The machine learning model may be informed its determination was correct and continue assessing user activities. During operation, the machine learning model may be configured to accept specific inputs. In some embodiments, the machine learning model may also generate suggestions for a third user activity located at a third location a third distance from a user address, wherein the third distance is longer than the second distance.

Method 2200 may include a step 2208 of generating suggestions to promote the future growth rate. In some embodiments, the suggestion may include an advertisement for the third user activity located at the third location. In another embodiment, the suggestion may include an incentive for the third user activity located at the third location. For example, if the approximated growth rate indicates that the distance of the furthest merchant will increase from twenty to twenty-two miles, the suggestions may include recommendations that the user visit establishments that are between twenty and twenty-two miles from their home address. For example, one suggestion may include a recommendation that the user visit a Restaurant R that is twenty-one miles away. Method 2200 may include a step 2209 of delivering the suggestion to a user device associated with the user data.

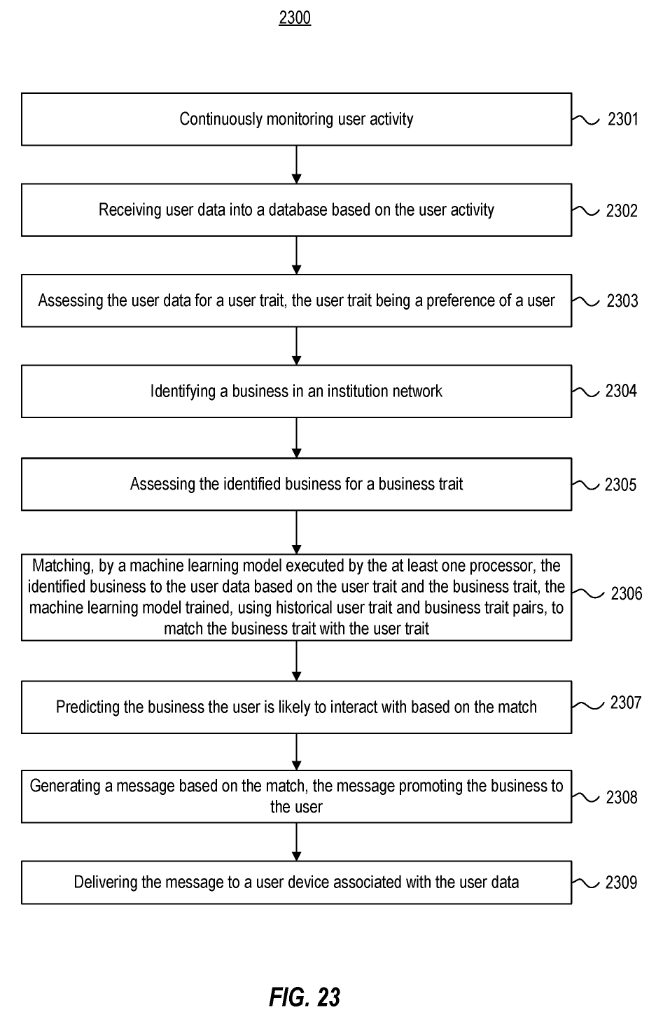

FIG. 23 depicts a flow chart for a method of promoting in-network businesses. Some embodiments pertain to incentivizing users to shop at businesses in an institution network or to shop at small businesses. Such embodiments may involve a computer system, for example, at a bank or institution, that incentivizes users to shop at businesses in an institution network or to shop at small businesses. Method 2300 may include a step 2301 of continuously monitoring user activity. In some embodiments, the user activity may include a user location based on a location of a user device. Method 2300 may include a step 2302 of receiving user data into a database based on the user activity.

Method 2300 may include a step 2303 of assessing the user data for a user trait, the user trait being a preference of a user. The user trait, as described herein, may refer to a characteristic that describes a user, such as those involving demographic data, behavioral data, or psychological data. In some embodiments, the user trait may include a spending habit, highlighting a preference of the user for particular products and services. In some embodiments, user traits may include a travel habit, highlighting a movement preference of the user. In some embodiments, user traits may include user interests. In some embodiments, the user data may be assessed for user traits by examining the user’s transaction history. Each transaction may be received and classified based on the goods and services provided by the merchant. In such an embodiment, transactions may be classified using merchant category codes. Merchant category codes, as described herein, may refer to codes assigned to business based on the types of goods or services the business provides. The business’s merchant category code may fall into a range of merchant category codes, where the range of merchant category codes spans all businesses providing goods and services that fall into a category of goods and services.

In some embodiments, the user trait may be confirmed after the user makes a threshold number of purchases falling into the category or sub-category within a predetermined period of time. In some embodiments, the predetermined period of time may be different for each category of sub-category based on how often an average user purchased goods of services from each category or subcategory. For example, the category of transportation may have another sub-category called air travel, spanning merchant category codes 4011-4025. The user may make four purchases from merchants that fall into the air travel sub-category within a six month period. The threshold number of purchases and predetermined period of time for the air travel sub-category may be three purchases in a six month period. The user may then be confirmed as having the user trait of air traveler. In some embodiments, the user trait may be the same as the category or sub-category. In other embodiments, the user trait may be similar to the category or sub-category, such as with air traveler, or may be different than the category or sub-category.

In other embodiments, the user trait may be confirmed from other user data, such as a user’s choice of credit card. For example, the user may apply for a credit card that has benefits that reward travel above all other purchases. For example, the credit card may reward the user with fifteen points per dollar spent on travel bookings, including air travel bookings, such as flights. In another example, the credit card may reward the user with 8% cash back on travel-related purchases. The user may be confirmed as having the user trait of traveler based on their choice of credit card.

Method 2300 may include a step 2304 of identifying a business in an institution network. Method 2300 may include a step 2305 of assessing the identified business for a business trait. The business trait, as described herein, may refer to a characteristic that describes a business. In some embodiments, the business trait may include a product offering, highlighting a category of product sold. In some embodiments, the business trait may include a service offering, highlighting a category of service provided. In some embodiments, the business traits may include hours the business operates.

In some embodiments, assessing identified businesses may involve, for example, using merchant category codes. The identified businesses may be assigned the merchant category code corresponding to the goods and services the identified business provides, and the business’s merchant category code may fall into a range of merchant category codes, where the range of merchant category codes spans all businesses providing goods and services that fall into the category. In some embodiments, the category may be a sub-category such that a range of merchant category codes may correspond to a sub-category, and several ranges of merchant category codes may fall into a single category. The identified business may then be assigned a merchant category code that falls into a sub-category when then falls into a category. The identified business may be confirmed as having the business trait related to the sub-category or the category the identified business’s merchant category code falls into. In one example, the identified business may be Airline A, which may have a merchant category code of 4014. Merchant category code 4014, where the range of merchant category codes 4011-4025 falls into the sub-category of air travel, which may fall into the category of transportation. Airline A may then be confirmed as having the business trait of air travel. In some embodiments, the business trait may be the same as the category or sub-category, and in other embodiments, the business trait may be different than the category or sub-category.

Method 2300 may include a step 2306 of matching, by a machine learning model executed by the at least one processor, the identified business to the user data based on the user trait and the business trait. The machine learning model may be trained, using historical user trait and business trait pairs, to match the business trait with the user trait.

In some embodiments, the machine learning model may be trained from historical user traits and historical business traits to determine if the user trait matches the business trait. The machine learning model may be shown exemplary user traits and business traits and where there is a match. One example may include that the user trait is air traveler, the business trait is air travel, and the traits match. Another example may include that the user trait is fashionista, the business trait is dining, and the traits do not match. Another example may include that the user trait is sports fan, the business trait is ticket provider, and the traits do match.

The machine learning model may learn from the examples and may further be trained by being shown user traits and business traits and determining if the traits match. In some embodiments, the machine learning model may match the identified business to the user data by identifying a commonality between the business trait and the user trait, where the commonality may be updated continuously. For each pair of traits, the machine learning model may determine if the traits match, and the determination may then be confirmed or corrected until the machine learning model is able to make accurate determinations a threshold amount of the time. For example, the machine learning model may be shown that the user trait is amateur cook, and the business trait is kitchen supplier. The machine learning model may determine that the traits match and may be informed its determination was correct and continue training. In another example, the machine learning model may be shown that the user trait is technology enthusiast, and the business trait may be electrical utilities. The machine learning model may determine that the traits do not match and may be informed its determination was correct and continue training. In determining whether a match exists, the machine learning model may use a combination of the training, keyword matching, or merchant product codes.

Method 2300 may include a step 2307 of predicting the business the user is likely to interact with based on the match. In some embodiments, the prediction may be based on user data, such as transaction data, and business data, such as the user’s records held by a business. Predicting what businesses the user is likely to interact with may involve recognizing that the user having the user trait that matches the business trait of the business does not necessarily mean the user will be interested in or likely to interact with the business. The prediction may involve examining the transaction history and business data of the businesses in the institution network. For example, the examination may reveal that the user has the user trait of air traveler and the business has the business trait of air travel. Here, the user trait and business trait may match, and Airline B and Airline C may be in the institution network. From the user data, it may be determined that the user usually purchases flights from Airline A. The flights are direct flights from City A to City Z. From the business data of Airline B and Airline C, it may be determined that Airline B offers direct flights from City A to City Z, but Airline C does not fly from City A to City Z. Thus, examination of the user data and business data may lead to a prediction that the user may be likely to interact with Airline B but will not likely interact with Airline C. Method 2300 may include a step 2308 of generating a message based on the match, the message promoting the business to the user. In some embodiments, the message may include a coupon for the business in the institution network having the business trait matching the user trait. In another embodiment, the message may include an advertisement for the business in the institution network having the business trait matching the user trait. Method 2300 may include a step 2309 of delivering the message to a user device associated with the user data.

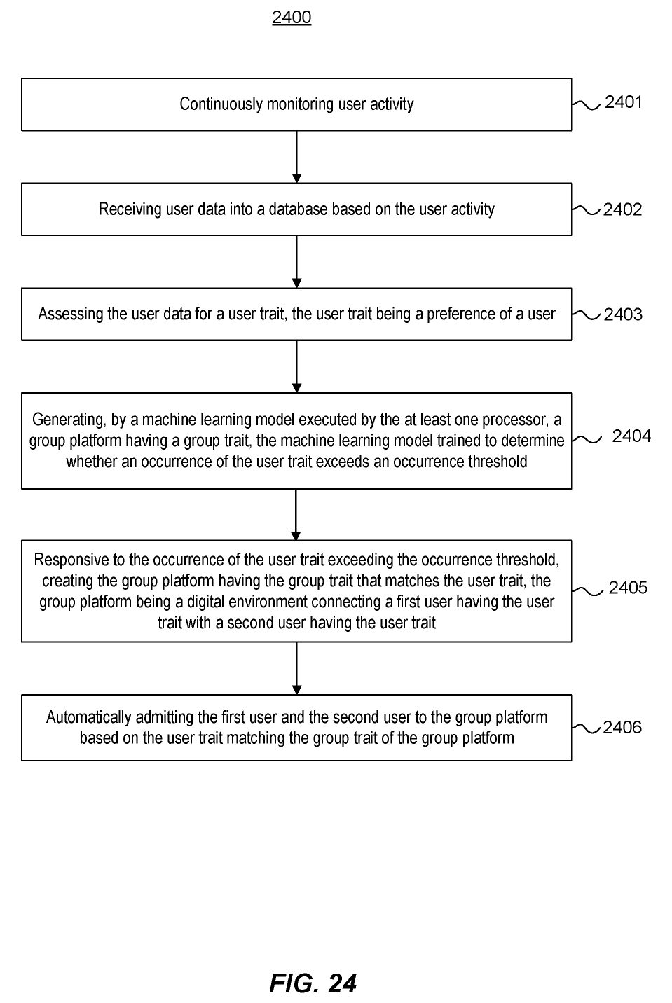

FIG. 24 depicts a flow chart for a method of grouping like-users. Some embodiments pertain to organizing users into groups based on their similarities, such as interests and location, to learn how the groups operate and what the groups do and do not do. Such embodiments may involve a computer system, for example, at a bank or institution, that organizes users into groups based on their similarities, such as interests and location, to learn how the groups operate and what the groups do and do not do. Method 2400 may include a step 2401 of continuously monitoring user activity. Method 2400 may include a step 2402 of receiving user data into a database based on the user activity.

Method 2400 may include a step 2403 of assessing the user data for a user trait, the user trait being a preference of a user. In some embodiments, the user data may be assessed for user traits by examining the user’s transaction history. Each transaction may be received and classified based on the goods and services provided by the merchant. In such an embodiment, transactions may be classified using merchant category codes.

In some embodiments, the user trait may be confirmed after the user makes a threshold number of purchases falling into the category or sub-category within a predetermined period of time. In some embodiments, the predetermined period of time may be different for each category of sub-category based on how often an average user purchased goods of services from each category or subcategory. For example, the category of transportation may have another sub-category called air travel, spanning merchant category codes 4011-4025. The user may make four purchases from merchants that fall into the air travel sub-category within a six month period. The threshold number of purchases and predetermined period of time for the air travel sub-category may be three purchases in a six month period. The user may then be confirmed as having the user trait of air traveler. In some embodiments, the user trait may be the same as the category or sub-category. In other embodiments, the user trait may be similar to the category or sub-category, such as with air traveler, or may be different than the category or sub-category.

In other embodiments, the user trait may be confirmed from other user data, such as a user’s choice of credit card. For example, the user may apply for a credit card that has benefits that reward travel above all other purchases. For example, the credit card may reward the user with fifteen points per dollar spent on travel bookings, including air travel bookings, such as flights. In another example, the credit card may reward the user with 8% cash back on travel related purchases. The user may be confirmed as having the user trait of traveler based on their choice of credit card. In other embodiments, the user trait may be more specific to the user’s interests. For example, in some embodiments, the user may be confirmed as having a user trait of sports fan, but the user may more specifically be confirmed as having the user trait of Football Team T fan based on location or transaction history.

Method 2400 may include a step 2404 of generating, by a machine learning model executed by the at least one processor, a group platform having a group trait. The machine learning model may be trained to determine whether an occurrence of the user trait exceeds an occurrence threshold. Group platform, as described herein, may refer to a platform for facilitating conversation and events between users who have joined based on a common interest, which may be a group trait. Group trait, as described herein, may refer to a characteristic shared by a several of users which may be the foundation for the creation of a group to bring like-users together. Group traits may be related to or include, for example, a spending habit based on a similar spending preference of users admitted to the group. The spending habit may involve, for example, what the user spends money on, how much money the user spends in a period of time, where the user spends their money, or when the user spends their money. In another embodiment, the group trait may include a saving habit based on based on a similar saving goal of users admitted to the group. The saving goal may involve a reason for saving how much the user saved during a period of time, or an interest in learning advice about saving. In another embodiment, the group trait may include a travel habit based on a similar travel preference of users admitted to the group. In another embodiment, the group trait may include a user location based on a proximity of a user address of each user admitted to the group. In another embodiment, the group trait may include an interest of a user. In some embodiments, the group trait may be a user trait. Occurrence threshold, as described herein, may be a threshold number of users having the user trait, where the threshold number of user’s must be exceeded for a group to be formed around the user trait, the user trait then becoming the group trait. In some embodiments, the occurrence threshold may be specific to a location. For example, the baseball team in City B may be Baseball Team H. The user trait of Baseball Team H fan may have an occurrence threshold of fifty thousand where only users having the user trait of Baseball Team H fan that reside in City B count towards the occurrence threshold.

In some embodiments, the machine learning model may be trained from user data, including user traits and the occurrence of user traits, where the occurrence of user traits is equal to a number users assessed to have the user trait, and whether the occurrence of the user trait exceeds an occurrence threshold and a group platform should be generated. One example may include that the user trait is Football Team T fan, the occurrence threshold for Town T is 10,000, and the occurrence of the user trait of Football Team T fan in Town T is 16,457, so the occurrence exceeds the occurrence threshold, and the group platform should be generated. Another example may include that the user trait is playing card collector, the occurrence threshold is 2000, and the occurrence of the user trait of playing card collector is 1,923, so the occurrence does not exceed the occurrence threshold, and the group platform should not be generated.

The machine learning model may learn from the examples and may further be trained by receiving the user trait, the occurrence threshold, and the occurrence of the user trait, and determining if the occurrence exceeds the occurrence threshold and whether the group platform should be generated. For each set of received information, the machine learning model may determine if the occurrence exceeds the occurrence threshold and whether the group platform should be generated. The determination may then be confirmed or corrected until the machine learning model is able to make accurate determinations a threshold amount of the time.

For example, the machine learning model may be shown that the user trait is model airplane hobbyist, the occurrence threshold is 800, and the occurrence of the user trait of playing card collector is 800. The machine learning model may determine that the occurrence of the user trait matches the occurrence threshold so the group platform should be generated. The machine learning model may be informed its determination was incorrect and that while the occurrence of the user trait matches the occurrence threshold, the occurrence does not exceed the occurrence threshold so the group platform should not be created. The machine learning model may then continue training. In another example, the machine learning model may be shown that the user trait is art enthusiast, the occurrence threshold for is 10,000, and the occurrence of the user trait of art enthusiast is 23,451, so the occurrence exceeds the occurrence threshold, and the group platform should be generated. The machine learning model may be informed its determination was correct and the machine learning model may continue training.

Method 2400 may include a step 2405 of, responsive to the occurrence of the user trait exceeding the occurrence threshold, creating the group platform having the group trait that matches the user trait, the group platform being a digital environment connecting a first user having the user trait with a second user having the user trait. In some embodiments, creation of the group platform may involve creating a digital environment with features, such as a message board, chatroom, and group feed, that may be accessible through a user’s account. Digital environment, as described herein, may refer to a virtual space that enables communication, transactions, and content exchange between users. In some embodiments, the group platform may include a focus group based on the user trait. For example, the group trait may be languages, and the user may have the user trait of an ability to communicate in Spanish. The group platform centered on languages may have a focus group that centers on Spanish.

Method 2400 may include a step 2406 of automatically admitting the first user and the second user to the group platform based on the user trait matching the group trait of the group platform. In some embodiments, users having the user trait that contributed to exceeding the occurrence threshold or, after creation of the group, users having the user trait that matches the group trait, may be automatically admitted to the group platform. In some embodiments, the first user and the second user may automatically receive a notification upon admission into the group platform. For example, the user may take several international trips each month. The user may then be confirmed as having a user trait of global traveler due to taking more than two international trips per month. Upon confirming that the user has the user trait, the user trait may be added to a list of user traits on user’s account or the user’s profile, or the user may be added to a record of users having the user trait of global traveler. Upon the user trait of global traveler appearing in the user’s profile, or upon the user’s name appearing in the record of users having the user trait of global traveler, the user may be admitted to a group platform for global travelers. In other embodiments, admission to the group platform may not be automatic. On some embodiments, upon the user trait of global traveler appearing in the user’s profile, or upon the user’s name appearing in the record of users having the user trait of global traveler, the user may be notified of their new user trait and encouraged to join the group platform for global travelers. The user may be notified by, for example, email, text message, phone call, or push notification, and the notice may include an incentive, such as a coupon.

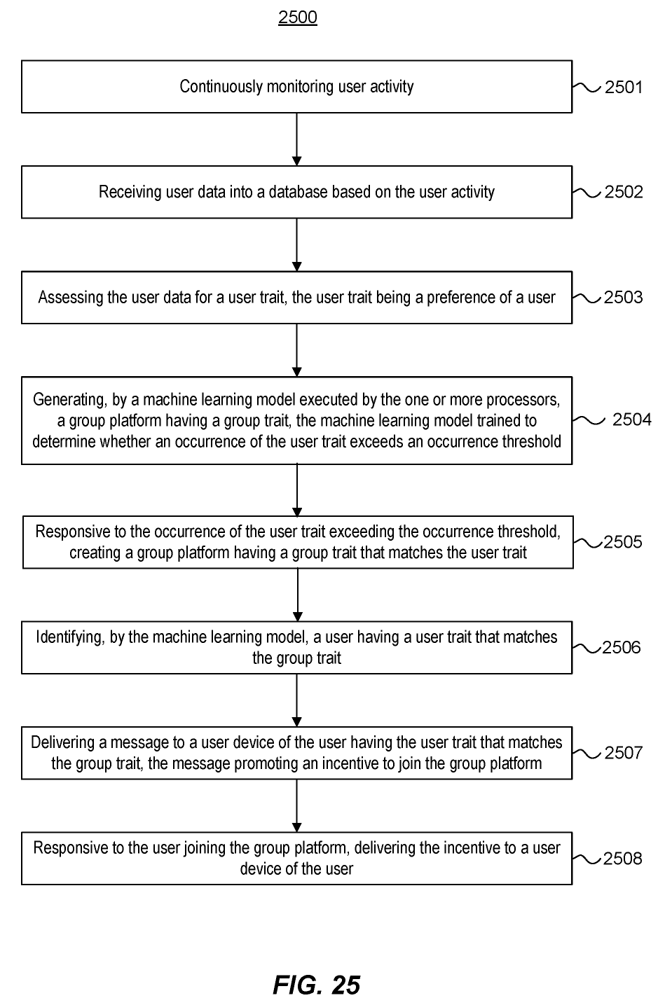

FIG. 25 depicts a flow chart for a method of incentivizing group participation. Some embodiments pertain to incentivizing users to join groups by offering exclusive, relevant offers rewards to those in a group. Such embodiments may involve a computer system, for example, at a bank or institution, that incentivizes users to join groups by offering exclusive, relevant offers rewards to those in a group. Method 2500 may include a step 2501 of continuously monitoring user activity. Method 2500 may include a step 2502 of receiving user data into a database based on the user activity.

Method 2500 may include a step 2503 of assessing the user data for a user trait, the user trait being a preference of a user.

Method 2500 may include a step 2504 of generating, by a machine learning model executed by the at least one processor, a group platform having a group trait. The machine learning model may be trained to determine whether an occurrence of the user trait exceeds an occurrence threshold.

Method 2500 may include a step 2505 of responsive to the occurrence of the user trait exceeding the occurrence threshold, creating a group platform having a group trait that matches the user trait.

Method 2500 may include a step 2506 of identifying, by the machine learning model, a user having a user trait that matches the group trait. In some embodiments, the machine learning model may be trained from user traits, the group traits, and whether the user trait and group trait match. One example may include that the user trait is Football Team T fan and the group trait is sports fans, so the user trait and the group trait match. Another example may include that the user trait is amateur painter and the group trait is sculpture, so the user trait and the group trait do not match. Thus, the machine learning may be trained that while some user traits and group traits may be similar in that they both fall into a larger, overarching category, the user trait and group trait themselves may not be a match.

The machine learning model may learn from the examples and may further be trained by the user trait and the group trait and determining whether there is a match. The determination may then be confirmed or corrected until the machine learning model is able to make accurate determinations a threshold amount of the time.

For example, the machine learning model may be told there is a group having the grout trait of martial arts and the user may have a user trait of Taekwondo instructor. The machine learning model may determine there is a match, may be informed its determination was correct, and may then continue training. In another example, the machine learning model may be told the group has a group trait of baking and the user has a user trait of cooking. The machine learning model may recognize that, while the user trait and the group trait are similar, there is not a match. The machine learning model may be informed its determination was correct and the machine learning model may continue training.

Method 2500 may include a step 2507 of delivering a message to a user device of the user having the user trait that matches the group trait, the message promoting an incentive to join the group platform. Method 2500 may include a step 2508 of responsive to the user joining the group platform, delivering the incentive to a user device of the user. In some embodiments, the incentive may be a discount code related to the group trait. In another embodiment, the incentive may be a discount code related to the user activity. In some embodiments, the incentive may expire after a period of time.

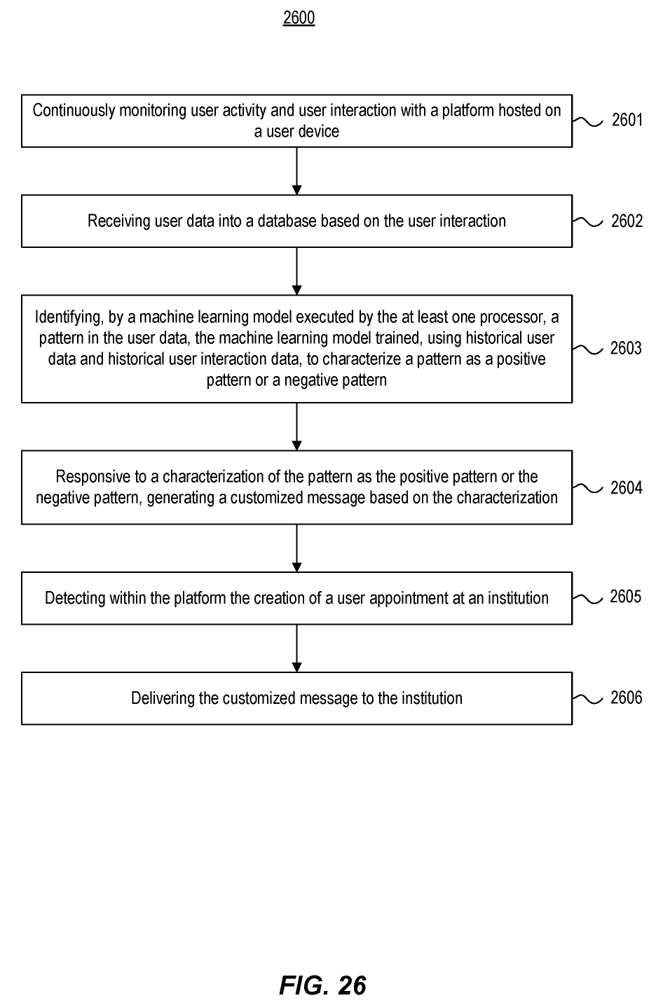

FIG. 26 depicts a flow chart for a method of notifying an institution of user needs. Some embodiments pertain to communicating with computing devices at an institution, such as a bank, to prompt employees, such as bank tellers, to deliver personalized content to users in person. Such embodiments may involve a computer system, for example, at a bank or institution, that communicates with computing devices at an institution to prompt employees to deliver personalized content to users in person.

Method 2600 may include a step 2601 of continuously monitoring user activity and user interaction with a platform hosted on a user device. Method 2600 may include a step 2602 of receiving user data into a database based on the user interaction. In some embodiments, the user data may include a time and a frequency at which the system monitoring the user interaction detects the user accessing the platform. Each time the user accesses the platform, the date and time may be recorded in a log. For example, the user data may include that the user accesses the platform on average three times per week. In another embodiment, the user data may include the time and frequency at which the user interacts with personalized content. For example, user interaction data may include information that the user interacted with personalized content four times during a week, the user spent an average of four minutes interacting with the personalized content per interaction, and the user interacted with the personalized content via user device.

Method 2600 may include a step 2603 of identifying, by a machine learning model executed by the at least one processor, a pattern in the user data. The machine learning model may be trained, using historical user data and historical user interaction data, to characterize the pattern as a positive pattern or a negative pattern.

In some embodiments, the machine learning model may be trained from historical user data or historical user interaction data to characterize the pattern as a positive pattern or a negative pattern. The machine learning model may be trained that a couple instances of an event or an action is not a pattern but that a threshold number of occurrences of an event or an action within a period of time is a pattern. The machine learning model may also be trained that patterns involving events or actions impacting account health or financial health may be characterized as positive or negative. More specifically, the machine learning model may be trained that a pattern of taking actions of a certain type may be a positive pattern, such as a user logging into and interacting with their account, but a pattern of failing to take such actions may be a negative pattern. The machine learning model may also be trained that a pattern of taking actions at a certain time may be a positive pattern, such as the user paying a bill on time, but a pattern of failing to take such actions at a certain time, such as paying a bill after it is due, may be a negative pattern.

The machine learning model may learn from the examples and may further be trained by receiving user activity and interaction data and determining whether a pattern exists and characterizing the pattern as a positive pattern or a negative pattern. For each set of data, the machine learning model may determine whether a pattern exists and how it should be characterized, which may then be confirmed or corrected until the machine learning model is able to make accurate determinations a threshold amount of the time. For example, the machine learning model may receive user activity data including that the user receives their monthly credit card statement on the tenth day of every month and makes the full payment on the statement on the eleventh day of every month. The machine learning model may identify a pattern of timely payments by the user and may categorize the pattern as a positive pattern. The machine learning model may be informed its determination was correct and continue assessing user activities.

During operation, the machine learning model may be configured to accept specific inputs. For example, the machine learning model may receive user activity data from an institution wishing to generate personalized content to send to the user. The institution may wish to provide the user with a warning, kudos, resources, or a suggestion based on the pattern and characterization. The machine learning model may output the identified pattern and characterization which may be used by the personalized content system to generate personalized content for a particular user.

Method 2600 may include a step 2604 of responsive to a characterization of a pattern as the positive pattern or the negative pattern, generating a customized message based on the characterization. In some embodiments, a message may be a positive message or may be a negative message. The positive message, as described herein, may, for example, be congratulatory or a kudos, may include a discount or coupon, may be encouraging or thankful, or may be otherwise positive in nature. A negative message, as described herein, may, for example, include a flag or warning, may include a penalty, may include recommendations or advice for improvement, or may be otherwise negative in nature. In some embodiments, the message may include an advertisement. In some embodiments, the pattern being characterized as the positive pattern prompts generation of a positive message. In other embodiments, the pattern being characterized as the negative pattern prompts generation of a negative message. In some embodiments, a timer may activate upon generation of the customized message. The time may be an indicator for how much time has passed since generation of the message.

Method 2600 may include a step 2605 of detecting within the platform the creation of a user appointment at an institution. In some embodiments, the platform may be a user application, such as on a mobile device. In some embodiments, the timer may reset upon detecting the creation of the user appointment. Method 2600 may include a step 2606 of delivering the customized message to the institution. In some embodiments, the customized message may be delivered to the user device upon a timer value of the timer exceeding a time limit. In some embodiments, the customized message may be delivered via email to ensure security of contents of the message. In some embodiments, the customized message may include tailored advice to an employee of the institution or the user.

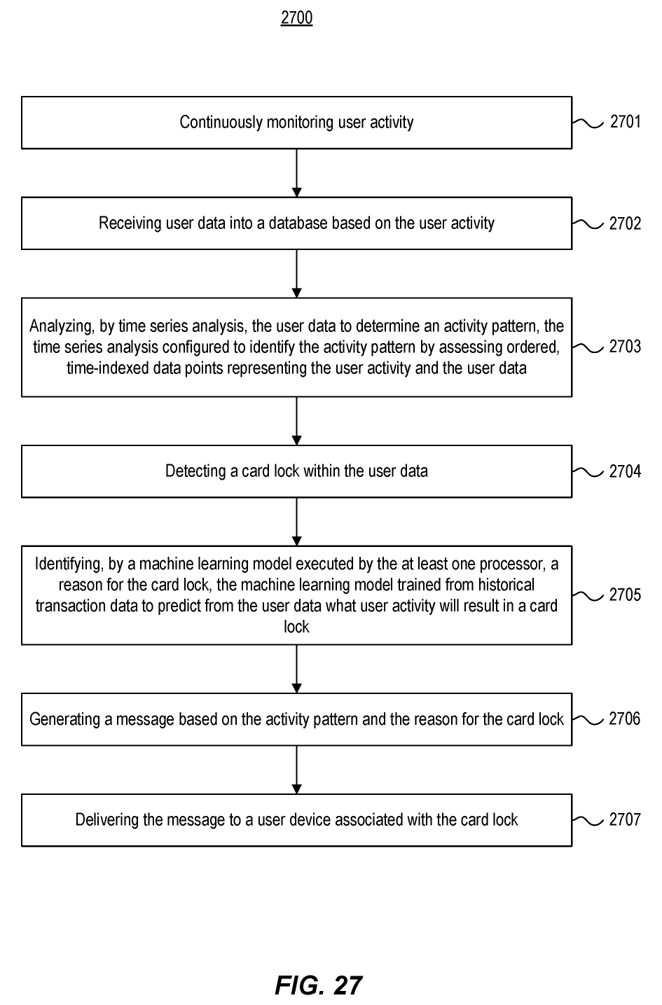

FIG. 27 depicts a flow chart for a method of providing personalized card lock content. Some embodiments pertain to detecting a travel lock or other credit card lock and delivering personalized content based on the reason for the lock. Such embodiments may involve a computer system, for example, at a bank or institution, that detects a travel lock or other credit card lock and delivers personalized content based on the reason for the lock. Method 2700 may include a step 2701 of continuously monitoring user activity. In some embodiments, the user activity may include a user location based on a location of a user device. Method 2700 may include a step 2702 of receiving user data into a database based on the user activity.

Method 2700 may include a step 2703 of analyzing, by time series analysis, the user data to determine an activity pattern, the time series analysis configured to identify the activity pattern by assessing ordered, time-indexed data points representing the user activity and the user data. In some embodiments, the activity pattern may include a location pattern. The location pattern may highlight a movement preference of a user and may involve a log of previous locations for a period of time. In another embodiment, the activity pattern may include a spending pattern. The spending pattern may highlight a transaction preference of a user and may include a log of attempted payments.

In some embodiments, the time series analysis may evaluate various types of user data against time. In some embodiments, the time series analysis may evaluate an account balance against time. In another embodiment, the time series analysis may evaluate a total number of transactions against time. In another embodiment, the time series analysis may evaluate a number of transactions falling into a category of user activity against time.

In one example, the number of transactions the user used a credit card for may be analyzed with respect to time to determine an activity pattern. In analyzing the number of transactions where the user used a credit card over time, it may be determined that the user used Credit Card A consistently for the past several months and then stopped using Credit Card A halfway through the last month. It may be determined that transactions for which the user used Credit Card B started around the time the user stopped using credit card A. In another example, it may be determined that the user consistently uses a credit card to book international travel and accommodations but only minimally uses their credit card once they arrive at their destination. The analysis may reveal activity patterns, such as the user’s credit card use patterns, including that the user may have gotten a new card with better benefits but wishes to hold onto a previous card for credit score purposes. The analysis may reveal that the user does only sparingly uses their credit card while traveling abroad and prefers to use cash.

Method 2700 may include a step 2704 of detecting a card lock within the user data. A card lock, as described herein, may refer to a temporary security feature that disables the credit card from making new purchases, cash advances, or balance transfers. The card lock may protect against unauthorized charges if a card is lost or stolen but may allow recurring payments to continue. In other embodiments, a card lock may include a travel lock where the user temporarily disabled a card while traveling to prevent new transactions. In some embodiments, the user may activate or deactivate the card lock from a user account or mobile application. In some embodiments, a processor may be configured to determine a location of the user device at a time of the card lock.

Method 2700 may include a step 2705 of identifying, by a machine learning model executed by the at least one processor, a reason for the card lock. The machine learning model may be trained from historical transaction data to predict from the user data what user activity will result in a card lock.

In some embodiments, the machine learning model may be trained from historical user data, such as transaction data, to identify the reason for the card lock. The machine learning model may be trained that there may be various reasons for a card lock and that some user activity may result in a card lock while some similar user activity may not result in a card lock. The machine learning model may be shown exemplary user data and whether the user activity will result in the user activating the card lock. One example may include that the user prefers to use cash whenever possible traveling internationally, so when the user arrives at their destination their credit card transactions often cease. In case of loss or theft, as a preventative measure, the user activates a credit card lock while traveling internationally and deactivates the credit card lock only when necessary until the user returns from their travels. Thus, the machine learning model may be trained that international travel will generally result in the user activating the credit card lock.

In another example, the machine learning model may be told that the user also travels domestically on occasion, including traveling to Hometown H. The machine learning model may be trained that, similar to the user’s international travel, when the user arrives in Hometown H the user’s credit card transactions nearly cease; however, the user does not activate a credit card lock. Thus, the machine learning model may be trained that travel itself may not result in a credit card lock and decreases in credit card transactions may not necessarily result in a credit card lock. In another example, the machine learning model may be trained that the user used Credit Card A, the user’s first credit card, consistently during the past several years, but last month the user stopped using Credit Card A and began using Credit Card B. Credit Card B has better benefits, and the user now exclusively uses Credit Card B. The machine learning model may be trained that the user’s credit is tied to their credit card, so the user ceasing use of Credit Card A to begin use of Credit Card B may be likely to activate a credit card lock of Credit Card A rather than canceling the card, even if the user does not plan to user Credit Card A again.

The machine learning model may learn from the examples and may further be trained by receiving user data and determining whether the user activity is likely to result in a credit card lock. For each set of user data, the machine learning model may determine whether the user activity is likely to result in a credit card lock, which may then be confirmed or corrected until the machine learning model is able to make accurate determinations a threshold amount of the time. For example, the machine learning model may receive user data including that the user traveled domestically from their residence in City A to City B. The machine learning model may determine that the user activity of traveling domestically from City A to City B is likely to result in the user activating a credit card lock. The machine learning model may be informed its determination was incorrect and told the correct determination is that the user activity of traveling domestically is unlikely to result in the user activating the card lock. The machine learning model may then continue assessing user activities.

In another example, the machine learning model may receive user data including that the user, a long time user of Credit Card X, stopped using Credit Card X and began using Credit Card Y. The machine learning model may determine that the user activity of ceasing use of Credit Card X and commencing consistent use of Credit Card Y is likely to result in the user activating the credit card lock of Credit Card X. The machine learning model may be informed its determination was correct and continue assessing user activities.

During operation, the machine learning model may be configured to accept specific inputs. For example, the machine learning model may receive user data, including credit card transaction data and location data. The institution may wish to provide the user with personalized content related to the credit card lock. The machine learning model may output whether a lock is likely and the reason for the lock, which may then be used by the personalized content system to generate personalized content for the user.

Method 2700 may include a step 2706 of generating a message based on the activity pattern and the reason for the card lock. In some embodiments, the message may be based on the location of the user at the time of the card lock. Method 2700 may include a step 2707 of delivering the message to a user device associated with the card lock. In some embodiments, the message may be delivered via push notification when the message includes time-sensitive content. In other embodiments, the message may be delivered via email to ensure security of contents of the message. In some embodiments, time-sensitive content may include limited-time offers, warnings, or recommendations for a current location or time of day.

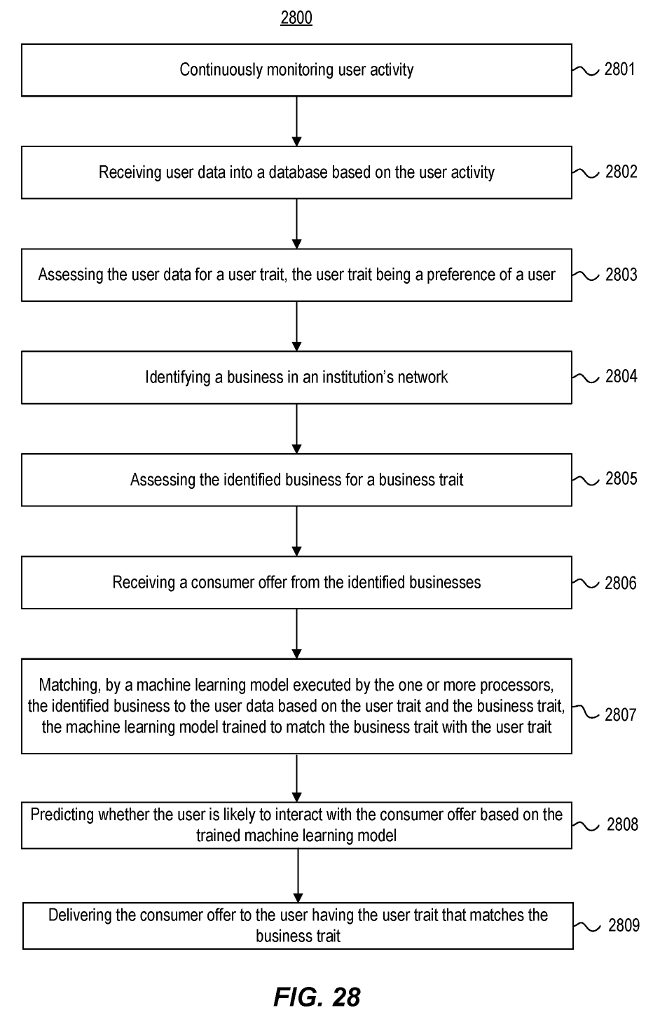

FIG. 28 depicts a flow chart for a method of providing in-network businesses’ offers. Some embodiments pertain to pushing offers for businesses in an institution network to institution users and employees. Such embodiments may involve a computer system, for example, at a bank or institution, that pushes offers for businesses in an institution network to institution users and employees. Method 2800 may include a step 2801 of continuously monitoring user activity. In some embodiments, the user activity may include a user location. Method 2800 may include a step 2802 of receiving user data into a database based on the user activity.

Method 2800 may include a step 2803 of assessing the user data for a user trait, the user trait being a preference of a user. User traits, as described herein, may refer to characteristics that describe a user, such as those involving demographic data, behavioral data, psychological data. In some embodiments, user traits may include spending habits, travel habits, user location, or interests. In some embodiments, the user data may be assessed for user traits by examining the user’s transaction history. Each transaction may be received and classified based on the goods and services provided by the merchant. In such an embodiment, transactions may be classified using merchant category codes. In some embodiments, the user trait may be the same as the category or sub-category. In other embodiments, the user trait may be similar to the category or sub-category, such as with air traveler, or may be different than the category or sub-category.

In other embodiments, the user trait may be confirmed from other user data, such as a user’s choice of credit card. For example, the user may apply for a credit card that has benefits that reward travel above all other purchases. For example, the credit card may reward the user with fifteen points per dollar spent on travel bookings, including air travel bookings, such as flights. In another example, the credit card may reward the user with 8% cash back on travel related purchases. The user may be confirmed as having the user trait of traveler based on their choice of credit card.

Method 2800 may include a step 2804 of identifying a business in an institution network. Method 2800 may include a step 2805 of assessing the identified business for a business trait. In some embodiments, the business trait may be the same as the category or sub-category, and in other embodiments, the business trait may be different than the category or sub-category.

Method 2800 may include a step 2806 of receiving a consumer offer from the identified businesses. Consumer offers, as described herein, may refer to incentives to attempt to bring in more business. Consumer offers may include, for example, advertisements, coupons, or discount codes. In some embodiments, the identified businesses may wish to market and promote their business. They may generate a variety of marketing materials, such as personalized content, consumer offers, coupons, discounts, or sale promotions. In some embodiments, consumer offers or other materials from the identified business may be received to determine the best users to deliver the offers to.

Method 2800 may include a step 2807 of matching, by a machine learning model executed by the at least one processor, the identified business to the user data based on the user trait and the business trait. The machine learning model may be trained to match the business trait with the user trait. In some embodiments, the machine learning model may be trained from user traits and business traits to determine if the user trait matches the business trait. The machine learning model may be shown exemplary user traits and business traits and where there is a match. One example may include that the user trait is air traveler, the business trait is air travel, and the traits match. Another example may include that the user trait is fashionista, the business trait is dining, and the traits do not match. Another example may include that the user trait is sports fan, the business trait is ticket provider, and the traits do match.

The machine learning model may learn from the examples and may further be trained by being shown user traits and business traits and determining if the traits match. In some embodiments, the machine learning model may match the identified business to the user data by identifying a commonality between the business trait and the user trait, where the commonality may be updated continuously. For each pair of traits, the machine learning model may determine if the traits match, and the determination may then be confirmed or corrected until the machine learning model is able to make accurate determinations a threshold amount of the time. For example, the machine learning model may be shown that the user trait is amateur cook, and the business trait is kitchen supplier. The machine learning model may determine that the traits match and may be informed its determination was correct and continue training. In another example, the machine learning model may be shown that the user trait is technology enthusiast, and the business trait may be electrical utilities. The machine learning model may determine that the traits do not match and may be informed its determination was correct and continue training. In determining whether a match exists, the machine learning model may use a combination of the training, keyword matching, or merchant product codes.

Method 2800 may include a step 2808 of predicting whether the user is likely to interact with the consumer offer based on the trained machine learning model.

In some embodiments, the prediction may be based on user data, such as transaction data, and business data, such as the user’s records held by a business. Predicting whether the user is likely to interact with the consumer offer may involve recognizing that the user having a user trait that matches the business trait of a business does not necessarily mean the user will be interested in or likely to interact with the consumer offer. The prediction may involve examining the transaction history and business data of the businesses in the institution network. For example, the examination may reveal that the user has the user trait of air traveler and the business has the business trait of air travel. Here, the user trait and business trait may match, and Airline B and Airline C may be in the institution network. From the user data, it may be determined that the user usually purchases flights from Airline A. The flights are direct flights from City A to City Z. From the business data of Airline B and Airline C, it may be determined that Airline B offers direct flights from City A to City Z, but Airline C does not fly from City A to City Z. Thus, examination of the user data and business data may lead to a prediction that the user may be likely to interact with consumer offers from Airline B but will not likely interact with consumer offers from Airline C.

Method 2800 may include a step 2809 of delivering the consumer offer to the user having the user trait that matches the business trait. In some embodiments, the consumer offer may be delivered to the user even if the user does not have the user trait that matches the business trait. The consumer offer may be delivered in a variety of ways including, for example, text message, phone call, email, or push notification.

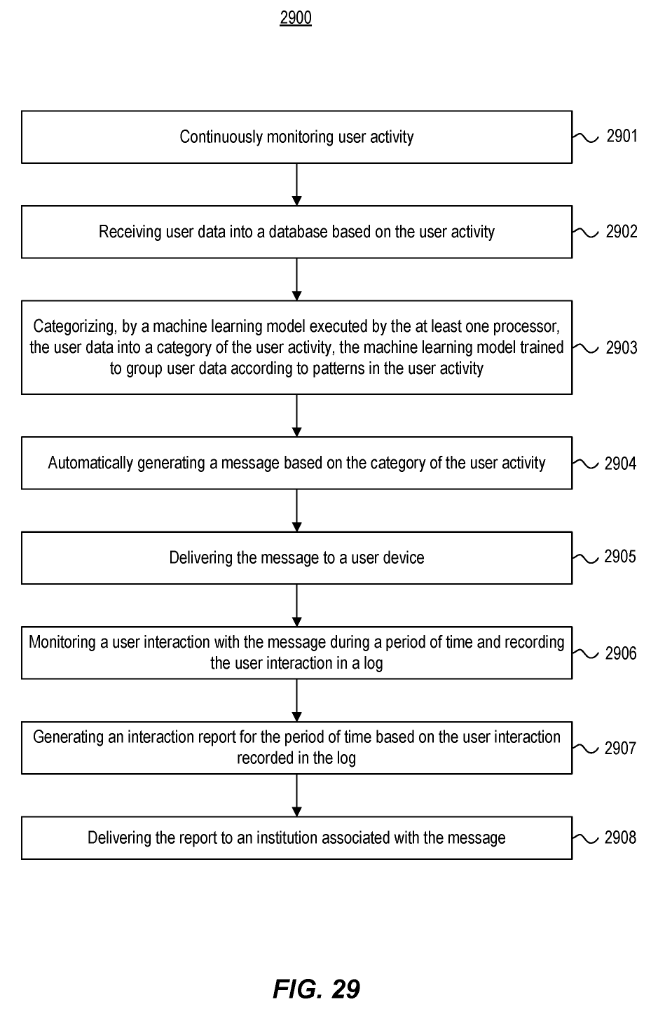

FIG. 29 depicts a flow chart for a method of redemption reporting. Some embodiments pertain to generating reports from offer redemption data for institutions’ in-network businesses to provide business-side feedback. Such embodiments may involve a computer system, for example, at a bank or institution, that generates reports from offer redemption data for institutions’ in-network businesses to provide business-side feedback.

Method 2900 may include a step 2901 of continuously monitoring user activity. Method 2900 may include a step 2902 of receiving user data into a database based on the user activity.

Method 2900 may include a step 2903 of categorizing, by a machine learning model executed by the at least one processor, the user data into a category of the user activity. The machine learning model may be trained to group user data according to patterns in the user activity.

Method 2900 may include a step 2904 of automatically generating a message based on the category of the user activity. In some embodiments, the message may include a coupon, promotion, advertisement, each for a business related to the category of user activity. For example, a message may be generated to promote the start of a new bowling league at Bowling Alley B. In another example, the message may include coupons to a local haberdashery. Method 2900 may include a step 2905 of delivering the message to a user device.

Method 2900 may include a step 2906 of monitoring a user interaction with the message during a period of time and recording the user interaction in a log. In some embodiments, user interaction may refer to a user engaging with the message by, for example, clicking on, tapping on, or swiping the message. In some embodiments, the user interaction may include a length of user engagement or a frequency of user engagement, where a length of user engagement may refer to how long a user engaged with a message and a frequency of user engagement may refer to how many times the user engaged with the message.

The user interaction with the message may be monitored, for example, by use of tracking pixels. In some embodiments, the message may be an email. Tracking pixels may be embedded in an email. An institution may insert a pixel image tag into the HTML code of the email. Pixel image tag, as described herein, may be a 1x1 pixel, transparent graphic embedded in an email or website to track user interaction. The user may open the email, which may cause the email client to fetch the image from a server. The server hosting the image may log the request and record the time, internet protocol (IP) address, and device information. The server may also record how long the email was opened for, how many times the email was reopened, and whether any linked within the email were clicked by the user.

Method 2900 may include a step 2907 of generating an interaction report for the period of time based on the user interaction recorded in the log. A report, as described herein, may refer to a formal or informal structured document, presenting factual information, analysis, or recommendations to aid in future decision making. In some embodiments, the report may have a predefined format. In some embodiments, the predefined format may be selected by an institution. The predefined format may be, for example, a spreadsheet or a memorandum. In some embodiments, the report may be automatically delivered upon the time period ending or upon generation of the report. The report may include the same or similar information to what is included in the log, such as whether the user opened the coupon, a time that the user opened the coupon, and whether the user redeemed the coupon. In some embodiments, the report may provide a recommendation to the institution to improve an interaction statistic. The interaction statistic may refer to a measure of how often or how long the user engages with the message. The recommendation may be, for example, to generate messages in a new way or to target a specific type of customer. For example, the recommendation may be that the messages are interacted with most by men in their twenties, so the institution should continue to send the same messages to men in their twenties or a similar demographic. Method 2900 may include a step 2908 of delivering the report to an institution associated with the message. In some embodiments, the report may be delivered by email to ensure security of contents of the report.

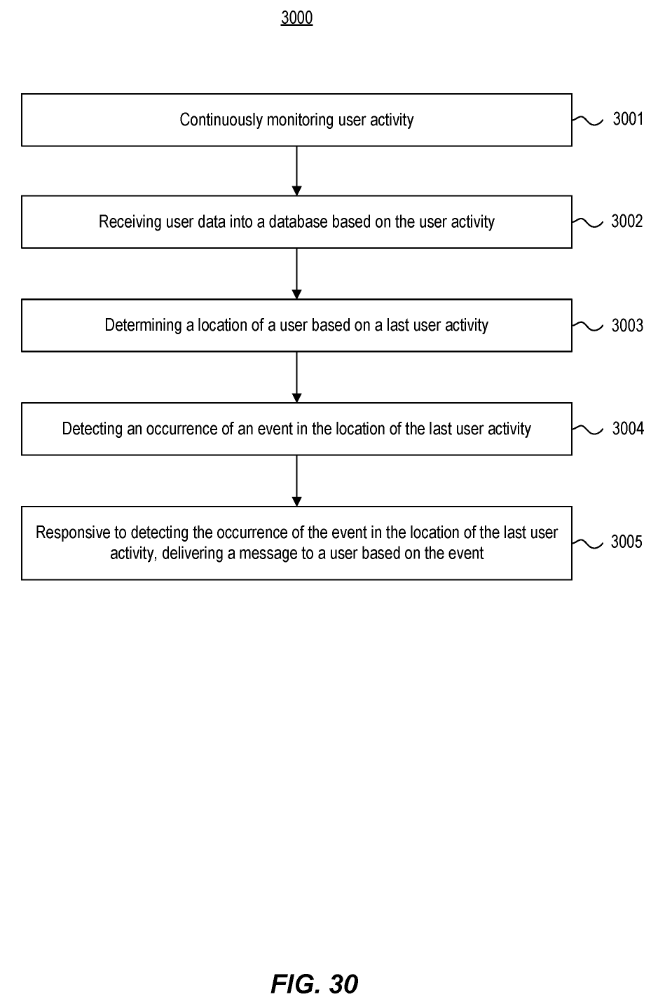

FIG. 30 depicts a flow chart for a method of making need-based assumptions. Some embodiments pertain to using location and demographic data to make need-based assumptions and generate recommended content and offerings. An offering may be an incentive, such as a coupon or discount. Such embodiments may involve a computer system, for example, at a bank or institution, that uses location and demographic data to make need-based assumptions and generate recommended content and offerings.

Method 3000 may include a step 3001 of continuously monitoring user activity. In some embodiments, the user activity may include a user location based on a location of a user device. Method 3000 may include a step 3002 of receiving user data into a database based on the user activity.

Method 3000 may include a step 3003 of determining a location of a user based on a last user activity. In some embodiments the last user activity may be determined from transaction data. The transaction data may include an identification number, timestamp, amount, and status, such as successful or failed. The transaction data may also include contextual information including merchant name, merchant type, or location. The location, as described herein, may refer to the location of the user at the time of the user activity, as indicated by the location of the user’s mobile device, or the location of a subject of the user activity at the time of the user activity. In some embodiments, the user activity may be the last user activity, which may refer to the user activity the user participated in most recently. In one example, the last user activity may be the user booking a hotel for a future trip. The location of the last user activity may be the location of the user at the time the user booked the hotel. In other embodiment, the location of the last user activity may be the location of the hotel.

Method 3000 may include a step 3004 of detecting an occurrence of an event in the location of the last user activity. In some embodiments, the event may be a natural disaster. For example, the user may live in City T and may go to pick up and pay for their prescription at the pharmacy in City T. The transaction data may then reveal that the location of the last user activity may be City T. City T may receive reports that a tornado formed nearby. The occurrence of the tornado may be detected in a variety of ways. The occurrence of the tornado may be detected by crowdsourced reports. Users in City T may be able to submit a report that they cited the tornado or heard from others or from the news that there is a tornado. In other embodiments, the news may be monitored directly by, for example, scanning digital news for keywords, like tornado. Upon detecting a keyword, the digital news may be further examined to confirm accuracy and timeliness. In other embodiments, the occurrence of the event may be a suspicion about the event. For example, it may only be detected that a tornado is likely to form near City T, and not that one has already formed.

Method 3000 may include a step 3005 of responsive to detecting the occurrence of the event in the location of the last user activity, delivering a message to a user based on the event. For example, upon detecting the present or future occurrence of the tornado in City T, a message may be delivered to the user to notify the user of the tornado and recommend the user seeks shelter. In some embodiments, the message may include a list of local resources. The local resources may include, for example, public buildings where the user may take shelter during the tornado or hotlines for finding loved ones or seeking disaster relief after the tornado passes. In another embodiment, the message may include an emergency preparedness plan. The emergency preparedness plan may include a plan for how the user can prepare for and stay safe during the event. In some embodiments, the message may be delivered via push notification when the message only includes a headline. In another embodiment, the message may be delivered via a phone call. In another embodiment, the message may be delivered via text message. In another embodiment, the message may be delivered via a high-priority bulletin when the message includes notice of imminent danger. For example, law enforcement may push an alert to all user devices within a distance from a location or all user devices of user that reside in an area. In another embodiment, the message may be delivered via email when the message contents are not time sensitive. In some embodiments, the message may be delivered automatically upon detecting the occurrence of the event.

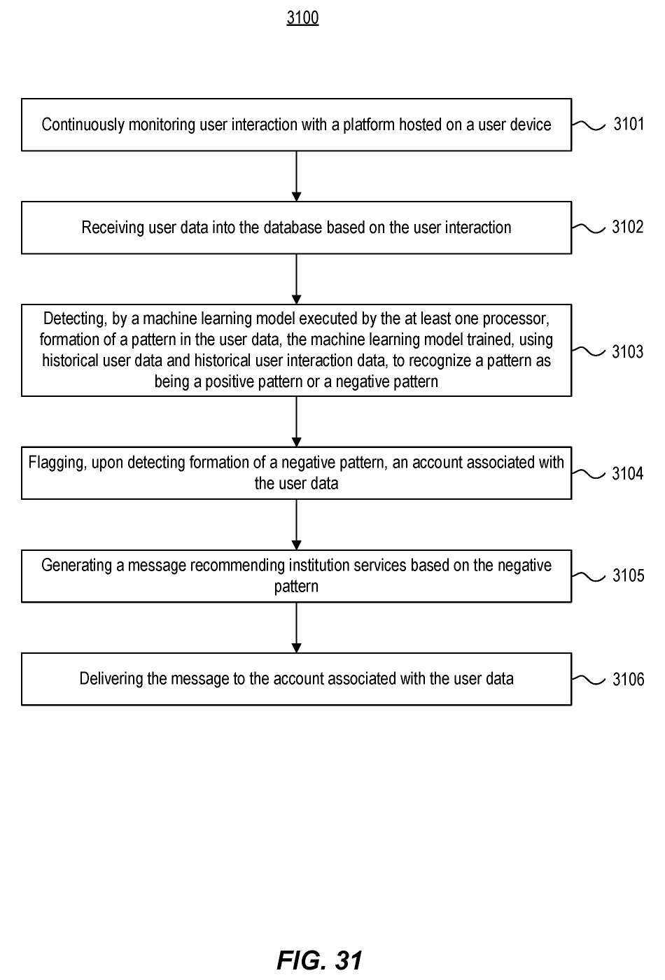

FIG. 31 depicts a flow chart for a method of recommending institution services. Some embodiments pertain to timely recommending institution services to a specific groups of users. Such embodiments may involve a computer system, for example, at a bank or institution, that timely recommends institution services to the specific groups of users.

Method 3100 may include a step 3101 of continuously monitoring user interaction with a platform hosted on a user device. In some embodiments, the platform may be part of a mobile application.

Method 3100 may include a step 3102 of receiving user data into the database based on the user interaction. In some embodiments, the user data may include a time and a frequency at which the system monitoring the user interaction detects the user accessing the platform. Each time the user accesses the platform, the date and time may be recorded in a log. For example, the user data may include that the user accesses the platform on average three times per week. In another embodiment, the user data may include the time and frequency at which the user interacts with personalized content. For example, user interaction data may include information that the user interacted with personalized content four times during a week, the user spent an average of four minutes interacting with the personalized content per interaction, and the user interacted with the personalized content via user device.

Method 3100 may include a step 3103 of detecting, by a machine learning model executed by the at least one processor, formation of a pattern in the user data. The machine learning model may be trained, using historical user data and historical user interaction data, to recognize the pattern as being a positive pattern or a negative pattern. In some embodiments, the machine learning model may be configured to forecast an outcome of one of either the positive pattern or the negative pattern.

The machine learning model may be trained that a small number of instances of an event or an action is not a pattern but that a threshold number of occurrences of an event or an action within a period of time is a pattern. In another embodiment, the machine learning model may be trained that while the first instance of the event or action, or even the first few instances of the event or action, is not a pattern, the first instance or first couple instances of a pattern may indicate the start of the formation of a pattern. In such an embodiment, each successive instance of the event or action may be further indicative of a pattern. The machine learning model may also be trained that patterns involving events or actions impacting account health or financial health may be characterized as positive or negative. More specifically, the machine learning model may be trained that a pattern of taking actions of a certain type may be a positive pattern, such as a user logging into and interacting with their account, but a pattern of failing to take such actions may be a negative pattern. The machine learning model may also be trained that a pattern of taking actions at a certain time may be a positive pattern, such as the user paying a bill on time, but a pattern of failing to take such actions at a certain time, such as paying a bill after it is due, may be a negative pattern.

The machine learning model may be shown exemplary user activity or interaction data and whether a pattern exists. For example, such examples may include that the user has paid their credit card between one to four days after the due date for each of the last six months, except for three months ago, where the user paid the bill one week before the due date. The machine learning model may be trained that, despite the single early payment, the data indicates a pattern of late payments, and since the pattern involves actions harmful to the user’s financial health, it is a negative pattern. The machine learning model may be further trained that the pattern of late payments were not concrete after the first instance of the late payment, but the formation of the pattern of late payment was detectable after the second instance of the late payment.

Another example may include that the user logs into and interacts with their account three times per month: once one week before the user’s credit card bill is due and once the day after each of the user’s pay days. The machine learning model may be trained that there is a pattern of the user frequently interacting with their account and finances, and that because the pattern involves an action beneficial to the user’s financial health, it is a positive pattern. In some embodiments, the machine learning model may be further trained that the pattern was detectable after one month of the user frequently interacting with their account.

The machine learning model may learn from the examples and may further be trained by receiving user activity and interaction data and determining whether a pattern exists and characterizing the pattern as a positive pattern or a negative pattern. For each set of data, the machine learning model may determine whether a pattern exists and how it should be characterized, which may then be confirmed or corrected until the machine learning model is able to make accurate determinations a threshold amount of the time. For example, the machine learning model may receive user activity data including that the user receives their monthly credit card statement on the tenth day of every month, and the user made the full payment on the statement on the eleventh day of month for each of the current month and the previous month. The machine learning model may detect the formation of a pattern of timely payments by the user and may categorize the pattern as a positive pattern. The machine learning model may be informed its determination was correct and continue assessing user activities.

During operation, the machine learning model may be configured to accept specific inputs. For example, the machine learning model may receive user activity data from an institution wishing to flag accounts of user forming negative patterns. The institution may wish to provide the user with assistance based on the pattern and characterization. The machine learning model may output whether a pattern is forming pattern and characterization which may be used by the personalized content system to generate personalized content for a particular user. In some embodiments, the machine learning model may be configured to forecast an outcome of the user data, such as what may happen if the user develops the negative pattern.

Method 3100 may include a step 3104 of flagging, upon detecting formation of a negative pattern, an account associated with the user data. In some embodiments, an account may be flagged automatically upon identifying the negative pattern. In other embodiments, the pattern being characterized as a positive pattern may prompt generation of a positive message. Method 3100 may include a step 3105 of generating a message recommending for institution services based on the negative pattern. Method 3100 may include a step 3106 of delivering the message to the account associated with the user data. In some embodiments, the message may be delivered, for example, via text message, push notification, or phone call. In some embodiments, the message may be delivered via email based on security requirements of the contents of the message. In some embodiments, the message may include a link to schedule an appointment.

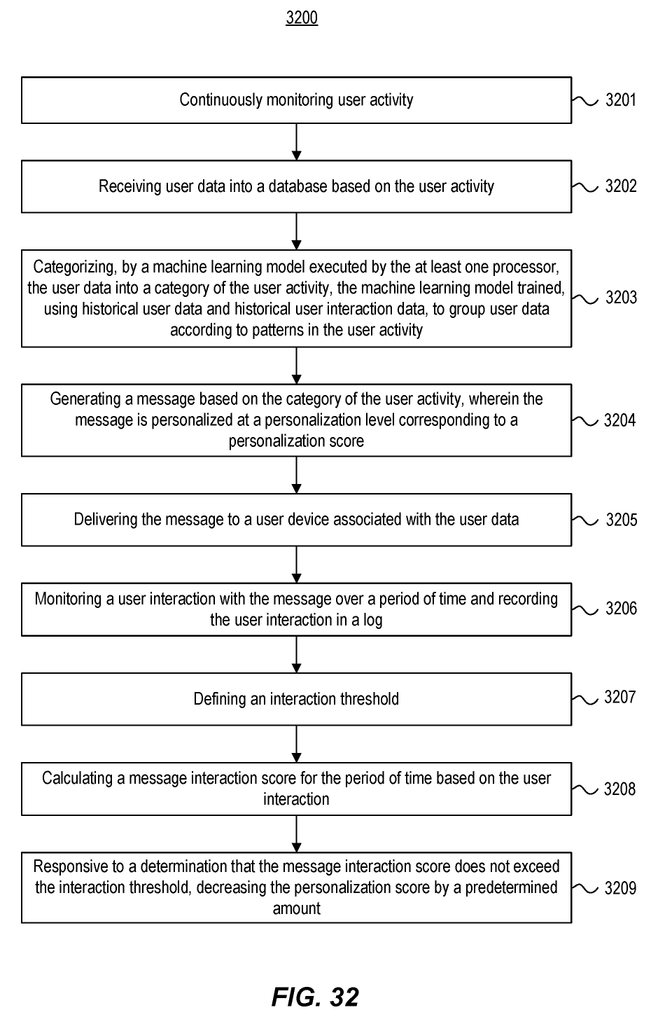

FIG. 32 depicts a flow chart for a method of feedback driven personalization reduction. Some embodiments pertain to reducing the personalization level of personalized content automatically by a predetermined amount based on redemption data. Such embodiments may involve a computer system, for example, at a bank or institution, that reduces the personalization level of personalized content automatically by a predetermined amount based on redemption data.

Method 3200 may include a step 3201 of continuously monitoring user activity. In some embodiments, the user activity may include a user location based on a location of the user device. Method 3200 may include a step 3202 of receiving user data into a database based on the user activity.

Method 3200 may include a step 3203 of categorizing, by a machine learning model executed by the at least one processor, the user data into a category of the user activity. The machine learning model may be trained, using historical user data and historical user interaction data, to group user data according to patterns in the user activity. In some embodiments, the machine learning model may be trained from historical user data, such as transaction data, to categorize user activity into the category of user activity. The machine learning model may be trained that a user has a routine. The routine may involve making purchases that fall into the category of user activity on certain days of the week, at certain times of day, or at certain locations. The machine learning may also be trained to recognize merchants that sell goods or services falling into the category of user activity. The machine learning model may be trained to group similar user data based on patterns in the user activity.

The machine learning model may be shown exemplary user data, the pattern in the user activity, and the category of the user activity. One example may include that during the week the user stops at Coffee Shop C between 6:00 - 6:30 AM for coffee on the way to work. The user almost never makes transactions before 8:00 AM besides purchasing coffee at Coffee Shop C. The machine learning model may be trained that the user has the activity pattern of purchasing coffee in the morning and is unlikely to make other transactions before 8:00 AM. The machine learning may be trained that the user activity of stopping for coffee should be categorized as dining. The machine learning model may also be trained that transactions occurring before 8:00 AM should likely be categorized as dining.

Another example may include user data including that the user recently bought a house and purchased tiles from Tile Store T, paint from Paint Store P, and light bulbs from hardware store H. The machine learning model may be trained to recognize that the purchases are occurring shortly after the home purchase. The machine learning model may be trained to group these purchases together because purchases of tiles, paint, and lightbulbs are similar purchases from similar merchants and may indicate a pattern of user activity of home improvement or interior design. Machine learning model may thus learn that the user data should be categorized as home improvement or interior design.

The machine learning model may learn from the examples and may further be trained by receiving user data, identifying any patterns, grouping the user data according to the patterns, and categorizing the user data, where the category may be related to the pattern or the grouping. For each set of user data, the machine learning model may categorize the user data. The categorization may then be confirmed or corrected until the machine learning model is able to make accurate determinations a threshold amount of the time. For example, the machine learning model may receive user data including that the user purchased a dress from Dress Store D, a suit from Menswear Shop M, and got shoes cobbled from Cobbler C. The machine learning model may determine that the three transactions should be grouped together because they are all related to dress clothes and may determine the user data should be categorized as shopping for formal attire. The machine learning model may be informed its categorization was correct and continue assessing user activities.

In another example, the machine learning model may receive user data including that the user goes bowling every Saturday night at 8:00 PM at Bowling Alley B. The user works weekend shifts and so bowling is usually the user’s only weekend outing. The machine learning model may determine that the user has the activity pattern of bowling on Saturday nights and is unlikely to make other recreational transactions on Saturdays. The machine learning may determine that the user activity of bowling on Saturday nights should be categorized as sports and recreation. The machine learning model may also determine that transactions occurring on Saturday nights may likely be categorized as sports and recreation. During operation, the machine learning model may be configured to accept specific inputs.

Method 3200 may include a step 3204 of generating a message based on the category of the user activity, wherein the message is personalized at a personalization level corresponding to a personalization score. In some embodiments, the message may include a coupon, promotion, advertisement, each for a business related to the user activity. Personalization level, as described herein, may refer to an amount of tailored customization applied to a message. In some embodiments, the personalization level may be a numerical level ranging from zero to one hundred, where a personalization level of zero may mean the personalized content is not personalized or only slightly personalized, and a personalization level of one hundred may mean the personalized content is personalized to the fullest extent. Personalization score, as described herein, may refer to a value which may be a quantitative measure of the personalization level.

Method 3200 may include a step 3205 of delivering the message to a user device associated with the user data. Method 3200 may include a step 3206 of monitoring a user interaction with the message over a period of time and recording the user interaction in a log. In some embodiments, user interaction may refer to a user engaging with the message by, for example, clicking on, tapping on, or swiping the message. In some embodiments, the user interaction may include a length of user engagement or a frequency of user engagement, where a length of user engagement may refer to how long a user engaged with a message and a frequency of user engagement may refer to how many times the user engaged with the message. The user interaction with the message may be monitored, for example, by use of tracking pixels. Tracking pixels may be embedded in the message. An institution may insert a pixel image tag into the hypertext markup language (HTML) code of the message. In other embodiments, other monitoring methods may be used to monitor the user’s interaction with the message.

Method 3200 may include a step 3207 of defining an interaction threshold. In some embodiments, the interaction threshold may be predetermined. In other embodiments, the interaction threshold may be determined based on how much an average user interacts with messages over a period of time. The interaction of a sample size of users may be monitored using the tracking pixels to determine the how the average user interacts with the messages and calculate an average message interaction score. Average message interaction score, as described herein, may be a quantitative measure of how much the average user interacts with the message. In some embodiments, the interaction threshold may be set to a value less than the average message interaction score. In some embodiments, the interaction threshold and the average message interaction score may be integers ranging from zero to one hundred, where the average message interaction score being zero may indicate that the average user does not interact with messages at all, and the average message interaction score being one hundred may indicate that the average user routinely or almost always interacts with the messages.

Method 3200 may include a step 3208 of calculating a message interaction score for the period of time based on the interaction. Message interaction score, as described herein, may be a quantitative measure of how much the user interacts with the message. In some embodiments, the message interaction score may be an integer ranging from zero to one hundred, where the message interaction score being zero may indicate that the user does not interact with messages at all, and the message interaction score being one hundred may indicate that the user excessively interacts with the messages. In some embodiments, the message interaction score may be associated with the category of user activity. In some embodiments, the period of time may be one week or one month. In some embodiments, the message interaction score may be based on whether the user opened the coupon, a time between receiving and opening the coupon, and whether the user redeemed the coupon. The message interaction score may be based on the user’s interaction with the message. For example, how long the message was opened for, how many times the message was reopened, and whether any links within the message were clicked by the user may each be assigned a weight, such that the user’s time spent with the message open, the user reopening the message, and the user clicking links within the message may factor into the calculation of the message interaction score.

Method 3200 may include a step 3209 of responsive to a determination that the message interaction score does not exceed the interaction threshold, decreasing the personalization score by a predetermined amount. In some embodiments, the predetermined amount may be a factor of the message interaction score.

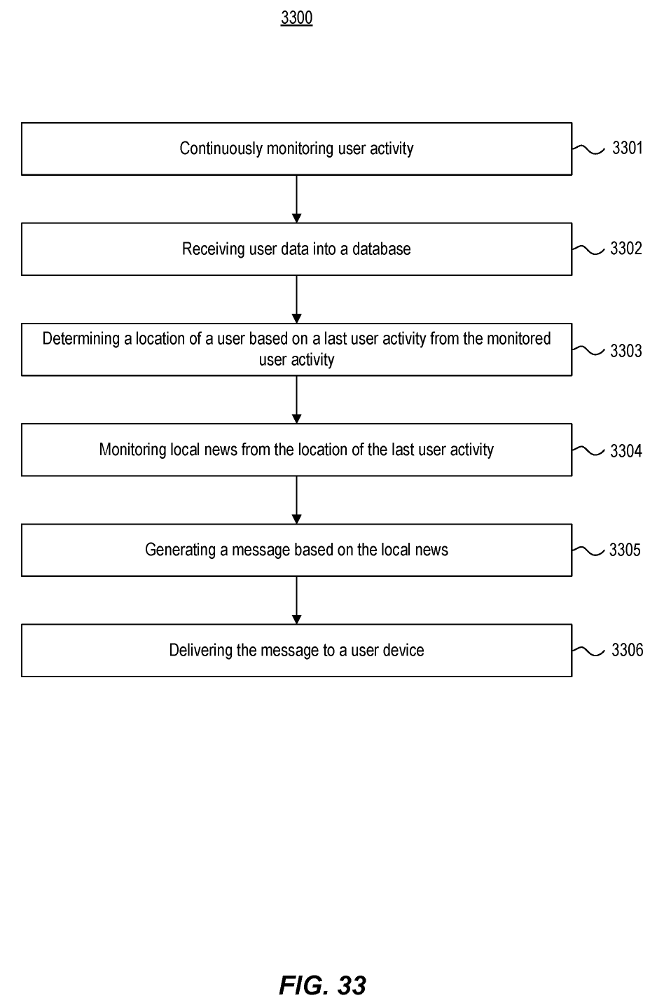

FIG. 33 depicts a flow chart for a method of delivering timely content. Some embodiments pertain to delivering personalized content to users based on user location data and relevant news for that location to drive activity. Activity may refer to generating engagement with the content, making consumer decisions based on the content, or any other combination of user activity based on the content. Such embodiments may involve a computer system, for example, at a bank or institution, that delivers personalized content to users based on user location data and relevant news for that location to drive activity.

Method 3300 may include a step 3301 of continuously monitoring user activity. In some embodiments, the user activity may include a user location based on a location of the user device. Method 3300 may include a step 3302 of receiving user data into a database. In some embodiments, the user data may include a user address.

Method 3300 may include a step 3303 of determining a location of a user based on a last user activity from the monitored user activity. In some embodiments the last user activity may be determined from transaction data. Transaction data, as described herein, may include time- and location-stamped records of funds moving into or out of a user account. In some embodiments, the transaction data may include deposits and withdrawals by the user, and in some embodiments, the transaction data may include expenses, such as on a credit card statement. The transaction data may include an identification number, timestamp, amount, and status, such as successful or failed. The transaction data may also include contextual information including merchant name, merchant type, or location.

Method 3300 may include a step 3304 of monitoring local news from the location of the last user activity. Local news may include, for example, headlines, announcement of a store closure, announcement of a grand opening, or announcement of a sale. In some embodiments, the monitoring may include monitoring local news that is local to the user address. In one example, monitoring the local news may reveal that a grand opening of Superstore S will take place in one week or that Retailer R is having a liquidation sale that started yesterday.

Method 3300 may include a step 3305 of generating a message based on the local news. In other embodiments, the message may include a news headline or an announcement of a grand opening for the location where the user device is located. Method 3300 may include a step 3306 of delivering the message to a user device, as described herein.

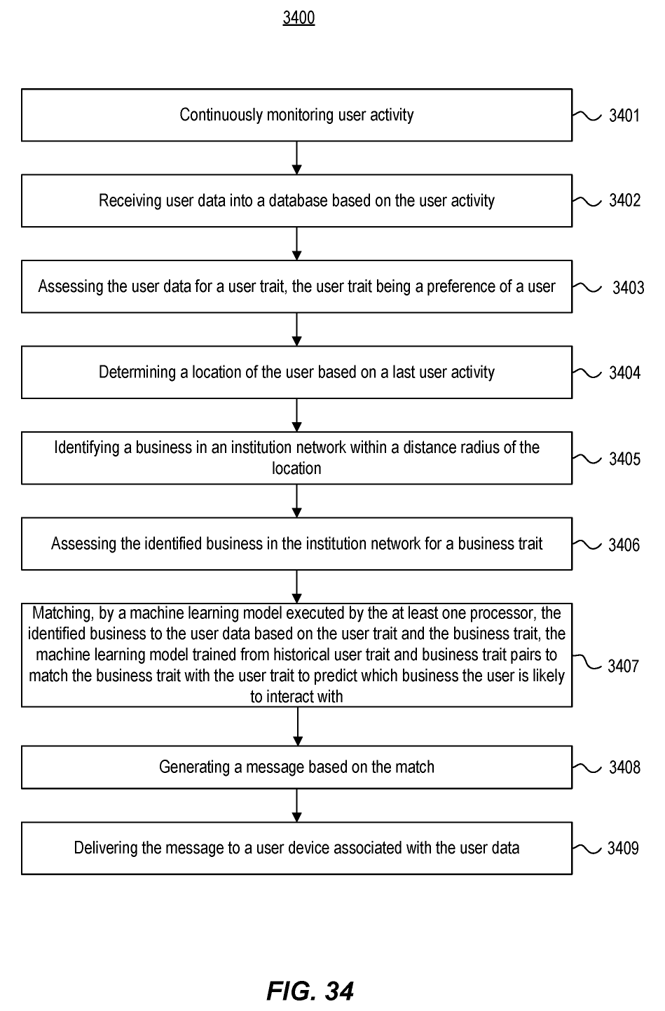

FIG. 34 depicts a flow chart for a method of providing geofence-based content. Some embodiments pertain to using location data, user activity, and geofences to narrow and tailor user recommendations to a specific location. Such embodiments may involve a computer system, for example, at a bank or institution, that uses location data, user activity, and geofences to narrow and tailor user recommendations to a specific location.

Method 3400 may include a step 3401 of continuously monitoring user activity. Method 3400 may include a step 3402 of receiving user data into a database based on the user activity.

Method 3400 may include a step 3403 of assessing the user data for a user trait, the user trait being a preference of a user. In some embodiments, the user trait may include a spending habit, highlighting a preference of the user for particular products and services. In some embodiments, the user trait may include a travel habit, highlighting a movement preference of the user. In some embodiments, the user trait may include other interests of the user. In some embodiments, the user data may be assessed for user traits by examining the user’s transaction history. Each transaction may be received and classified based on the goods and services provided by the merchant. In such an embodiment, transactions may be classified using merchant category codes.

Method 3400 may include a step 3404 of determining a location of the user based on a last user activity. In some embodiments the last user activity may be determined from transaction data. The transaction data may include an identification number, timestamp, amount, and status, such as successful or failed. The transaction data may also include contextual information including merchant name, merchant type, or location.

Method 3400 may include a step 3405 of identifying a business in an institution network within a distance radius of the location. Distance radius, as described herein, may refer to a perimeter around a user or a fixed point, such as the last user activity or the user’s home address. In some embodiments, there may be a geofence along the perimeter created by the distance radius. The distance radius may determine the perimeter of the geofence. In some embodiments, the distance radius may be determined based on the user activity. For example, the furthest distance the user consistently travels to make a purchase is twenty-five miles from the user’s home address, the distance radius may be twenty-five miles to be large enough to enclose the merchants the user shops at most frequently and an area of town the user most often travels through.

Method 3400 may include a step 3406 of assessing the identified business in the institution network for a business trait. In some embodiments, the business trait may include a product offering, highlighting a category of product sold. In some embodiments, the business trait may include a service offering, highlighting a category of service provided. In some embodiments, the business trait may include hours the business operates. In some embodiments, assessing identified businesses may involve, for example, using merchant category codes. The business’ merchant category code may fall into a range of merchant category codes, where the range of merchant category codes spans all businesses providing goods and services that fall into the category. In some embodiments, the category may be a sub-category such that a range of merchant category codes may correspond to a sub-category, and several ranges of merchant category codes may fall into a single category. The identified business may then be assigned a merchant category code that falls into a sub-category when then falls into a category. The identified business may be confirmed as having the business trait related to the sub-category or the category the identified business’ merchant category code falls into.

In one example, the identified business may be Airline A, which may have a merchant category code of 4014. Merchant category code 4014, where the range of merchant category codes 4011–4025 falls into the sub-category of air travel, which may fall into the category of transportation. Airline A may then be confirmed as having the business trait of air travel. In some embodiments, the business trait may be the same as the category or sub-category, and in other embodiments, the business trait may be different than the category or sub-category.

Method 3400 may include a step 3407 of matching, by a machine learning model executed by the at least one processor, the identified business to the user data based on the user trait and the business trait. The machine learning model may be trained from historical user trait and business trait pairs to match the business trait with the user trait to predict what business the user is likely to interact with.

Method 3400 may include a step 3408 of generating a message based on the match. In some embodiments, the message may include a promotion. In other embodiments, the message may include an advertisement for the business in the institution network having the business trait matching the user trait. In other embodiments, the message may include a coupon for the business in the institution network having the business trait matching the user trait. Method 3400 may include a step 3409 of delivering the message to a user device associated with the user data. In some embodiments, the message may be delivered, for example, via push notification, text message, or email.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware or by software on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure may be performed by a data processor, such as a computing device for executing a plurality of instructions.

Various implementations of the systems and techniques described here can be realized in digital electronic circuitry, integrated circuitry, specially designed ASICs (application specific integrated circuits), computer hardware, firmware, software, and/or combinations thereof. These various implementations may include implementation in a computer program that is executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device,” it should be noted that optionally any device featuring a data processor and the ability to execute an instruction may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally include a network or a computer network.

To provide for interaction with a user, the systems and techniques described herein can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back-end component (e.g., as a data server), or that includes a middleware component (e.g., an application server), or that includes a front end component (e.g., a client computer having a graphical user interface or a web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

It should be appreciated that the above-described methods and apparatus may be varied in many ways, including omitting, or adding steps, changing the order of steps and the type of devices used. It should be appreciated that unique features may be combined in diverse ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Systems and methods disclosed herein involve unconventional improvements over conventional approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The block diagrams in the figures illustrate the architecture, organizational entity, and operation of possible implementations of systems, methods, and computer hardware or software products according to various example embodiments of the present disclosure. In this regard, each block in a flowchart or block diagram may represent a module, segment, or portion of code, which includes an executable instruction for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the organizational entity involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

What is claimed is:

1. A system comprising:
a memory storing a set of instructions; and
at least one processor configured to execute the set of instructions to:
continuously monitor user interaction with a platform hosted on a user device;
store user interaction data for a period of time in a database;
parse user interaction data according to predetermined parsing instructions to produce parsed user interaction data;
identify, by a machine learning model executed by the at least one processor, a pattern in the parsed user interaction data, the machine learning model trained to characterize the pattern as a positive pattern or a negative pattern;
responsive to a characterization of the pattern as a positive pattern or a negative pattern, generate a customized message based on the characterization; and
deliver the message to the user device.

2. The system of claim 1, wherein the user interaction data includes a time and a frequency at which the continuous monitoring of the user interaction detects an access to the platform to gauge a receptivity of a user to receiving the customized message and a best destination for delivering the customized message.

3. The system of claim 1, wherein the user interaction includes paying a bill, and, from a plurality of user interactions, the machine learning model identifies the pattern as a pattern of paying bills before the bills are due.

4. The system of claim 1, wherein the user interaction includes setting up direct deposit, and, from a plurality of user interactions, the machine learning model identifies the pattern as a pattern of utilizing account features.

5. The system of claim 1, wherein the predetermined parsing instructions include instructions to extract names.

6. The system of claim 1, wherein the machine learning model is configured to forecast an outcome of one of either the positive pattern or the negative pattern.

7. The system of claim 1, wherein the pattern being characterized as the positive pattern prompts generation of a positive message.

8. The system of claim 1, wherein the pattern being characterized as the negative pattern prompts generation of a negative message.

9. A computer implemented method comprising the following operations performed by at least one processor:
continuously monitoring user interaction with a platform hosted on a user device;
storing user interaction data for a period of time in a database;
parsing user interaction data according to predetermined parsing instructions to produce parsed user interaction data;
identifying, by a machine learning model executed by the at least one processor, a pattern in the parsed user interaction data, the machine learning model trained to characterize the pattern as a positive pattern or a negative pattern;
responsive to a characterization of the pattern as a positive pattern or a negative pattern, generating a customized message based on the characterization; and
delivering the message to the user device.

10. The method of claim 9, wherein the user interaction data includes a time and a frequency at which the continuous monitoring of the user interaction detects an access to the platform to gauge a receptivity of a user to receiving the customized message and a best destination for delivering the customized message.

11. The method of claim 9, wherein the user interaction includes paying a bill, and, from a plurality of user interactions, the machine learning model identifies the pattern as a pattern of paying bills before the bills are due.

12. The method of claim 9, wherein the user interaction includes setting up direct deposit, and, from a plurality of user interactions, the machine learning model identifies the pattern as a pattern of utilizing account features.

13. The method of claim 9, wherein the predetermined parsing instructions include instructions to extract names.

14. The method of claim 9, wherein the pattern being characterized as the positive pattern prompts generation of a positive message.

15. The method of claim 9, wherein the pattern being characterized as the negative pattern prompts generation of a negative message.

16. A non-transitory computer storage medium encoded with computer program instructions that when executed by at least one processor, cause the at least one processor to perform operations comprising:
continuously monitoring user interaction with a platform hosted on a user device;
storing user interaction data for a period of time in a database;
parsing user interaction data according to predetermined parsing instructions;
identifying, by a machine learning model executed by the at least one processor, a pattern in the parsed user interaction data, the machine learning model trained to characterize the pattern as a positive pattern or a negative pattern;
responsive to a characterization of the pattern as a positive pattern or a negative pattern, generating a customized message based on the characterization; and
delivering the message to the user device.
